(19) United States
(12) Patent Application Publication
(10) Pub. No.: US 2012/0066171 A1
(43) Pub. Date: Mar. 15, 2012

(54) METHODS OF EVALUATING A SUBJECT'S LIKELIHOOD TO RESPOND TO THERAPY BASED ON ANALYZING RELEVANT PARAMETERS OF THERAPY TARGETS

(75) Inventor: Benjamin J. Zeskind, Boston, MA (US)

(73) Assignee: Immuneering Corporation, Cambridge, MA (US)

(21) Appl. No.: 13/227,333

(22) Filed: Sep. 7, 2011

Related U.S. Application Data
(60) Provisional application No. 61/380,683, filed on Sep. 7, 2010.

(51) Int. Cl. G06F 17/00

(52) U.S. Cl. 706/52; 706/46

(57) ABSTRACT

The disclosure relates to methods of predicting the effects of therapy, designing/conducting a clinical trial, selecting a subject for a clinical trial, selecting a subject for therapy, monitoring a subject's responsiveness to therapy, treating a subject, and predicting effects of anti-CD25 therapy.

### FIELD OF THE DISCLOSURE

This disclosure relates to the diagnosis and treatment of disease.

### BACKGROUND OF INVENTION

Cytokines and their receptors are ubiquitous throughout the human immune system and play a vital role in coordinating and controlling the actions of the many different cell types that participate in an immune response.

Not surprisingly, both agonists and antagonists for many of the cytokine receptors have been developed for medical applications ranging from suppression of the immune response during transplantation, asthma, or autoimmune disease, to enhancement of the immune response against cancer.

Therapeutic strategies focused on modulating cytokine signaling have met with mixed success at best. Often, there is dramatic heterogeneity in response, with some patients deriving significant benefit and others experiencing toxicity in the absence of clinical activity. Despite extensive research aimed at discovering biomarkers to predict response to cytokine-related therapies, the ability to stratify patients by likelihood of response remains a long felt but unsolved need.

Predicting clinical activity of cytokine-related therapies has proven challenging in part due to an incomplete or inaccurate understanding of their mechanism of action. Typically, these therapies are developed with the goal of enhancing or inhibiting the signaling of a single type of receptor on a single type of cell. For instance, aldesleukin (recombinant interleukin-2) was developed with the goal of enhancing interleukin (IL)-2 receptor signaling on CD8+ T cells. Similarly, reslizumab (a monoclonal antibody against IL-5) was developed with the goal of inhibiting IL-5 receptor signaling on eosinophils.

### SUMMARY OF INVENTION

Here we describe a novel approach to understanding the mechanism of action of cytokine-related therapies, identifying patients likely to respond, increasing response rates, and expanding use. Our approach is based on a principle that heretofore has not been applied to the development of cytokine-related therapies.

Because many cytokine receptors share common subunits, it is important to understand the effect that a cytokine-receptor agonist or antagonist may have on cytokine receptors other than the targeted one. For instance, in the case of reslizumab, the IL-5 receptor shares a common beta receptor subunit with IL-3 and granulocyte-macrophage colony stimulating factor (GM-CSF). By reducing the amount of IL-5 available, reslizumab not only antagonizes IL-5 receptor signaling but may also enhance signaling of IL-3 and/or GM-CSF by increasing the availability of the common beta subunit.

In addition, because virtually every cytokine receptor is expressed on more than one cell type, it is important to understand the effects of a cytokine-receptor agonist or antagonist on multiple cell types expressing the targeted receptor, and the relative effects of the therapy on different cell types. For instance, in the case of aldesleukin several other cell types (including regulatory T cells and CD56^{bright} NK cells) express high affinity IL-2 receptors and in certain patients the aldesleukin may be more likely to affect these cells than the intended CD8⁺ T cells. Daclizumab is a therapy designed to antagonize the CD25 subunit of the IL-2 receptor, which is currently in clinical trials for multiple sclerosis. Bielekova and colleagues at the National Institutes of Health (NIH) observed that CD56bright natural killer (NK) cells expand to different extents in different multiple sclerosis (MS) patients following treatment with an anti-CD25 antibody (Daclizumab), and that this expansion is correlated with response to the therapy. [Bielekova, 2006] Monti and colleagues found that Daclizumab enhances T cell responsiveness to IL-7 in vitro, hypothesizing that this effect is caused by an increase in the availability of CD132 [Monti, 2009]

However, nobody has attempted to quantify or predict this effect, nor has anybody heretofore connected it with CD56bright NK cell expansion following Daclizumab treatment in MS. We identified a third set of findings that are extremely relevant. Hanna and colleagues [Hanna, 2004] found that CD56bright NK cells express CD127, and proliferate in response to IL-7 (unlike CD56dim NK cells).

Taken together, these three studies strongly suggest that Daclizumab causes CD56bright NK cell expansion in some MS patients by increasing availability of CD132 for the IL-7 receptor. However it is not known and not obvious how to quantify or predict this effect and why it differs from subject to subject. The method described herein was developed to meet that need.

According to one aspect of the disclosure, a method of predicting the effects of therapy on a subject prior to treatment is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) prior to treatment based on (i); and (iii) predicting the effects of therapy on a subject prior to treatment based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following: natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligand(s) may comprise: IL-2, IL-4, IL-7, IL-9, IL-15, and IL-21. The receptor subunit(s) and ligand(s) may further comprise TSLPR, IL-13Ralpha1 (CD213alpha1), TSLP, and IL-13. In some preferred embodiments, the receptor subunit(s) further comprise IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to another aspect of the disclosure, a method of designing and/or conducting a clinical trial is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) prior to treatment based on (i); and (iii) designing and/or conducting a clinical trial based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following: natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligand(s) may comprise: IL-2, IL-4, IL-7, IL-9, IL-15, and IL-21. The receptor subunit(s) and ligand(s) may further comprise TSLPR, IL-13Ralpha1 (CD213alpha1), TSLP, and IL-13. In some preferred embodiments, the receptor subunit(s) further comprise IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the he therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to yet another aspect of the disclosure, a method of selecting a subject for a clinical trial is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) prior to treatment based on (i); and (iii) selecting a subject for a clinical trial based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligands may comprise: IL-2, IL-4, IL-7, IL-9, IL-15, and IL-21. The receptor subunit(s) and ligand(s) may further comprise TSLPR, IL-13Ralpha1 (CD213alpha1), TSLP, and IL-13. In some preferred embodiments, the receptor subunit(s) further comprise IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to still another aspect of the disclosure, a method of selecting a therapy for a subject is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) prior to treatment based on (i); and (iii) selecting a therapy for a subject based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following: natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligands may comprise: IL-2, IL-4, IL-7, IL-9, IL-15, and IL-21. The receptor subunit(s) and ligand(s) may further comprise TSLPR, IL-13Ralpha1 (CD213alpha1), TSLP, and IL-13. In some preferred embodiments, the receptor subunit(s) further comprise IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to another aspect of the disclosure, a method of monitoring a subject's responsiveness to therapy is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) subsequent to the initiation of treatment based on (i); and (iii) monitoring a subject's responsiveness to therapy based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following: natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligands may comprise: IL-2, IL-4, IL-7, IL-9, IL-15, and IL-21. The receptor subunits and ligands considered may further comprise TSLPR, IL-13Ralpha1 (CD213alpha1), TSLP, and IL-13. In some preferred embodiments, the receptor subunits considered further comprises IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the he therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to still another aspect of the disclosure, a method of treating a subject is provided. The method comprises (i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b); (ii) determining a first set of output values, representing the signaling on one or more receptor(s) subsequent to the initiation of treatment based on (i); and (iii) treating a subject based on the results of (i)-(ii).

The method may further comprise (iv) providing a second set of input values, equal to the first set of input values but wherein the quantity or quantities that is/are expected to be directly altered by the therapy is/are changed to reflect the therapy's expected effect; (v) determining a second set of output values representing the signaling on one or more receptor(s) after administration of the therapy; and (vi) predicting the effects of therapy on a subject prior to treatment, based on the results of (i)-(v).

In some embodiments, the therapy comprises an agonist or an antagonist of a receptor or receptor subunit, alters the quantity of ligand available to bind to a receptor or receptor subunit, and/or modulates a pathway triggered by a receptor or receptor subunit.

In some embodiments, the target receptor subunit(s) comprises: (a) the subunit(s) of the receptor(s) for which the therapy is an agonist or an antagonist, (b) the receptor subunit(s) for which the therapy is an agonist or an antagonist and any subunit(s) that form complexes with that/those receptor subunits, (c) the subunit(s) of the receptor(s) that bind to the ligand whose quantity is altered by the therapy, or (d) receptor subunit(s) that trigger the signaling pathway which the therapy modulates.

The first set of input values may further comprise receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the first set of input values further comprises a receptor subunit(s) that binds to a ligand identified in (i) and/or receptor subunit(s) that interact with receptor subunit(s) identified in (i)(a) and/or (i)(b), and ligand(s) that bind to a receptor subunit(s) that interact with receptor subunits identified in (i)(a) and/or (i)(b).

In some embodiments, the absolute or relative quantity of receptor subunit(s) is the absolute or relative quantity of receptor subunit(s) present on one or more cell type(s). In some embodiments, the signaling determined in (ii) is compared to the signaling determined in (v) to determine the therapy's effect on one or more cell type(s). In some embodiments, the effect of one or more cell type(s) comprises proliferation or a cytotoxic response of one or more cell type(s).

Examples of cell type(s) include but are not limited to one or more of the following: natural killer cell, CD56bright natural killer cell, CD56dim natural killer cell, B cell, eosinophil, T cell, regulatory T cell, naïve regulatory T cell, or memory regulatory T cell.

In some embodiments, the therapy is (a) an agonist or an antagonist of a cytokine receptor or cytokine receptor subunit, (b) alters the quantity of ligand available to bind to a cytokine receptor or cytokine receptor subunit, or (c) modulates a pathway triggered by a cytokine receptor or cytokine receptor subunit.

The cytokine receptor or cytokine receptor subunit may comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the therapy alters the quantity of ligand available to bind to one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2).

In some embodiments, the ligand comprises: IL-2, IL-4, IL-7, IL-9, IL-15, IL-21, TSLP, or IL-13. In some of the preferred embodiments, the therapy is a CD25 antagonist. In some of the preferred embodiments, the particular cell type is CD56bright natural killer.

In some embodiments, the therapy's effect is proliferation. In some embodiments, the therapy's target receptor subunits comprise CD25 (IL-2Ralpha), CD122 (IL-2Rbeta), and CD132 (gamma chain). The receptor subunits that interact with the therapy's target receptor subunits may comprise: CD124 (IL-4Ralpha), CD127 (IL-7Ralpha), CD129 (IL-9Ralpha), IL-15Ralpha, and IL-21Ralpha (NILR). The ligands may comprise: IL-2, IL-4, IL-7, IL-9, IL-15, and IL-21. The receptor subunit(s) and ligand(s) may further comprise TSLPR, IL-13Ralpha1 (CD213alpha1), TSLP, and IL-13. In some preferred embodiments, the receptor subunit(s) further comprise IL-13Ralpha2 (CD213alpha2). In some preferred embodiments, the therapy comprises one or more of the following: recombinant IL-2, recombinant IL-4, recombinant IL-7, recombinant IL-9, recombinant IL-15, recombinant IL-21, recombinant TSLP, or recombinant IL-13.

In some embodiments, the he therapy's target receptor subunits and receptor subunits that interact with the therapy's target receptor subunits comprise one or more of the following: CD25 (IL-2Ralpha), CD122 (IL-2Rbeta), CD132 (gamma chain), CD124 (IL-4Ralpha), CD127 (IL-7Ralpha), CD129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy comprises a JAK inhibitor. The therapy's target receptor subunits and receptor subunits that interact with the therapy's target receptor subunits may comprise one or more of the following: CD25 (IL-2Ralpha), CD 122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2). The ligands may comprise one or more of: IL-2, IL-4, IL-7, IL-9, IL-15, IL-21, TSLP, or IL-13.

In some preferred embodiments, the therapy (a) is an agonist or an antagonist of one or more of the following: BAFF-R (BR3), TACI, APRIL, or HSPG or (b) alters the quantity of ligand available to bind to one or more of the following: BAFF-R (BR3), TACI, APRIL, or HSPG. The receptor subunit may comprise: BAFF-R (BR3), TACI, APRIL, or HSPG. The ligand may comprise: BAFF (BLys) or APRIL.

In some embodiments, the therapy comprises a BAFF antagonist. The particular cell type may be a B cell. In some preferred embodiments, the therapy's effect is proliferation or antibody production. The therapy's target receptor subunit and receptor subunits that interact with the therapy's target receptor subunits may comprise: BAFF-R (BR-3), TACI, APRIL, or HSPG. The ligands may comprise: BAFF (BLyS) or APRIL.

In some embodiments, the therapy is an agonist or antagonist of one or more of the following: IL-5Ralpha, betac, IL-3Ralpha, GM-CSFRalpha or alters the quantity of ligand available to bind to one or more of the following: IL-5Ralpha, betac, IL-3Ralpha, or GM-CSFRalpha. The receptor subunit may comprise: IL-5Ralpha, betac, IL-3Ralpha, or GM-CSFRalpha. The ligand may comprise: IL-5, IL-3, or GM-CSF.

In some preferred embodiments, the therapy is an anti-IL-5 antibody. The particular cell type may be an eosinophil. The therapy's effect may be proliferation. The therapy's target receptor subunits and receptor subunits that interact with the therapy's target receptor subunit may comprise: IL-5Ralpha, betac, IL-3Ralpha, GM-CSFRalpha. The ligand may comprise: IL-5, IL-3, or GM-CSF.

In some embodiments, the signaling on one or more receptors comprises the number of receptor-ligand surface complexes. In some embodiments, determining the signaling on one or more receptors utilizes differential equations. In some embodiments, determining the signaling on one or more receptors utilizes binding affinities (dissociation constants). In some embodiments, the signaling on one or more receptors utilizes an analysis of receptor-ligand binding and trafficking dynamics. In some embodiments, determining the signaling on one or more receptors utilizes an analysis of assembly energetics. In some embodiments, determining the signaling on one or more receptors utilizes a computational analysis. In some embodiments, determining providing a set of values comprises assaying a sample from the subject to determine the values.

Assaying the sample may be conducted using one or more of the following: flow cytometry, mRNA expression analysis, quantitative polymerase chain reaction (qPCR), immunohistochemistry (IHC), enzyme-linked immunosorbent assay (ELISA), surface plasmon resonance (SPR), or radiolabeled binding assays. The sample may be one or more of the following: blood, serum, plasma, lymph, saliva, urine, sweat, mucus, cerebrospinal fluid, amniotic fluid, Pap smear, tissue, tumor, lymph node, biopsy sample, and/or peripheral blood mononuclear lymphocyte (PBMC).

In some embodiments, the method comprises determining differences in the therapy's effect on different cell types. In some embodiments, the method comprises performing the method for two or more different cell types simultaneously.

According to another aspect of the disclosure, a method of predicting the effects of anti-CD25 therapy on a subject prior to treatment is provided. The method comprises: (i) providing prior to treatment a first set of input values comprising the absolute or relative quantity of regulatory T cells in a sample from the subject; and (ii) predicting the effects of therapy on a subject prior to treatment based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

According to yet another aspect of the disclosure, a method of designing and/or conducting a clinical trial is provided. The method comprises: (i) providing prior to treatment a first set of input values comprising the absolute or relative quantity of regulatory T cells in a sample from the subject; and (ii) designing and/or conducting a clinical trial based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

According to still another aspect of the disclosure, a method of selecting a subject for a clinical trial is provided. The method comprises: (i) providing prior to treatment a first set of input values comprising the absolute or relative quantity of regulatory T cells in a sample from the subject; and (ii) selecting a subject for a clinical trial based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

According to still another aspect of the disclosure, a method of selecting a therapy for a subject is provided. The method comprises: (i) providing prior to treatment a first set of input values comprising the absolute or relative quantity of regulatory T cells in a sample from the subject; and (ii) selecting a therapy for a subject based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

According to still another aspect of the disclosure, a method of monitoring a subject's responsiveness to therapy is provided. The method comprises: (i) providing subsequent to initiation of treatment a first set of input values comprising the absolute or relative quantity of regulatory T cells in a sample from the subject; and (ii) monitoring a subject's responsiveness to therapy based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

According to yet another aspect of the disclosure, a method of treating a subject is provided. The method comprises: (i) providing prior to treatment a first set of input values comprising the absolute or relative quantity of regulatory T cells in a sample from the subject; and (ii) treating a subject based on the results of (i).

In some embodiments, (i) further comprises providing a set of values for the absolute or relative quantity of anti-CD25 that will be administered to a subject. In some embodiments, the values provided in (i) are utilized to determine the absolute or relative quantity of Tregs and/or CD56bright NK cells that will remain following a given dose of anti-CD25. In some embodiments, (i) further comprises providing a set of values for the absolute or relative quantity of IL-2 and/or IL-7 present in a sample from a subject. In some embodiments, (i) further comprises providing a set of values for the absolute or relative quantity of memory Tregs and/or naïve Tregs and/or CD56bright NK cells present in a sample from a subject. In some embodiments, (i) further comprises the absolute or relative quantity of CD25 and/or CD122 and/or CD 132 and/or CD 127 on one or more cell types.

In some embodiments, the values provided in (i) are utilized to determine the absolute or relative quantity of memory Tregs and/or naïve Tregs and/or CD56bright NK cells that will remain following a given dose of anti-CD25. In some embodiments, the values provided in (i) are utilized to determine how the absolute or relative quantity of IL-2 and/or IL-7 will be distributed among the absolute or relative quantity of Tregs and/or CD56bright NK cells that will remain following a given dose of anti-CD25. In some embodiments, the values provided in (i) are further utilized to determine whether or not the CD56bright NK cells will receive sufficient IL-2 to proliferate.

### BRIEF DESCRIPTION OF DRAWINGS

FIG. 1 illustrates the receptor subunit and cytokine interactions upon which the model equations are based. FIG. 1(a) shows the portion of the interactions involving the IL-9 receptor. FIG. 1(b) shows the portion of the interactions involving the IL-21 receptor. FIG. 1(c) shows the portion of the interactions involving the IL-4 and IL-13 receptors. FIG. 1(d) shows the portion of the interactions involving the IL-7 and TSLP receptors. FIG. 1(e) shows the portion of the interactions involving the IL-2 receptor. FIG. 1(f) shows the portion of the interactions involving the IL-15 receptor.

FIG. 2(a) shows an initial example of a subject represented by a certain set of input values, for whom the quantity of cytokine is the limiting factor in cytokine signaling. With concentrations of IL-2, IL-7, and IL-21 set to 0.1 nM each, the signaling plateaus occur when each cytokine runs out. When we provide a second set of values in which the amount of CD25 has been reduced to reflect the expected effect of the therapy, as shown in FIG. 2(b), there is little effect on the level of IL-7 or IL-21 signaling, because the concentration of cytokine and not the receptor levels remain the limiting factor.

FIG. 3(a) shows the out put of the model for a different set of input values representing a different patient, in which the concentrations of IL-2, IL-7, and IL-21 are significantly higher at 10 nM each. In this case, when a second set of input values is provided with the levels of CD25 reduced to reflect the effect of an anti-CD25 therapy, as shown in FIG. 3(b), the level of IL-2 signaling drops as expected and the level of IL-7 signaling increases significantly.

FIG. 4(a) illustrates a first subject before (left) and after (right) treatment with a BAFF inhibitor. The subject has lower initial APRIL levels, so the BAFF antagonist will NOT be effective because even after the addition of the BAFF antagonist (as represented by a reduction in BAFF concentration from 0.18 nM to 0.044 nM), the negative signaling (mediated by BAFF:TACI) still exceeds the positive signaling (mediated by APRIL:TACI). In contrast, the second subject (illustrated in FIG. 4(b)) has higher initial APRIL levels before treatment (left), so the BAFF antagonist WILL be effective because after the addition of the BAFF antagonist (as represented by a reduction in BAFF concentration from 0.18 nM to 0.044 nM) (right), the negative signaling (mediated by BAFF:TACI) NO LONGER exceeds the positive signaling (mediated by APRIL:TACI).

### DETAILED DESCRIPTION OF INVENTION

Aspects of the disclosure relate to predicting the effect of a therapy on a subject prior to treatment. In some embodiments, the effect of a therapy is a binary outcome, i.e. the subject will respond or will not respond to a given therapy. In some embodiments, the effect of a therapy comprises a likelihood of response to a particular therapy, expressed as a percentage or in another format. Alternately, the effect of a therapy may comprise a number expressed in arbitrary units such as a “score.” For instance, a subject has a 50% chance of responding to therapy. As another example, a subject has a score of 40. As another example, said score may be reported in connection with a likelihood of response—for instance, subject has a score of 40, and in clinical trials subjects with a score of 40 had a 70% chance of responding to therapy. The term respond or responsiveness, may refer to partial or complete responses. Responsiveness depends on the condition being treated. In some embodiments, responsiveness comprises the extent to which the therapy is achieving its intended effect, such as, for example, ameliorating the subject from the disease. Responsiveness may be based, for example, on reduction in tumor size, progression free survival, complete and durable response, or any basis known to one of ordinary skill in the art.

The term therapy is intended to include prophylaxis, amelioration, prevention or cure from the condition being treated. The subject may have not received any therapy before or may have undergone a prior therapy. Treatment comprises administering one or more therapies.

In some embodiments, the therapy is a single therapeutic/agent, or a therapeutic regimen consisting of multiple therapies/agents. In one embodiment, the therapy comprises a particular therapeutic molecule or molecules to be administered. In some embodiments, therapy comprises a particular molecule, as well as dosing, timing, and other parameters related to the therapy or its administration. In some embodiments, the therapy comprises a therapy already approved by a regulatory agency. In some embodiments, the therapy comprises a therapy under investigation in clinical trials. In some embodiments, the therapy comprises an agonist or an antagonist of a cytokine receptor or a cytokine receptor subunit. In some embodiments, an agonist for a cytokine receptor is a therapy that binds to a cytokine receptor and causes it to generate a signal. In some embodiments, an antagonist for a cytokine receptor is a therapy that blocks the effective functioning of the cytokine receptor, preventing it from generating a signal.

In some embodiments, the therapy alters the quantity of ligand available to bind to a cytokine receptor or a cytokine receptor subunit. The subunit may be a protein that comprises all or part of a receptor. Often, a subunit is one protein that assembles with one or two other proteins to form a complex that together comprises a receptor. For instance, CD122 is a subunit that assembles with CD132 to form a complex that is the intermediate-affinity IL-2 receptor.

In some embodiments, the therapy modulates a pathway triggered by a cytokine receptor or a cytokine receptor subunit. In some embodiments, the cytokine receptor or cytokine receptor subunit comprises one or more of the following: CD25 (IL-2Ralpha), CD122 (IL-2Rbeta), CD132 (gamma chain), CD 124 (IL-4Ralpha), CD 127 (IL-7Ralpha), CD 129 (IL-9Ralpha), IL-15Ralpha, IL-21Ralpha (NILR), TSLPR, IL-13Ralpha1 (CD213alpha1), or IL-13Ralpha2 (CD213alpha2).

In embodiments where the therapy antagonizes a receptor subunit, the expected effect of the therapy comprises a reduction in the quantity of that subunit available to form complexes with other subunits, or to bind to ligand. In embodiments where the therapy alters the quantity of one or more ligands, the expected effect of the therapy comprises an increase or decrease in the quantity of available ligand.

In some embodiments, input values are numbers that represent something about a subject before he or she is treated. In other words, numbers that correspond to some characteristic of the subject prior to the administration of therapy. For instance, input values could refer to the quantity of a particular receptor subunit on a particular cell type in a subject. In one example, the input values are used by a computer to determine output values. In some embodiments, providing input values are obtained from or provided by a third party. The third party may provide the values in an electronic format such, for example, as a spreadsheet.

In some embodiments, output values are numbers that are determined using the input values, but that represent a different characteristic of the subject than the input values represent. In other words, numbers that represent something about a subject that is different from what the input values represent, but which depends in some way on the input values. For instance, output values could refer to the number of receptor-ligand surface complexes between IL-7 and the IL-7 receptor, when the input values were the concentration of IL-7 in a subject's serum, and the number of CD127 receptor subunits on a patient's CD56bright NK cells. In some embodiments, output values are obtained from or provided by a third party. The third party may provide the values in an electronic format such, for example, as a spreadsheet.

In some embodiments, signaling on one or more receptor(s) comprises the extent to which a receptor activates a chain or cascade of molecular interactions within a cell in response to the binding of a particular ligand to that receptor. In one embodiment, this is represented by the number of receptor-ligand complexes at a given time. In another embodiment, this is represented as the number of receptor-ligand complexes internalized during a given time interval.

For a therapy that antagonizes a receptor subunit, in some embodiments, a therapy's expected expect is a reduction in the quantity of that subunit. For a therapy that alters the quantity of one or more ligands, in some embodiments, a therapy's expected expect is an increase or decrease in the quantity of available ligand.

In some embodiments, the therapy alters the quantity of ligand available. In some embodiments, the therapy increases the amount of ligand that is able to bind to receptors on a subject's cell(s). In some embodiments, the therapy decreases the amount of ligand that is able to bind to receptors on a subject's cell(s). In some embodiments, decreasing the amount of ligand comprises reducing the amount of ligand by depleting it, or causing an agent to bind to it so that it is no longer able to bind to receptors, or applying a therapy that otherwise lessens the availability of the ligand. In some embodiments, increasing the amount comprises adding additional ligand directly (as in the case of a recombinant cytokine) or applying a therapy that otherwise increases the availability of the ligand.

In some embodiments, the therapy modulates a pathway triggered by a cytokine receptor or by a cytokine receptor subunit. In some embodiments, the alteration changes the magnitude of signaling that is occurring in a cascade of events that involves a particular molecule. In one example, a JAK3 inhibitor would be considered to modulate the JAK3 pathway because it reduces the magnitude of signaling in the cascade of events that involves JAK3.

In some embodiments, a signaling pathway comprises a chain or cascade of molecular interactions occurring within a cell in response to the binding of a particular ligand to a particular receptor. If a therapy is designed to interfere with this chain or interactions, then the subunits of the receptor that initiate that chain of interactions comprise the targeted receptor subunits. For instance, if the therapy is a JAK inhibitor, then it targets the JAK signaling pathway which is triggered by the CD 132 receptor subunit, and so the targeted receptor subunits would comprise CD132 and any receptor subunits that form complexes with it.

In some embodiments, analysis of receptor-ligand binding and trafficking dynamics comprises calculating the extent of signaling that is occurring or will occur on a given receptor as represented by the number of receptor-ligand surface complexes, using measurable input values such as, for example, the number of receptors, the concentration of ligand, and the binding affinity of the ligand for the receptor. Such calculations take into account the forward and reverse rates at which a ligand binds to a receptor, as well as the rates at which ligands, receptors, and their complexes move between the cell surface and endosomes. In other words, generating a set of output values from a set of input values whereby the output values are a number of receptor ligand surface complexes, and the process of generating the output values takes into account the association and dissociation rates of ligand and receptor, and the movement of receptors and complexes between the cell surface and endosomes.

In some embodiments, analysis assembly dynamics comprises calculating the extent to which receptor subunits come together to form complexes, taking into account the association and dissociation rates with which the various receptor subunits come together to form complexes. In other words, generating a set of output values from a set of input values whereby the output values are a number of receptors composed of two or more particular subunits, and the process of generating the output values takes into account the association and dissociation rates of the various receptor subunits.

Aspects of the disclosure comprise providing input values for a therapy's target receptor subunit(s). For a therapy that agonizes or antagonizes a receptor subunit, a therapy's target receptor subunit comprises the receptor subunit(s) that it agonizes or antagonizes and any receptor subunit(s) that form(s) complexes with that receptor unit. In one embodiment, for an anti-CD25 therapy, the target receptor subunits comprises CD25, CD122, and CD132. For a therapy that alters the quantity of one or more ligands, a therapy's target receptor subunit comprises the receptor subunit(s) that bind to said ligand(s). For a therapy that modulates a pathway triggered by a receptor or receptor subunit, a therapy's target receptor subunit comprises the receptor subunit(s) that trigger said pathway.

Aspects of the disclosure comprise providing input values comprising the absolute or relative quantity of receptor units that interact with the therapy's target receptor unit. In some embodiments, the interaction comprises binding, allosterically modifying, forming complexes with, or causing conformation change(s).

The methods described herein have important implications for treating subjects and also for the clinical development of new treatments. Determining whether a subject will benefit from continued treatment or would benefit from a change in treatment is clinically useful. One example of clinical usefulness of the methods of this invention includes identifying subjects who are less likely or more likely to respond to a treatment. The methods are also useful in predicting or determining that a subject would benefit from continued treatment or would benefit from a change in treatment. Health care practitioners and providers select treatment regimens based upon the expected net benefit to the subject. The net benefit is derived from the risk to benefit ratio. The present disclosure permits the determination of whether a subject will benefit from continued treatment or would benefit from a change in treatment, thereby aiding a physician in selecting a treatment.

Another example of clinical usefulness, in the case of human subjects for example, includes aiding clinical investigators in the selection for clinical trials of subjects with a high likelihood of obtaining a net benefit. It is expected that clinical investigators now will use the present disclosure for determining entry criteria for clinical trials.

### EXAMPLES

### Example 1

### Predicting the Effects of an Anti-CD25 Therapy on a Subject Prior to Treatment

In one embodiment, the therapy is an antibody against CD25. The therapy's target receptor subunits are CD25, CD122, and CD132. The ligand that interacts with the therapy's target receptor subunits is IL-2. The receptor subunits that interact with the therapy's target receptor subunits are CD124, CD127, CD129, IL-15Ralpha, and IL-21Ralpha. The ligands that interact with receptor subunits that interact with the therapy's target receptor subunits are: IL-4, IL-7, IL-9, IL-15, and IL-21. The receptor subunits and ligands considered further include TSLPR, IL-13Ralpha1, TSLP, and IL-13. The receptor subunits considered further include IL-13Ralpha2.

### Methods and Methods:

In one embodiment, assaying a sample further comprises utilizing the following protocol adapted from [Cesana, 2006], [Venken, 2008], [Hatjiharissi, 2007]

Blood Collection: Whole blood is collected in heparin-containing Vacutainer tubes (BD or equivalent).

Determining absolute cell counts: TruCount Tubes (BD Biosciences or equivalent) are utilized to determine accurate cell counts. Cells are stained with fluorescently labeled antibodies against the following eight makers (human): CD3, CD4, CD25, CD127, CD45RA, CD56, CD16, and CD19. Define the five key subsets as follows:

nTregs: CD4⁺CD25^{high}CD127^{low}CD45RA⁻
mTregs: CD4⁺CD25^{high}CD127^{low}CD45RA⁺

### CD56^{bright} NK: CD56^{bright}CD16^{dim}

### CD56^{dim} NK: CD56^{dim}CD16^{bright}

### B Cells: CD 19⁺

Cell counts for each subset are determined using a FACS Aria or FACS Calibur (BD Biosciences or equivalent).

Isolating peripheral blood mononuclear cells (PBMCs): PBMCs are isolated from whole blood using Ficoll density gradient centrifugation (Histopaque, Sigma-Aldrich; Amersham; or equivalent).

Cell sorting: Relevant subsets are separated. Cells are stained with fluorescently labeled antibodies against the following eight makers (human): CD3, CD4, CD25, CD127, CD45RA, CD56, CD 16, and CD 19. The five key subsets are defined as follows:

nTregs: CD4⁺CD25^{high}CD127^{low}CD45RA⁻
mTregs: CD4⁺CD25^{high}CD127^{low}CD45RA⁺

### CD56^{bright} NK: CD56^{bright}CD16^{dim}

### CD56^{dim} NK: CD56^{dim}CD16^{bright}

### B Cells: CD 19⁺

Each subset is isolated using a FACS Aria, FACS Calibur (BD Biosciences) or equivalent.

CELL SURFACE Receptor Quantification: Each of the four FACS-sorted cell subsets collected above is stained with phycoerythrin (PE) conjugated antibodies against one or more of the following targets: CD25, CD122, CD132, CD124, CD127, CD129, IL-15Ralpha, IL-21Ralpha, TSLPR, IL-13Ralpha1, and IL-13Ralpha2.

One or more of the following reagents (or equivalent) is utilized:

Monoclonal Anti-Human CD25 Phycoerythrin (Catalog Number FAB1020P: R&D Systems, Minneapolis, Minn. USA) or PE Mouse Anti-Human CD25 (Catalog Number 555432 Becton Dickinson Biosciences, San Jose, Calif. USA)

Monoclonal Anti-human IL-2Rβ (CD122)-Phycoerythrin (Catalog Number: FAB224P R&D Systems, Minneapolis, Minn. USA) or PE Mouse Anti-Human CD122 (Catalog Number: 554522 Becton Dickinson Biosciences, San Jose, Calif. USA)

Anti-human CD 132/Common γ chain-Phycoerythrin Monoclonal Antibody (Catalog Number: IC2841P R&D Systems, Minneapolis, Minn. USA) or PE Rat Anti-Human CD132 (Catalog Number 555898 Becton Dickinson Biosciences, San Jose, Calif. USA) or PE Mouse Anti-Human CD132 (Catalog Number 555900 Becton Dickinson Biosciences, San Jose, Calif. USA)

Monoclonal Anti-human IL-4 Rα (CD124)-Phycoerythrin (Catalog Number: FAB230P R&D Systems, Minneapolis, Minn. USA) or PE Mouse Anti-Human CD124 (Catalog Number 552178 Becton Dickinson Biosciences, San Jose, Calif. USA).

Monoclonal Anti-human IL-7 Rα/CD127-Phycoerythrin (Catalog Number: FAB306P R&D Systems, Minneapolis, Minn. USA) or PE Mouse Anti-Human CD127 (Catalog Number 557938 Becton Dickinson Biosciences, San Jose, Calif. USA).

Monoclonal Anti-human IL-9 R-Phycoerythrin (Catalog Number: FAB290P R&D Systems, Minneapolis, Minn. USA) or PE Anti-Human IL-9 Receptor (CD129) (Catalog Number 310403 BioLegend, San Diego, Calif. USA).

Monoclonal Anti-human IL-15 Rα-Phycoerythrin (Catalog Number: FAB1471P R&D Systems, Minneapolis, Minn. USA) or PE Anti-human CD359 (IL-15Ra) Antibody (Catalog Number 330207 BioLegend, San Diego, Calif. USA).

Monoclonal Anti-human IL-21 R-Phycoerythrin (Catalog Number: FAB9911P R&D Systems, Minneapolis, Minn. USA) or PE Mouse Anti-Human IL-21R (Catalog Number 560264 Becton Dickinson Biosciences, San Jose, Calif. USA) or PE Anti-human CD360 (IL-21R) Antibody (Catalog Number 347805, BioLegend, San Diego, Calif. USA).

PE Anti-human TSLPR (TSLP-R) Antibody (Catalog Number 322805, BioLegend, San Diego, Calif. USA) or Phycoerythrin (PE) anti-human TSLP Receptor (TSLPR, thymic stromal derived lymphopoietin receptor) (Catalog Number 12-5499, eBioscience, San Diego, Calif. USA).

Monoclonal Anti-human IL-13 Rα1-Phycoerythrin (Catalog Number: FAB1462P R&D Systems, Minneapolis, Minn. USA).

IL13 receptor alpha 2 antibody [B-D13] (Phycoerythrin) (Catalog Number: ab27415 or ab34931, Abcam, Cambridge, Mass. USA)

The number of receptors per cell for each receptor type are quantified in each cell subset, calibrating using QuantiBRITE PE Phycoerythrin Fluorescence Quantitation Beads (Catalog Number 340495: Becton Dickinson Immunocytometry Systems, San Jose, Calif. USA) using techniques described in [Pannu, 2001] and [Hatjiharissi, 2007].

Alternately, a technique that determines molecules of equivalent soluble fluorescein (MESF) is used to determine receptor quantities.

Intracellular and Cell Surface Receptor Quantification: After quantifying only the cell surface receptors using the above procedure, the cells are permeabilized using CytoFix/Cytoperm (Catalog Number 554722, Becton Dickinson Biosciences, San Jose, Calif. USA) or equivalent. Then the above “Cell Surface Receptor Quantification” procedure is repeated, but in this case will yield the total (intracellular+cell surface) receptor levels. The intracellular levels is then calculated for each receptor by subtracting the surface levels from the total levels as in [Hodge, 2000].

Measure Cytokine Levels: Serum cytokine levels are determined as in [Sabatino, 2008] using a SearchLight multiplex array (Aushon Biosystems, Billerica, Mass. USA) to measure the concentrations of IL-2, IL-4, IL-7, IL-9, IL-15, IL-21, IL-13, and TSLP in the patient's serum. While IL-21 is not currently available, it can be measured separately using an ELISA kit such as the Human IL-21 ELISA MAX™ Deluxe (Catalog Number 433804, BioLegend, San Diego, Calif. USA) or the Human IL-21 ELISA Ready-SET-Go! Set (Catalog Number 88-7216, eBioscience, San Diego, Calif. USA).

In one embodiment, the measurements resulting from the above protocols comprise the initial conditions that are input into the computational model as defined in the table below. In this example, Cell Type A is defined to be CD56bright NK cells, but in other embodiments it could be other cell types, or repeated for multiple cell types.

Table of Measured Parameters: Initial Conditions (t = 0)

| parameter | Definition |
|---|---|
| R_{S}^{CellTypeA:CD25}[t = 0] | Surface CD25 receptor subunits per Cell |
| | Type A |
| R_{S}^{CellTypeA:CD122}[t = 0] | Surface CD122 receptor subunits per Cell |
| | Type A |
| R_{S}^{CellTypeA:CD132}[t = 0] | Surface CD132 receptor subunits per Cell |
| | Type A |
| R_{S}^{CellTypeA:IL4RA}[t = 0] | Surface CD124 receptor subunits per Cell |
| | Type A |
| R_{S}^{CellTypeA:CD127}[t = 0] | Surface CD127 receptor subunits per Cell |
| | Type A |
| R_{S}^{CellTypeA:IL9R}[t = 0] | Surface CD129 receptor subunits per Cell |
| | Type A |
| R_{S}^{CellTypeA:IL15RA}[t = 0] | Surface IL-15Ralpha (CD359) receptor |
| | subunits per Cell Type A |
| R_{S}^{CellTypeA:IL21R}[t = 0] | Surface IL-21R (CD360) receptor subunits per |
| | Cell Type A |
| R_{S}^{CellTypeA:TSLPR}[t = 0] | Surface TSLP receptor subunits per Cell |
| | Type A |
| R_{S}^{CellTypeA:IL13Ra1}[t = 0] | Surface IL-13Ralpha1 receptor subunits per |
| | Cell Type A |
| R_{S}^{CellTypeA:IL13Ra2}[t = 0] | Surface IL-13Ralpha2 receptor subunits per |
| | Cell Type A |
| Rᵢ^{CellTypeA:CD25}[t = 0] | Intracellular CD25 receptor subunits per Cell |
| | Type A |
| Rᵢ^{CellTypeA:CD122}[t = 0] | Intracellular CD122 receptor subunits per Cell |
| | Type A |
| Rᵢ^{CellTypeA:CD132}[t = 0] | Intracellular CD132 receptor subunits per Cell |
| | Type A |
| Rᵢ^{CellTypeA:IL4RA}[t = 0] | Intracellular CD124 receptor subunits per Cell |
| | Type A |
| Rᵢ^{CellTypeA:CD127}[t = 0] | Intracellular CD127 receptor subunits per Cell |
| | Type A |
| Rᵢ^{CellTypeA:IL9R}[t = 0] | Intracellular CD129 receptor subunits per Cell |
| | Type A |
| Rᵢ^{CellTypeA:IL15RA}[t = 0] | Intracellular IL-15Ralpha (CD359) receptor |
| | subunits per Cell Type A |
| Rᵢ^{CellTypeA:IL21R}[t = 0] | Intracellular IL-21R (CD360) receptor subunits |
| | per Cell Type A |
| Rᵢ^{CellTypeA:TSLPR}[t = 0] | Intracellular TSLP receptor subunits per Cell |
| | Type A |
| Rᵢ^{CellTypeA:IL13Ra1}[t = 0] | Intracellular IL-13Ralpha1 receptor subunits |
| | per Cell Type A |
| Rᵢ^{CellTypeA:IL13Ra2}[t = 0] | Intracellular IL-13Ralpha2 receptor subunits |
| | per Cell Type A |
| L^{IL2}[t = 0] | Concentration of IL-2 in serum |
| L^{IL4}[t = 0] | Concentration of IL-4 in serum |
| L^{IL7}[t = 0] | Concentration of IL-7 in serum |
| L^{IL9}[t = 0] | Concentration of IL-9 in serum |
| L^{IL15}[t = 0] | Concentration of IL-15 in serum |
| L^{IL21}[t = 0] | Concentration of IL-21 in serum |
| L^{IL13}[t = 0] | Concentration of IL-13 in serum |
| L^{ILTSLP}[t = 0] | Concentration of TSLP in serum |
| Y^{CellTypeA}[t = 0] | Cell Type A starting cell count |

In one embodiment, the method comprises assessing these measured values using a computational model. Here we discuss the background for said model.

Careful work by Smith, beginning with a key study in 1984 [Cantrell, 1984] and continuing to today, has led to the quantal theory of immunology. This theory predicts that T cells or other lymphocytes will proliferate once the number of formed receptor-ligand complexes, integrated over time, crosses a certain threshold. In the quantal theory, the parameters having the most impact on proliferation time are the number of receptors per cell, the binding affinity of those receptors, and the number of cells present. In addition, the binding and trafficking dynamics have a significant impact. This includes internalization rates, degradation rates, recycling rates, and so forth.

Lauffenburger and colleagues developed computational models of these binding and trafficking dynamics, and demonstrated the ability to predict CD8+ T cell proliferation in vitro in response to IL-2 [Fallon, 2000]. While Lauffenburger references Smith's work, he uses a proliferation rate that is based on the instantaneous number of receptor-ligand surface complexes, rather than the integral of these complexes over time. This was a reasonable approximation for the situation that Lauffenburger was modeling, in which proliferation had little effect on the outcome, but for modeling cell proliferation following high dose IL-2-induced lymphopenia it is critical to capture Smith's findings more directly. We therefore substitute a zero proliferation rate, solve for the instantaneous number of receptor-ligand complexes for each receptor type, sum this value over time, and determine which receptor type first reaches the threshold number of complexes, and when.

Lauffenburger's model focuses on a single receptor type (IL-2). We made the non-obvious decision to build a model of multiple receptor types competing for the same CD 132 subunit. It is highly non-obvious that such an approach would result in an effective means to predict response to therapy.

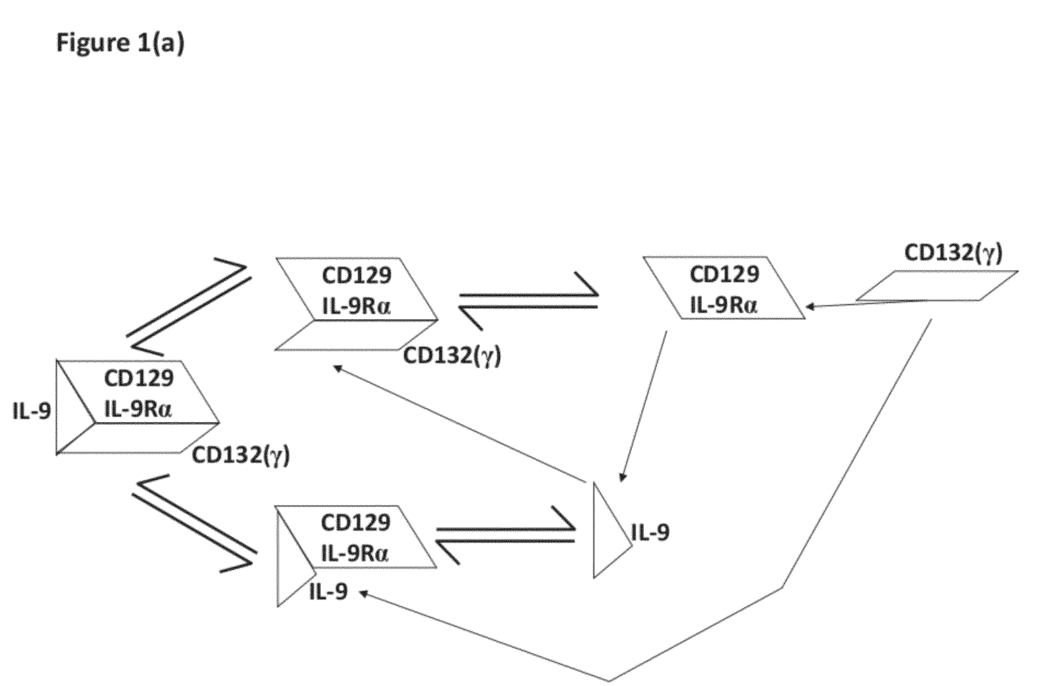

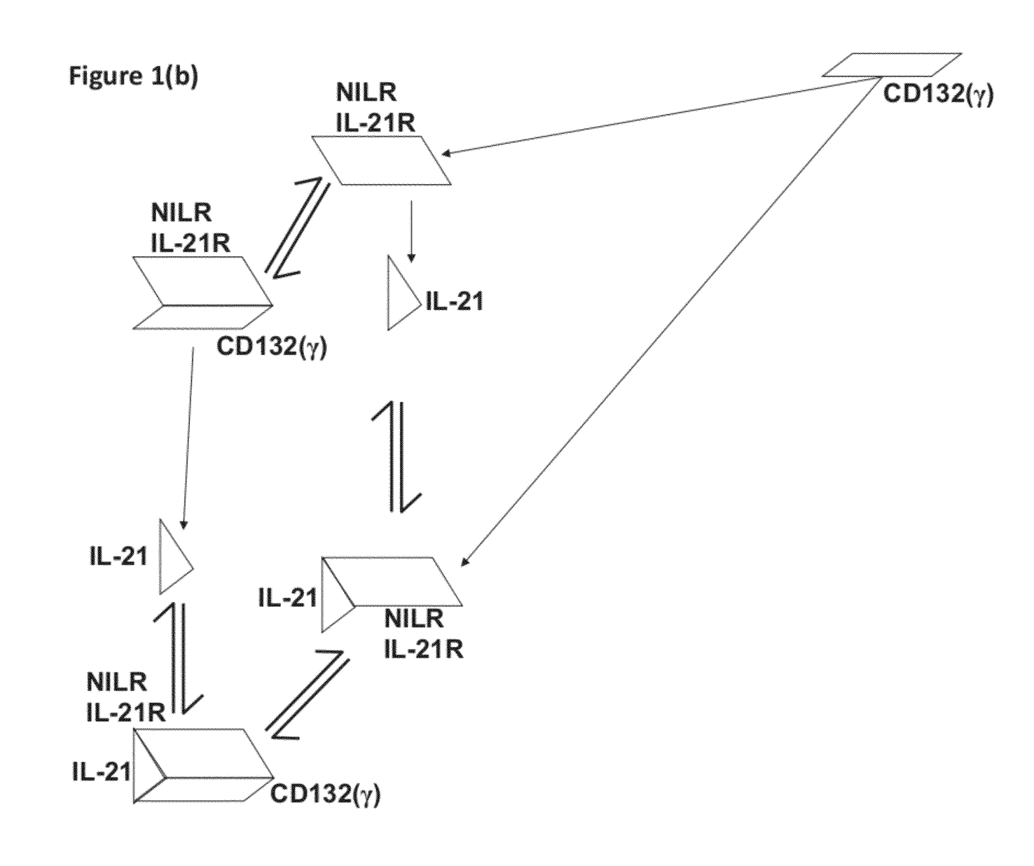

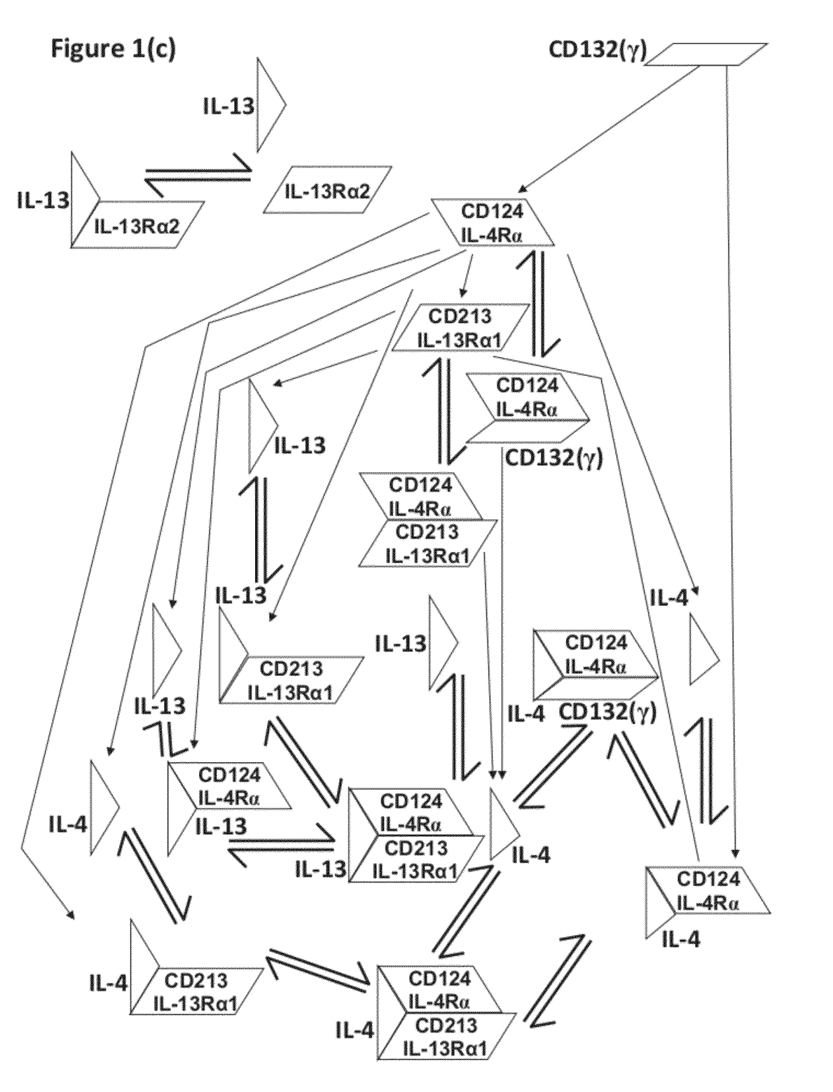

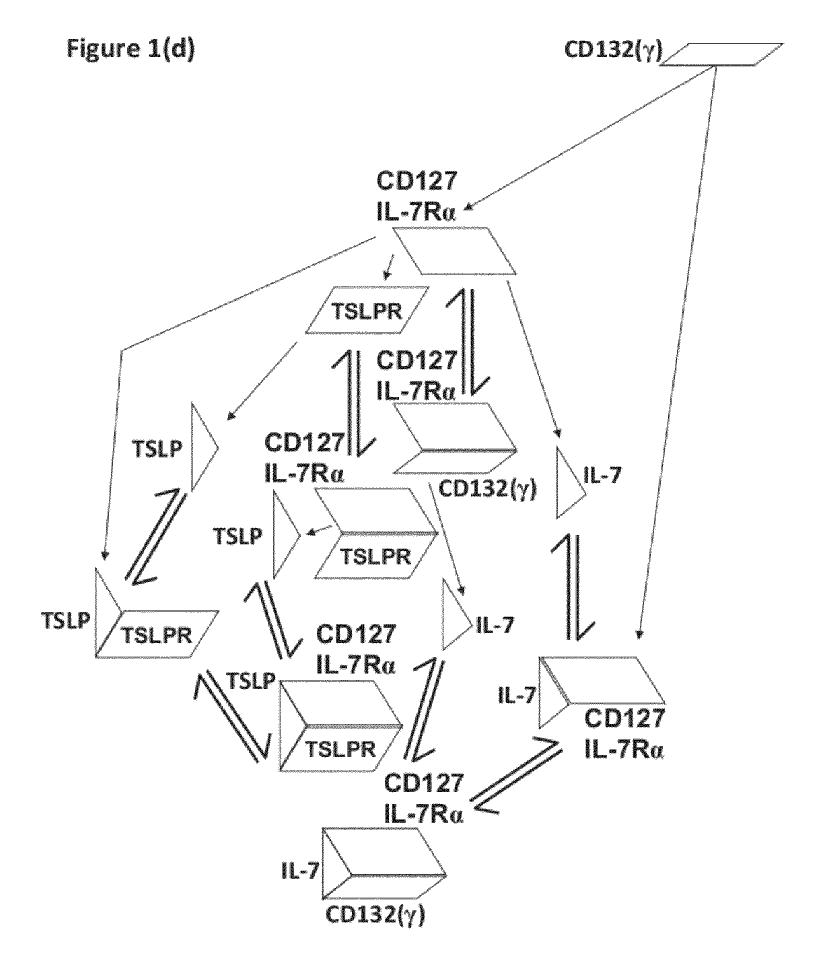

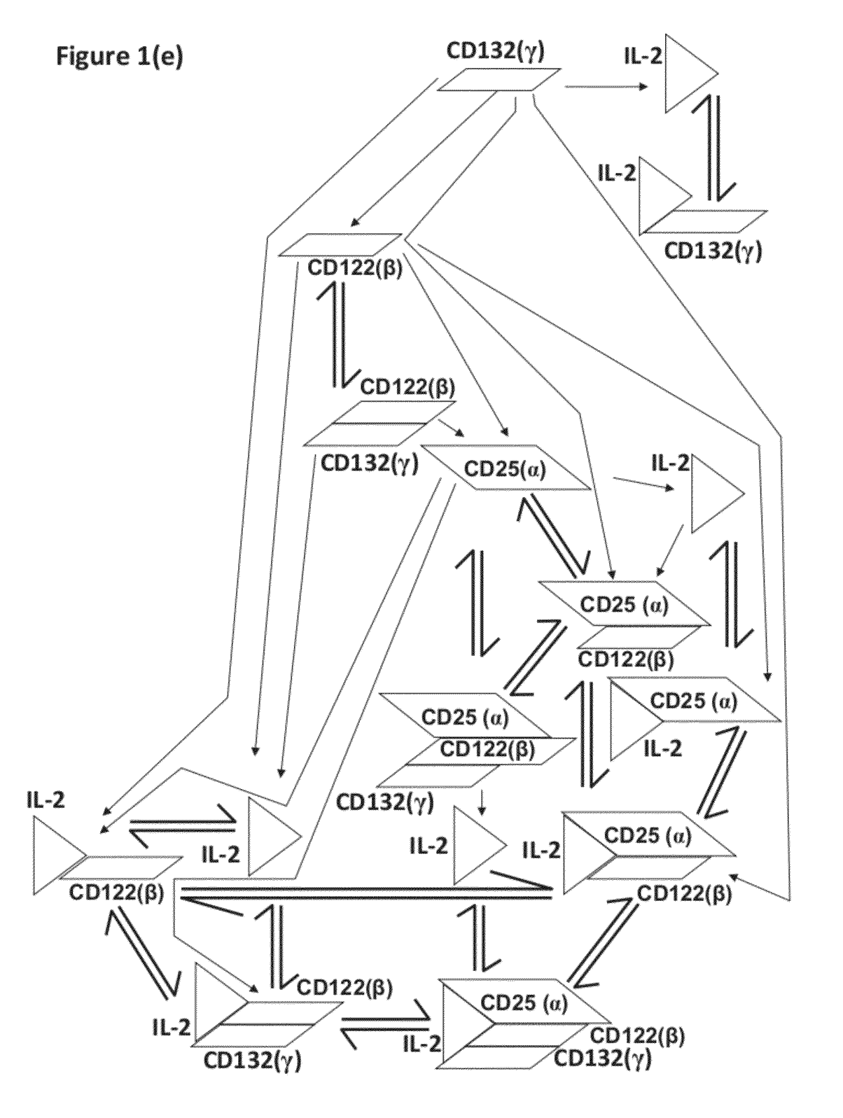

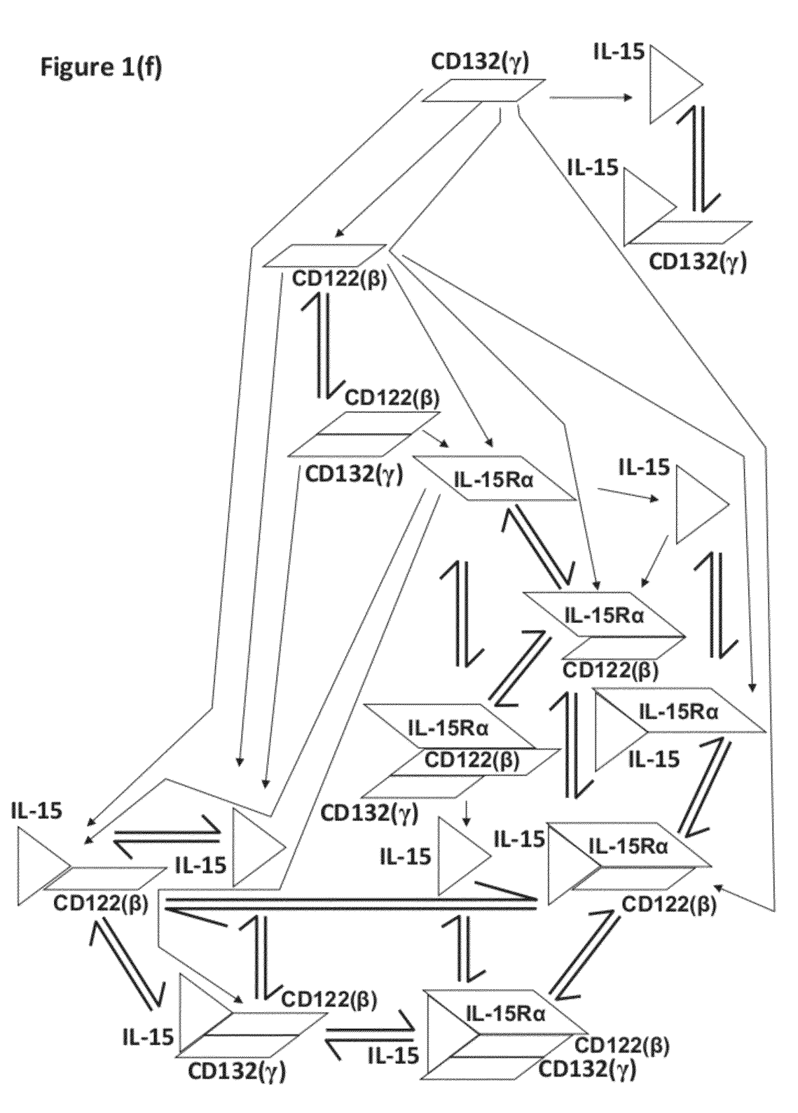

FIG. 1 illustrates the receptor subunit and cytokine interactions upon which the model equations are based. FIG. 1(a) shows the portion of the interactions involving the IL-9 receptor. FIG. 1(b) shows the portion of the interactions involving the IL-21 receptor. FIG. 1(c) shows the portion of the interactions involving the IL-4 and IL-13 receptors. FIG. 1(d) shows the portion of the interactions involving the IL-7 and TSLP receptors. FIG. 1(e) shows the portion of the interactions involving the IL-2 receptor. FIG. 1(f) shows the portion of the interactions involving the IL-15 receptor.

In one particular embodiment, the following format is used to define relevant parameters to represent interactions:

kf_X_Y is defined as the surface forward rate constant of X binding to Y.
kr_X_Y is defined as the surface reverse rate constant of X binding to Y.
kfe_X_Y is defined as the internal forward rate constant of X binding to Y.
kre_X_Y is defined as the internal reverse rate constant of X binding to Y.
ksyn_X_Y is defined as the rate at which X in synthesized in response to the binding event indicated in Y.
kt_celltypea_X is defined as the constitutive internalization rate of X on cell type a.
ke_celltypea_X is defined as the internalization rate of X on cell type a.
kh_celltypea_X is defined as the degradation rate of X on cell type a.
kx_celltypea_X is defined as the recycling rate of X on cell type a.
vs_celltypea_X is defined as the rate at which X is synthesized on cell type a.
ve is defined as the total endosomal volume.
na is defined as Avogadro's Number in nM.
veff is defined as an effective volume in order to modify the three dimensional equations to properly represent the two dimensional interactions between receptor subunits in a membrane.

In one particular embodiment, using the above format to define parameters, the following parameters are provided from literature values as indicated, although in other embodiments other values may be used or the values may be measured:

ve=10̂-14;% L/cell [Fallon, 2000]total endosomal volume

na=6.02e23/(10̂9); % Avogadro's Number, units in nM

veff=(4*pi*(5e-6)̂2)*(1e-9)*1000;% effective volume (liters per cell) for 2D 1000 L/m̂3. 5 um radius. 10 nm height.

kf_il2_cd132=0;% “Not detectable” [Taniguchi, 1993] “No interaction” [Rickert, 2004]
kr_il2_cd132=0.0138;% min ̂-1, TEMP IL-2 [Fallon, 2000]
kfe_il2_cd132=0;%
kre_il2_cd132=0.0138;% min ̂-1, TEMP IL-2 [Fallon, 2000]

kr_cd25_cd122=0.0138;% min ̂-1, TEMP IL-2 [Fallon, 2000]
kf_cd25_cd122=(1/(na*veff)*kr_cd25_cd122/278;% nM̂-1 min ̂-1 [Rickert, 2004]
kfe_cd25_cd122=0;% Does not occur—[Fallon, 2000]—all CD25 dissociates
kre_cd25_cd122=1000000;% Set arbitrarily high because—[Fallon, 2000]—all CD25 dissociates

kf_cd122_cd132=(1/(na*veff))*0;% No binding detected by [Rickert, 2004]
kr_cd122_cd132=0.0138;% min ̂-1, TEMP IL-2 [Fallon, 2000]
kfe_cd122_cd132=0;%
kre_cd122_cd132=0.0138;% min ̂-1, TEMP IL-2 [Fallon, 2000]

kr_il2_cd122_cd132=0.0138;% min ̂-1, TEMP IL-2 [Fallon, 2000]
kf_il2_cd122_cd132=kr_il2_cd122_cd132/1.1;% Exact number scaled from [Fallon, 2000]. Range confirmed by [Voss, 1992]
kre_il2_cd122_cd132=8*kr_il2_cd122_cd132;% [Fallon, 2000]
kfe_il2_cd122_cd132=kre_il2_cd122_cd132/1;%[Fallon, 2000] expressed in nM instead of pM

kr_il2_cd25_cd122_cd132=0.0138;% min ̂-1, TEMP IL-2 [Fallon, 2000]
kf_il2_cd25_cd122_cd132=kr_il2_cd25_cd122_cd132/0.011;% Exact number from [Fallon, 2000]. Range confirmed by [Voss, 1992]
kfe_il2_cd25_cd122_cd132=0;% Does not occur—[Fallon, 2000]—all CD25 dissociates
kre_il2_cd25_cd122_cd132=1000000;% Set arbitrarily high because—[Fallon, 2000]—all CD25 dissociates

kf_cd25_cd122_cd132=(1/(na*veff))*0;% Not discussed by [Rickert, 2004]—assume not favorable
kr_cd25_cd122_cd132=0.0138;% min ̂-1, TEMP IL-2 [Fallon, 2000]
kfe_cd25_cd122_cd132=0;%
kre_cd25_cd122_cd132=1000000;% Set arbitrarily high because—[Fallon, 2000]—all CD25 dissociates

kr_il2_cd122=0.0138;% min ̂-1, TEMP IL-2 [Fallon, 2000]
kf_il2_cd122=kr_il2_cd122/144;% nMA-1 min ̂-1 [Rickert, 2004] BUT [Myszka, 1996] says 450 nM—2 citations
kre_il2_cd122=8*kr_il2_cd122;% Use same proportions as IL-2 binding to CD122/CD132 complex from [Fallon, 2000]
kfe_il2_cd122=kre_il2_cd122/1;% Use same proportions as IL-2 binding to CD122/CD132 complex from [Fallon, 2000]

kr_cd122_il2_cd25=0.0138;% min ̂-1, TEMP IL-2 [Fallon, 2000]=0;%
kf_cd122_il2_cd25=(1/(na*veff)*kr_cd122_il2_cd25/63;% nMA-1 min ̂-1 [Rickert, 2004]
kfe_cd122_il2_cd25=0;% Does not occur—[Fallon, 2000]—all CD25 dissociates
kre_cd122_il2_cd25=1000000;% Set arbitrarily high because—[Fallon, 2000]—all CD25 dissociates, so no complexes

kr_il2_cd25=0.0138;% min ̂-1, TEMP IL-2 [Fallon, 2000]
kf_il2_cd25=kr_il2_cd25/10;% nMA-1 min ̂-1 [Rickert, 2004] [Myszka, 1996] agrees
kfe_il2_cd25=0;% Does not occur—[Fallon, 2000]—all CD25 dissociates
kre_il2_cd25=1000000;% Set arbitrarily high because—[Fallon, 2000]—all CD25 dissociates, so no complexes

kf_cd25_il2_cd122_cd132=(1/(na*veff)*kf_il2_cd25;% Assume same binding affinity as CD25 to free IL-2. Stickiest interaction, and assume CD122/CD132 doesn't significantly add or interfere.
kr_cd25_il2_cd122_cd132=kr_il2_cd25;% min ̂-1, Assume same binding affinity as CD25 to free IL-2
kfe_cd25_il2_cd122_cd132=0;% Does not occur—[Fallon, 2000]—all CD25 dissociates
kre_cd25_il2_cd122_cd132=1000000;% Set arbitrarily high because—[Fallon, 2000]—all CD25 dissociates, so no complexes

kr_il2_cd25_cd122=0.0138;% min ̂-1, TEMP IL-2 [Fallon, 2000]
kf_il2_cd25_cd122=kr_il2_cd25_cd122/0.4;% nM̂-1 min ̂-1, [Myska, 1996]—0.2-0.6 nM
kfe_il2_cd25_cd122=0;% Does not occur—[Fallon, 2000]—all CD25 dissociates
kre_il2_cd25_cd122=1000000;% Set arbitrarily high because—[Fallon, 2000]—all CD25 dissociates, so no complexes

kf_cd25_il2_cd122=(1/(na*veff)*kf_il2_cd25;% Assume same binding affinity as IL-2 to free CD25. Stickiest interaction, and assume CD122 doesn't significantly add or interfere.
kr_cd25_il2_cd122=kr_il2_cd25;% min ̂-1, Assume same binding affinity as IL-2 to free CD25. Stickiest interaction, and assume CD122 doesn't significantly add or interfere.
kfe_cd25_il2_cd122=0;% Does not occur—[Fallon, 2000]—all CD25 dissociates
kre_cd25_il2_cd122=1000000;% Set arbitrarily high because—[Fallon, 2000]—all CD25 dissociates, so no complexes

kf_il15_cd122=kf_il2_cd122;% Assume similar to IL-2
kr_il15_cd122=kr_il2_cd122;% min ̂-1, Assume similar to IL-2
kfe_il15_cd122=kfe_il2_cd122;% Assume similar to IL-2
kre_il15_cd122=kre_il2_cd122;% Assume similar to IL-2

kf_il15_cd122_cd132=kf_il2_cd122_cd132;% CRUCIAL INTERACTION—PRESENTED IN TRANS FROM OTHER CELLS. 1.1 nm Similar affinity to IL-2 for CD122/CD132 [Vamosi, 2004]
kr_il15_cd122_cd132=kr_il2_cd122_cd132;% 0.0138 min ̂-1
kfe_il15_cd122_cd132=kfe_il2_cd122_cd132;%
kre_il15_cd122_cd132=kre_il2_cd122_cd132;%

kr_il15_il15r=0.0138;% min ̂-1, TEMP IL-2 [Fallon, 2000]
kf_il15_il5r=kr_il15_il5r/0.05;% nMA-1 min ̂-1 (KD=5×10̂-11) [Mortier, 2008]
kre_il15_il5r=8*kr_il15_il15r;% min ̂-1, Use same proportions as IL-2 binding to CD122/CD132 complex from [Fallon, 2000]
kfe_il15_il15r=kre_il15_il15r/1;% Use same proportions as IL-2 binding to CD122/CD132 complex from [Fallon, 2000]

kf_il15il15r_cd122_cd132=kf_il15_il15r;% Same for Trimeric and IL-15Ralpha [Vamosi, 2004]
kr_il15_il15r_cd122_cd132=kr_il15_il15r;% min ̂-1
kfe_il15_il15r_cd122_cd132=kfe_il15_il15r;%
kre_il15_il15r_cd122_cd132=kre_il15_il15r;% min ̂-1

kf_cd122_cd132_il15_il15r=(1/(na*veff))*0;%TEMP leave as zero b/c “Neither population expressed IL-4RA and IL-15RA chains” [Bielekova, 2006]
kr_cd122_cd132_il15_il15r=0.0138;% min ̂-1, TEMP IL-2 [Fallon, 2000]
kfe_cd122_cd132_il15_il15r=0;%TEMP leave as zero b/c “Neither population expressed IL-4RA and IL-15RA chains” [Bielekova, 2006]
kre_cd122_cd132_il15_il15r=0.0138;% min ̂-1, TEMP IL-2 [Fallon, 2000]

kf_il15r_cd122_cd132=(1/(na*veff))*0;%TEMP leave as zero b/c “Neither population expressed IL-4RA and IL-15RA chains” [Bielekova, 2006]
kr_il15r_cd122_cd132=0.0138;% min ̂-1, TEMP IL-2 [Fallon, 2000]
kfe_il15r_cd122_cd132=0;%TEMP leave as zero b/c “Neither population expressed IL-4RA and IL-15RA chains” [Bielekova, 2006]
kre_il15r_cd122_cd132=0.0138;% min ̂-1, TEMP IL-2 [Fallon, 2000]

kf_il15r_cd122=(1/(na*veff))*0;%TEMP leave as zero b/c “Neither population expressed IL-4RA and IL-15RA chains” [Bielekova, 2006]
kr_il15r_cd122=0.0138;% min ̂-1, TEMP IL-2 [Fallon, 2000]
kfe_il15r_cd122=0;%TEMP leave as zero b/c “Neither population expressed IL-4RA and IL-15RA chains” [Bielekova, 2006]
kre_il15r_cd122=0.0138;% min ̂-1, TEMP IL-2 [Fallon, 2000]

kf_il15il15r_cd122=0;%TEMP leave as zero b/c “Neither population expressed IL-4RA and IL-15RA chains” [Bielekova, 2006]
kr_il15_il15r_cd122=0.0138;% min ̂-1, TEMP IL-2 [Fallon, 2000]
kfe_il15_il15r_cd122=0;%TEMP leave as zero b/c “Neither population expressed IL-4RA and IL-15RA chains” [Bielekova, 2006]
kre_il15_il15r_cd122=0.0138;% min ̂-1, TEMP IL-2 [Fallon, 2000]

kf_cd122_il15_il15r=(1/(na*veff))*0;%TEMP leave as zero b/c “Neither population expressed IL-4RA and IL-15RA chains” [Bielekova, 2006]
kr_cd122_il15_il15r=0.0138;% min ̂-1, TEMP IL-2 [Fallon, 2000]
kfe_cd122_il15_il15r=0;%TEMP leave as zero b/c “Neither population expressed IL-4RA and IL-15RA chains” [Bielekova, 2006]
kre_cd122_il15il15r=0.0138;% min ̂-1, TEMP IL-2 [Fallon, 2000]

kf_il15r_il15_cd122=(1/(na*veff))*0;%TEMP leave as zero b/c “Neither population expressed IL-4RA and IL-15RA chains” [Bielekova, 2006]
kr_il15r_il15_cd122=0.0138;% min ̂-1, TEMP IL-2 [Fallon, 2000]
kfe_il15r_il15_cd122=0;%TEMP leave as zero b/c “Neither population expressed IL-4RA and IL-15RA chains” [Bielekova, 2006]
kre_il15r_il15_cd122=0.0138;% min ̂-1, TEMP IL-2 [Fallon, 2000]

kf_il15r_il15_cd122_cd132=(1/(na*veff))*0;%TEMP leave as zero b/c “Neither population expressed IL-4RA and IL-15RA chains” [Bielekova, 2006]
kr_il15r_il15_cd122_cd132=0.0138;% min ̂-1, TEMP IL-2 [Fallon, 2000]
kfe_il15r_il15_cd122_cd132=0;%TEMP leave as zero b/c “Neither population expressed IL-4RA and IL-15RA chains” [Bielekova, 2006]
kre_il15r_il15_cd122_cd132=0.0138;% min ̂-1, TEMP IL-2 [Fallon, 2000]

kf_il15_cd132=(1/(na*veff))*0;%TEMP leave as zero b/c “Neither population expressed IL-4RA and IL-15RA chains” [Bielekova, 2006]

kr_il15_cd132=0.0138;% min ̂-1, TEMP IL-2 [Fallon, 2000]

kfe_il15_cd132=0;%TEMP leave as zero b/c “Neither population expressed IL-4RA and IL-15RA chains” [Bielekova, 2006]

kre_il15_cd132=0.0138;% min ̂-1, TEMP IL-2 [Fallon, 2000]

%%%%%%%%%%%%%%%%%%%%%%%%%%%%%%%%% IL-7/TSLP

%kf_cd127_cd132=1;% nM̂-1 min ̂-1 [Palmer, 2008]

kf_cd127_cd132=(1/(na*veff))*0;% nMA-1 min ̂-1 ASSUME UNLIKELY (temp)
kr_cd127_cd132=0.1;% min ̂-1, [Palmer, 2008]
%kr_cd127_cd132=0.1;% min ̂-1, [Palmer, 2008]
kfe_cd127_cd132=0;%
kre_cd127_cd132=0;%

kr_il7_cd127_cd132=0.0138;% min ̂-1, TEMP IL-2 [Fallon, 2000]
kf_il7_cd127_cd132=kr_il7_cd127_cd132/0.08;% nMA-1 min ̂-1 80 pM [Olosz, 2000]—
kfe_il7_cd127_cd132=0;%
kre_il7_cd127_cd132=0;%

kf_cd127_tslpr=(1/(na*veff))*0;%
kr_cd127_tslpr=0.0138;% min ̂-1, TEMP IL-2 [Fallon, 2000]
kfe_cd127_tslpr=0;%
kre_cd127_tslpr=0;%

kr_tslp_cd127_tslpr=0.0138;% min ̂-1, TEMP IL-2 [Fallon, 2000]
kf_tslp_cd127_tslpr=kr_tslp_cd127_tslpr/13;% nM̂-1 min ̂-1 [Pandey, 2000]
kfe_tslp_cd127_tslpr=0;%
kre_tslp_cd127_tslpr=0;%

kr_il7_cd127=60*(1e-1)*(4e-3)/(2.5e-3+4.1e-3);% min ̂-1 [McElroy, 2010] GLYCOSYLATED, OTHERWISE=kr_il7_cd127=60*(1.7e-2)*(1.2e-3)/(4.2e-3+1.2e-3) unglycosylated
kf_il7_cd127=kr_il7_cd127/56;% nM̂-1 min ̂-1 GLYCOSYLATED, OTHERWISE=kr_il7_cd127/18000 (18 uM) unglycosylated—[Olosz, 2000]: 200 pM
kfe_il7_cd127=0;%
kre_il7_cd127=0;%

kr_cd127_tslp_tslpr=0.0138;% min ̂-1, TEMP IL-2 [Fallon, 2000]
kf_cd127_tslp_tslpr=(1/(na*veff))*0;%
kfe_cd127_tslp_tslpr=0;%
kre_cd127_tslp_tslpr=0;%

kf_tslp_tslpr=0;% [Pandey, 2000]
kr_tslp_tslpr=0.0138;% min ̂-1, TEMP IL-2 [Fallon, 2000]
kfe_tslp_tslpr=0;%
kre_tslp_tslpr=0.0138;% min ̂-1, TEMP IL-2 [Fallon, 2000]

%%%%%%%%%%%%%%%%% IL-4/IL-13

kf_il4ra_cd132=(1/(na*veff))*0;%TEMP leave as zero b/c “Neither population expressed IL-4RA and IL-15RA chains” [Bielekova, 2006]
kr_il4ra_cd132=0.0138;% min ̂-1, TEMP IL-2 [Fallon, 2000]
kfe_il4ra_cd132=0;%TEMP leave as zero b/c “Neither population expressed IL-4RA and IL-15RA chains” [Bielekova, 2006]
kre_il4ra_cd132=0;%TEMP leave as zero b/c “Neither population expressed IL-4RA and IL-15RA chains” [Bielekova, 2006]

kf_cd124_cd132=(1/(na*veff))*0;%TEMP leave as zero b/c “Neither population expressed IL-4RA and IL-15RA chains” [Bielekova, 2006]
kr_cd124_cd132=0.0138;% min ̂-1, TEMP IL-2 [Fallon, 2000]
kfe_cd124_cd132=0;%TEMP leave as zero b/c “Neither population expressed IL-4RA and IL-15RA chains” [Bielekova, 2006]
kre_cd124_cd132=0;%TEMP leave as zero b/c “Neither population expressed IL-4RA and IL-15RA chains” [Bielekova, 2006]

kf_cd124_cd213=(1/(na*veff))*0;%TEMP leave as zero b/c “Neither population expressed IL-4RA and IL-15RA chains” [Bielekova, 2006]
kr_cd124_cd213=0.0138;% min ̂-1, TEMP IL-2 [Fallon, 2000]
kfe_cd124_cd213=0;%TEMP leave as zero b/c “Neither population expressed IL-4RA and IL-15RA chains” [Bielekova, 2006]
kre_cd124_cd213=0;%TEMP leave as zero b/c “Neither population expressed IL-4RA and IL-15RA chains” [Bielekova, 2006]

kr_il4_cd124_cd132=6.6;% min ̂-1, (0.11 ŝ-1 [Andrews, 2006])
kf_il4_cd124_cd132=kr_il4_cd124_cd132/1100;% nMA-1 min ̂-1 (KD=1.1 uM: [Andrews, 2006])
kfe_il4_cd124_cd132=0;%TEMP leave as zero b/c “Neither population expressed IL-4RA and IL-15RA chains” [Bielekova, 2006]
kre_il4_cd124_cd132=0;%TEMP leave as zero b/c “Neither population expressed IL-4RA and IL-15RA chains” [Bielekova, 2006]

kr_il13_cd213=(60*1.41e-3);% min ̂-1, IL-13 for shIL 13-Ra1 [Andrews, 2002]
kf_il13_cd213=kr_il13_cd213/37.8;% nMA-1 min ̂-1, [Andrews, 2002] [Kraich, 2006 agrees]
kfe_il13_cd213=0;%
kre_il13_cd213=0;%

kf_il13_cd124_cd213=kf_il13_cd213;% “The ka value obtained . . . was similar to that obtained for the binding of 1′-13 to IL-13Ra1 [Andrews, 2002]
kr_il13_cd124_cd213=(0.495)*kf_il13_cd124_cd213;% min ̂-1, 495 pM [Andrews, 2002]
kfe_il13_cd124_cd213=0;%
kre_il13_cd124_cd213=0;%

kr_il4_cd124=(60*1.67e-3);% min ̂-1, (1.67e-3 5̂-1 [Andrews, 2006])
kf_il4_cd124=kr_il4_cd124/(0.150);% nMA-1 min ̂-1, (Zhang, 2003 says 150 pM, Kraich, 2006 agrees) ([Andrews, 2006] says 382 pM)
kfe_il4_cd124=0;%TEMP leave as zero b/c “Neither population expressed IL-4RA and IL-15RA chains” [Bielekova, 2006]
kre_il4_cd124=0;%TEMP leave as zero b/c “Neither population expressed IL-4RA and IL-15RA chains” [Bielekova, 2006]

kf_il4_cd124_cd213=kf_il4_cd124;% “presence of IL-13Ra1 had no detectable effect on the binding of IL-4 to IL-4Ra” [Andrews, 2002]
kr_il4_cd124_cd213=kr_il4_cd124;% min ̂-1, “presence of IL-13Ra1 had no detectable effect on the binding of IL-4 to IL-4Ra” [Andrews, 2002]
kfe_il4_cd124_cd213=0;%TEMP leave as zero b/c “Neither population expressed IL-4RA and IL-15RA chains” [Bielekova, 2006]
kre_il4_cd124_cd213=0;%TEMP leave as zero b/c “Neither population expressed IL-4RA and IL-15RA chains” [Bielekova, 2006]

kf_il13_cd124=0;% NO DIRECT BINDING OBSERVED [Andrews, 2002]
kr_il13_cd124=1;% min ̂-1, Placeholder, no direct binding observed [Andrews, 2002]
kfe_il13_cd124=0;%TEMP leave as zero b/c “Neither population expressed IL-4RA and IL-15RA chains” [Bielekova, 2006]
kre_il13_cd124=0;%TEMP leave as zero b/c “Neither population expressed IL-4RA and IL-15RA chains” [Bielekova, 2006]

kf_cd124_il4_cd213=(1/(na*veff))*0;%TEMP leave as zero b/c “Neither population expressed IL-4RA and IL-15RA chains” [Bielekova, 2006]
kr_cd124_il4_cd213=0.0138;% min ̂-1, TEMP IL-2 [Fallon, 2000]
kfe_cd124_il4_cd213=0;%TEMP leave as zero b/c “Neither population expressed IL-4RA and IL-15RA chains” [Bielekova, 2006]
kre_cd124_il4_cd213=0;%TEMP leave as zero b/c “Neither population expressed IL-4RA and IL-15RA chains” [Bielekova, 2006]

kr_cd124_il13_cd213=0.0138;% min ̂-1, TEMP IL-2 [Fallon, 2000]
kf_cd124_il13_cd213=(1/(na*veff)*kr_cd124_il13_cd213/150;% [Kraich, 2006]
kfe_cd124_il13_cd213=0;%TEMP leave as zero b/c “Neither population expressed IL-4RA and IL-15RA chains” [Bielekova, 2006]
kre_cd124_il13_cd213=0;%TEMP leave as zero b/c “Neither population expressed IL-4RA and IL-15RA chains” [Bielekova, 2006]

kf_il4_cd213=0;% NO DIRECT BINDING OBSERVED [Andrews, 2006] or KD=2500 nm [Kraich, 2006]
kr_il4_cd213=1;% min ̂-1, Placeholder, no direct binding observed [Andrews, 2006]
kfe_il4_cd213=0;%
kre_il4_cd213=0;%

kf_cd213_il13_cd124=(1/(na*veff))*0;%TEMP leave as zero b/c “Neither population expressed IL-4RA and IL-15RA chains” [Bielekova, 2006]
kr_cd213_il13_cd124=0.0138;% min ̂-1, TEMP IL-2 [Fallon, 2000]
kfe_cd213_il13_cd124=0;%TEMP leave as zero b/c “Neither population expressed IL-4RA and IL-15RA chains” [Bielekova, 2006]
kre_cd213_il13_cd124=0;%TEMP leave as zero b/c “Neither population expressed IL-4RA and IL-15RA chains” [Bielekova, 2006]

kr_cd213_il4_cd124=0.0138;% min ̂-1, TEMP IL-2 [Fallon, 2000]
kf_cd213_il4_cd124=(1/(na*veff)*kr_cd213_il4_cd124/(1200);% [Kraich, 2006]
kfe_cd213_il4_cd124=0;%TEMP leave as zero b/c “Neither population expressed IL-4RA and IL-15RA chains” [Bielekova, 2006]
kre_cd213_il4_cd124=0;%TEMP leave as zero b/c “Neither population expressed IL-4RA and IL-15RA chains” [Bielekova, 2006]

kr_il13_il3ra2=(60*1.39e-4);% min ̂-1, IL13 to shIl-13Ra2 [Andrews, 2002]
kf_il13il13ra2=kr_il13_il3ra2/2.49;% nMA-1 min ̂-1 [Andrews, 2002]
kfe_il13_il3ra2=0;%
kre_il13_il3ra2=0;%

%%%%%%%%%%%%%%%%%%%% IL-9

%kf_il9r_cd132=0;%

%kr_il9r_cd132=0.0138;% min ̂-1, TEMP IL-2 [Fallon, 2000]

%kfe_il9r_cd132=0;%

%kre_il9r_cd132=0;%

kf_cd129_cd132=(1/(na*veff))*0;%
kr_cd129_cd132=0.0138;% min ̂-1, TEMP IL-2 [Fallon, 2000]
kfe_cd129_cd132=0;%
kre_cd129_cd132=0;%

kr_il9_cd129_cd132=0.0138;% min ̂-1, TEMP IL-2 [Fallon, 2000]
kf_il9_cd129_cd132=kr_il9_cd129_cd132/0.1;% nM̂-1 min ̂-1 Kd=100 pM [De Smedt, 2000]
kfe_il9_cd129_cd132=0;%
kre_il9_cd129_cd132=0;%

kf_il9_cd129=0;%
kr_il9_cd129=0.0138;% min ̂-1, TEMP IL-2 [Fallon, 2000]
kfe_il9_cd129=0;%
kre_il9_cd129=0;%

%%%%%%%%%%%%%%%%%%%%IL-21

kf_il21_il21r_cd132=0;%
kr_il21_il21r_cd132=0.0138;% min ̂-1, TEMP IL-2 [Fallon, 2000]
kfe_il21_il21r_cd132=0;%
kre_il21_il21r_cd132=0;%

kf_il21r_cd132=(1/(na*veff))*0;%
kr_il21r_cd132=0.0138;% min ̂-1, TEMP IL-2 [Fallon, 2000]
kfe_il21r_cd132=0;%
kre_il21r_cd132=0;%

kr_il21_il21r=(60*0.003);% min ̂-1, [Zhang, 2003]
kf_il21_il21r=kr_il21_il21r/(0.070);% nM̂-1 min ̂-1 70 pM [Zhang 2003]
kfe_il21_il21r=0;%
kre_il21_il21r=0;%

%%%%%%%%%%%%%%%%%%%%%%%%%%%%%%%%%%%%%%%%%%% %%% COMPETITION FOR FREE CD132

%kf_cd132_il9_il9r=0;%

%kr_cd132_il9_il9r=0.0138;% min ̂-1, TEMP IL-2 [Fallon, 2000]

%kfe_cd132_il9_il9r=0;%

%kre_cd132_il9_il9r=0;%

kf_cd132_il9_cd129=(1/(na*veff))*0;%
kr_cd132_il9_cd129=0.0138;% min ̂-1, TEMP IL-2 [Fallon, 2000]
kfe_cd132_il9_cd129=0;%
kre_cd132_il9_cd129=0;%

kf_cd132_il4_il4ra=(1/(na*veff))*0;%TEMP leave as zero [Bielekova, 2006]
kr_cd132_il4_il4ra=0.0138;% min ̂-1, TEMP IL-2 [Fallon, 2000]
kfe_cd132_il4_il4ra=0;%TEMP leave as zero [Bielekova, 2006]
kre_cd132_il4_il4ra=0;%TEMP leave as zero b/c [Bielekova, 2006]

kr_cd132_il21_il21r=(60*0.01);% min ̂-1, [Zhang, 2003]
kf_cd132_il21_il21r=(1/(na*veff)*kr_cd132_il21_il21r/200;% nMA-1 min ̂-1 [Zhang, 2003]
kfe_cd132_il21_il21r=0;% kre_cd132_il21_il21r=0;%
%%%%%%%%%%%%%%%%%%%%%%%%%%%%%%%%%%

kr_cd132_il7_cd127=0.0138;% min ̂-1, TEMP IL-2 [Fallon, 2000]
kf_cd132_il7_cd127=(1/(na*veff)*kr_cd132_il7_cd127/12;% nM̂-1 min ̂-1 TEMP—assume same as IL-2[Rickert, 2004]
kfe_cd132_il7_cd127=0;%
kre_cd132_il7_cd127=0.0138;%

kr_cd132_il2_cd25_cd122=0.0138;% min ̂-1, TEMP IL-2 [Fallon, 2000]
kf_cd132_il2_cd25_cd122=(1/(na*veff)*kr_cd132_il2_cd25_cd122/12;%nM̂-1 min ̂-1 [Rickert, 2004]
kfe_cd132_il2_cd25_cd122=0;%
kre_cd132_il2_cd25_cd122=0.0138;%

kr_cd132_il2_cd122=0.0138;% min ̂-1, TEMP IL-2 [Fallon, 2000]
kf_cd132_il2_cd122=(1/(na*veff)*kr_cd132_il2_cd122/1.5;% nMA-1 min ̂-1 [Rickert, 2004]
kfe_cd132_il2_cd122=0;%
kre_cd132_il2_cd122=0.0138;%%%%%CHANGE
kf_cd132_cd25_cd122=(1/(na*veff))*0;% [Rickert, 2004]

kr_cd132_cd25_cd122=0.0138;% min ̂-1, TEMP IL-2 [Fallon, 2000]
kfe_cd132_cd25_cd122=0;%
kre_cd132_cd25_cd122=0.0138;% min ̂-1, TEMP IL-2 [Fallon, 2000]

kr_cd132_il4_cd124=0.0138;% min ̂-1, TEMP IL-2 [Fallon, 2000]
kf_cd132_il4_cd124=(1/(na*veff)*kr_cd132_il4_cd124/4000;% 4 uM [Zhang, 2003]—no on/off rates given
kfe_cd132_il4_cd124=0;%TEMP leave as zero b/c “Neither population expressed IL-4RA and IL-15RA chains” [Bielekova, 2006]
kre_cd132_il4_cd124=0.0138;%TEMP leave as zero b/c “Neither population expressed IL-4RA and IL-15RA chains” [Bielekova, 2006]

kf_cd132_il15r_cd122=(1/(na*veff))*0;%TEMP leave as zero b/c “Neither population expressed IL-4RA and IL-15RA chains” [Bielekova, 2006]
kr_cd132_il15r_cd122=0.0138;% min ̂-1, TEMP IL-2 [Fallon, 2000]
kfe_cd132_il15r_cd122=0;%TEMP leave as zero b/c “Neither population expressed IL-4RA and IL-15RA chains” [Bielekova, 2006]
kre_cd132_il15r_cd122=0;%TEMP leave as zero b/c “Neither population expressed IL-4RA and IL-15RA chains” [Bielekova, 2006]

kf_cd132_il15_il15r_cd122=(1/(na*veff))*0;%TEMP leave as zero b/c “Neither population expressed IL-4RA and IL-15RA chains” [Bielekova, 2006]
kr_cd132_il15_il15r_cd122=0.0138;% min ̂-1, TEMP IL-2 [Fallon, 2000]
kfe_cd132_il15_il15r_cd122=0;%TEMP leave as zero b/c “Neither population expressed IL-4RA and IL-15RA chains” [Bielekova, 2006]
kre_cd132_il5il15r_cd122=0.0138;%TEMP leave as zero b/c “Neither population expressed IL-4RA and IL-15RA chains” [Bielekova, 2006]

kf_cd132_il15_cd122=(1/(na*veff))*0;%
kr_cd132_il15_cd122=0.0138;% min ̂-1, TEMP IL-2 [Fallon, 2000]
kfe_cd132_il15_cd122=0;%
kre_cd132_il15_cd122=0.0138;%

%FACTORS AFFECTING

### SYNTHESIS %%%%%%%%%%%%%%%%%%%%%%%%%%%%%%%%%%%%%%%% &&&&&&

ksyn_tslpr_il2_CD25=0;%

ksyn_tslpr_il2_CD 122=0; %

ksyn_tslpr_il4_{—}213=0;%

ksyn_tslpr_il4_{—}132=0;%

ksyn_tslpr_il7=0;%

ksyn_tslpr_il9=0;%

ksyn_tslpr_il13=0;%

ksyn_tslpr_il15=0;%

ksyn_tslpr_tslp=0.011;% min ̂-1, TEMP IL-2 [Fallon, 2000]

ksyn_tslpr_il21=0;%

%%%%%%%%%%%%%%%%%%%%%%%%%%%

ksyn_cd127_il2_CD25=-0.011;% direction: [Xue, 2002]

ksyn_cd127_il2_CD122=-0.011;% direction: [Xue, 2002]

ksyn_cd127_il4_{—}213=0;%

ksyn_cd127_il4_{—}132=0;%

ksyn_cd127_il7=0.011;% min ̂-1, TEMP IL-2 [Fallon, 2000]

ksyn_cd127_il9=0;%

ksyn_cd127_il3=0;%

ksyn_cd127_il5=0;%

ksyn_cd127_tslp=0;%

ksyn_cd127_il21=0;%

%%%%%%%%%%%%%%%%%%%%%%%%%%%

ksyn_cd124_il2_CD25=0;%

ksyn_cd124_il2_CD122=0;%

ksyn_cd124_il4_{—}213=0.011;% min ̂-1, TEMP IL-2 [Fallon, 2000]

ksyn_cd124_il4_{—}132=0.011;% min ̂-1, TEMP IL-2 [Fallon, 2000]

ksyn_cd124_il7=0;%

ksyn_cd124_il9=0;%

ksyn_cd124_il3=0;%

ksyn_cd124_il5=0;%

ksyn_cd124_tslp=0;%

ksyn_cd124_il21=0;%

%%%%%%%%%%%%%%%%%%%%%%%%%%

ksyn_cd213_il2_CD25=0;%

ksyn_cd213_il2_CD122=0;%

ksyn_cd213_il4_{—}213=0.011;% min ̂-1, TEMP IL-2 [Fallon, 2000]

ksyn_cd213_il4_{—}132=0;%

ksyn_cd213_il7=0;%

ksyn_cd213_il9=0;%

ksyn_cd213_il3=0.011;% min ̂-1, TEMP IL-2 [Fallon, 2000]

ksyn_cd213_il5=0;%

ksyn_cd213_tslp=0;%

ksyn_cd213_il21=0;%

%%%%%%%%%%%%%%%%%%%%%%%%%%%

ksyn_il21r_il2_CD25=0;%

ksyn_il21r_il2_CD122=0;%

ksyn_il21r_il4_{—}213=0;%

ksyn_il21r_il4_{—}132=0;%

ksyn_il21r_il7=0;%

ksyn_il21r_il9=0;%

ksyn_il21r_il13=0;%

ksyn_il21r_il15=0;%

ksyn_il21r_tslp=0;%

ksyn_il21r_il21=0.011;% min ̂-1, TEMP IL-2 [Fallon, 2000]

%%%%%%%%%%%%%%%%%%%%%%%%%%%

ksyn_cd129_il2_CD25=0;%

ksyn_cd129_il2_CD122=0;%

ksyn_cd129_il4_{—}213=0;%

ksyn_cd129_il4_{—}132=0;%

ksyn_cd129_il7=0;%

ksyn_cd129_il9=0.011;% min ̂-1, TEMP IL-2 [Fallon, 2000]

ksyn_cd129_il13=0;%

ksyn_cd129_il5=0;%

ksyn_cd129_tslp=0;%

ksyn_cd129_il21=0;%

%%%%%%%%%%%%%%%%%%%%%%%%%%%

ksyn_il15r_il2_CD25=0;%

ksyn_il15r_il2_CD122=0;%

ksyn_il15r_il4_{—}213=0;%

ksyn_il15r_il4_{—}132=0;%

ksyn_il15r_il7=0;%

ksyn_il15r_il9=0;%

ksyn_il15r_il13=0;%

ksyn_il15r_il15=0.011;% min ̂-1, TEMP IL-2 [Fallon, 2000]

ksyn_il15r_tslp=0;%

ksyn_il15r_il21=0;%

%%%%%%%%%%%%%%%%%%%%%%%%%%%

ksyn_cd25_il2_CD25=0.011;% min ̂-1, TEMP IL-2 [Fallon, 2000]%%%%%%%%%%%%%%%%%%%%%%%%%%%%%%%%%%

ksyn_cd25_il2_CD122=0.011;% min ̂-1, TEMP IL-2 [Fallon, 2000]

ksyn_cd25_il4_{—}213=0;%

ksyn_cd25_il4_{—}132=0;%

ksyn_cd25_il7=0;%

ksyn_cd25_il9=0;%

ksyn_cd25_il13=0;%

ksyn_cd25_il15=0;%

ksyn_cd25_tslp=0;%

ksyn_cd25_il21=0.011;% [Arai, 2010] direction, number Temp from IL-2%

%%%%%%%%%%%%%%%%%%%%%%%%%%

ksyn_il13ra2_il2_CD25=0;%

ksyn_il13ra2_il2_CD122=0;%

ksyn_il13ra2il4_{—}213=0;%

ksyn_il13ra2il4_{—}132=0;%

ksyn_il13ra2_il7=0;%

ksyn_il13ra2_il9=0;%

ksyn_il13ra2_il13=0.011;% min ̂-1, TEMP IL-2 [Fallon, 2000]

ksyn_il13ra2_{—}1115=0;%

ksyn_il13ra2_tslp=0;%

ksyn_il13ra2_il21=0;%

%%%%%%%%%%%%%%%%%%%%%%%%%%%

ksyn_cd122_il2_CD25=0.011;% min ̂-1, TEMP IL-2 [Fallon, 2000]

ksyn_cd122_il2_CD122=0.011;% min ̂-1, TEMP IL-2 [Fallon, 2000]

ksyn_cd122_il4_{—}213=0;%

ksyn_cd122_il4_{—}132=0;%

ksyn_cd122_{—}117=0;%

ksyn_cd122_il9=0;%

ksyn_cd122_{—}1113=0;%

ksyn_cd122_{—}1115=0;%

ksyn_cd122_tslp=0;%

ksyn_cd122_il21=0;%

%%%%%%%%%%%%%%%%%%%%%%%%%%%

ksyn_cd132_il2_CD25=0.011;% min ̂-1, TEMP IL-2 [Fallon, 2000]

ksyn_cd132_il2_CD122=0.011;% min ̂-1, TEMP IL-2 [Fallon, 2000]

ksyn_cd132_il4_{—}213=0;%

ksyn_cd132_il4_{—}132=0.011;% min ̂-1, TEMP IL-2 [Fallon, 2000]

ksyn_cd132_{—}117=0.011;% min ̂-1, TEMP IL-2 [Fallon, 2000]

ksyn_cd132_il9=0.011;% min ̂-1, TEMP IL-2 [Fallon, 2000]

ksyn_cd132_il13=0;%

ksyn_cd132_{—}1115=0.011;% min ̂-1, TEMP IL-2 [Fallon, 2000]

ksyn_cd132_tslp=0;%

ksyn_cd132_il21=0.011;% min ̂-1, TEMP IL-2 [Fallon, 2000]

%%%%%%%%%%%%%%%%%%%%%%%%%%%

kt_celltypea_cd127_tslpr=0.007;% min ̂-1 TEMP IL-2 [Fallon, 2000]

kt_celltypea_cd124=0.007;% min ̂-1 TEMP IL-2 [Fallon, 2000]

kt_celltypea_tslpr=0.007;% min ̂-1 TEMP IL-2 [Fallon, 2000]

kt_celltypea_cd127=0.007;% min ̂-1 TEMP IL-2 [Fallon, 2000]

kt_celltypea_cd124_cd132=0.007;% min ̂-1 TEMP IL-2 [Fallon, 2000]

kt_celltypea_cd213=0.007;% min ̂-1 TEMP IL-2 [Fallon, 2000]

kt_celltypea_cd124_cd213=0.007;% min ̂-1 TEMP IL-2 [Fallon, 2000] kt_celltypea_il21r=0.007;% min ̂-1 TEMP IL-2 [Fallon, 2000]

kt_celltypea_cd129=0.007;% min ̂-1 TEMP IL-2 [Fallon, 2000]

kt_celltypea_il21r_cd132=0.007;% min ̂-1 TEMP IL-2 [Fallon, 2000]

kt_celltypea_cd129_cd132=0.007;% min ̂-1 TEMP IL-2 [Fallon, 2000]

kt_celltypea_il15r_cd122_cd132=0.007;% min ̂-1 TEMP IL-2 [Fallon, 2000]

kt_celltypea_il15r=0.007;% min ̂-1 TEMP IL-2 [Fallon, 2000]

kt_celltypea_cd25=0.007;% min ̂-1 TEMP IL-2 [Fallon, 2000]

kt_celltypea_cd25_cd122_cd132=0.007;% min ̂-1 TEMP IL-2 [Fallon, 2000]

kt_celltypea_cd25_cd122=0.007;% min ̂-1 TEMP IL-2 [Fallon, 2000]

kt_celltypea_il15r_cd122=0.007;% min ̂-1 TEMP IL-2 [Fallon, 2000]

kt_celltypea_il3ra2=0.007;% min ̂-1 TEMP IL-2 [Fallon, 2000]

kt_celltypea_cd122_cd132=0.007;% min ̂-1 TEMP IL-2 [Fallon, 2000]

kt_celltypea_cd122=0.007;% min ̂-1 TEMP IL-2 [Fallon, 2000]

kt_celltypea_cd127_cd132=0.007;% min ̂-1 TEMP IL-2 [Fallon, 2000]

kt_celltypea_cd132=0.007;% min ̂-1 TEMP IL-2 [Fallon, 2000]

ke_celltypea_il9_cd129_cd132=0.04;% min ̂-1 TEMP IL-2 [Fallon, 2000]

ke_celltypea_il21_il21r_cd132=0.04;% min ̂-1 TEMP IL-2 [Fallon, 2000]

ke_celltypea_il13_cd124_cd213=0.04;% min ̂-1 TEMP IL-2 [Fallon, 2000]

ke_celltypea_il4_cd124_cd213=0.04;% min ̂-1 TEMP IL-2 [Fallon, 2000]

ke_celltypea_il4_cd124_cd132=0.04;% min ̂-1 TEMP IL-2 [Fallon, 2000]

ke_celltypea_tslp_cd127_tslpr=0.04;% min ̂-1 TEMP IL-2 [Fallon, 2000]

ke_celltypea_il7_cd127_cd132=0.04;% min ̂-1 TEMP IL-2 [Fallon, 2000]

ke_celltypea_il2_cd122_cd132=0.04;% min ̂-1 TEMP IL-2 [Fallon, 2000]

ke_celltypea_il15_il15r_cd122_cd132=0.04;% min ̂-1 TEMP IL-2 [Fallon, 2000] ke_celltypea_il2_cd25_cd122_cd132=0.04;% min ̂-1 TEMP IL-2 [Fallon, 2000]

ke_celltypea_il15_cd122_cd132=0.04;% min ̂-1 TEMP IL-2 [Fallon, 2000]

ke_celltypea_il15_il15r_cd122=0.04;% min ̂-1 TEMP IL-2 [Fallon, 2000]

ke_celltypea_il15_cd122=0.04;% min ̂-1 TEMP IL-2 [Fallon, 2000]

ke_celltypea_il2_cd122=0.04;% min ̂-1 TEMP IL-2 [Fallon, 2000]

ke_celltypea_il9_cd129=0.04;% min ̂-1 TEMP IL-2 [Fallon, 2000]

ke_celltypea_il21_il21r=0.04;% min ̂-1 TEMP IL-2 [Fallon, 2000]

ke_celltypea_il4_cd124=0.04;% min ̂-1 TEMP IL-2 [Fallon, 2000]

ke_celltypea_il4_cd213=0.04;% min ̂-1 TEMP IL-2 [Fallon, 2000]

ke_celltypea_il13_cd213=0.04;% min ̂-1 TEMP IL-2 [Fallon, 2000]

ke_celltypea_il13_cd124=0.04;% min ̂-1 TEMP IL-2 [Fallon, 2000]

ke_celltypea_il7_cd127=0.04;% min ̂-1 TEMP IL-2 [Fallon, 2000]

ke_celltypea_tslp_tslpr=0.04;% min ̂-1 TEMP IL-2 [Fallon, 2000]

ke_celltypea_il2_cd25=0.04;% min ̂-1 TEMP IL-2 [Fallon, 2000]

%%%%%%%%%%%%%%%%%%%%%%%%%%%%%%%%%%%%%%%%%%% %%%%%%%%%%%%%%%%%%%%%%%%%%

ke_celltypea_il2_cd25_cd122=0.0;% min ̂-1 TEMP IL-2 [Fallon, 2000]

%%%%%%%%%%%%%%%%%%%%%%%%%%%%%%%%%%%%%%%%%%% %%%%%%%%%%%%%%%%%%%%%%%%%%%%

ke_celltypea_il13_il3ra2=0.04;% min ̂-1 TEMP IL-2 [Fallon, 2000]

ke_celltypea_il2_cd132=0.04;% min ̂-1 TEMP IL-2 [Fallon, 2000]

ke_celltypea_il15_il15r=0.04;% min ̂-1 TEMP IL-2 [Fallon, 2000]

ke_celltypea_il15_cd132=0.04;% min ̂-1 TEMP IL-2 [Fallon, 2000]

kh_celltypea_cd132=0.035;% minA-1 TEMP Fallon il-2%%%%%%%%%%%%%%%%%%%%%%%%%%%%%%

kh_celltypea_il2_cd132=0.035;% minA-1 TEMP Fallon il-2%

%%%%%%%%%%%%%%%%%% KEY!!!

kh_celltypea_il2_cd25_cd122_cd132=0.035;% minA-1 TEMP Fallon il-2

kh_celltypea_il15_il15r_cd122_cd132=0.035;% minA-1 TEMP Fallon il-2

kh_celltypea_cd25_cd122_cd132=0.035;% minA-1 TEMP Fallon il-2

kh_il15_il15r_cd122_cd132=0.035;% minA-1 TEMP Fallon il-2

kh_il7_cd127_cd132=0.035;% min ̂-1 TEMP Fallon il-2

kh_tslp_cd127_tslpr=0.035;% min ̂-1 TEMP Fallon il-2

kh_il4_cd124_cd132=0.035;% min ̂-1 TEMP Fallon il-2

kh_il4_cd124_cd213=0.035;% min ̂-1 TEMP Fallon il-2

kh_il13_cd124_cd213=0.035;% min ̂-1 TEMP Fallon il-2

kh_celltypea_cd122_cd132=0.035;% min ̂-1 TEMP Fallon il-2

kh_celltypea_cd122=0.035;% min ̂-1 TEMP Fallon il-2%%%%%%%%%%%%%%%%%%%%%%%%%%%

kh_celltypea_cd127_cd132=0.035;% min ̂-1 TEMP Fallon il-2

kh_celltypea_cd127=0.035;% min ̂-1 TEMP Fallon il-2

kh_celltypea_tslpr=0.035;% min ̂-1 TEMP Fallon il-2

kh_celltypea_cd127_tslpr=0.035;% min ̂-1 TEMP Fallon il-2

kh_celltypea_cd124=0.035;% min ̂-1 TEMP Fallon il-2

kh_celltypea_cd124_cd132=0.035;% min ̂-1 TEMP Fallon il-2

kh_celltypea_cd213=0.035;% min ̂-1 TEMP Fallon il-2

kh_celltypea_cd124_cd213=0.035;% min ̂-1 TEMP Fallon il-2

kh_celltypea_il21r=0.035;% min ̂-1 TEMP Fallon il-2

kh_celltypea_cd129=0.035;% min ̂-1 TEMP Fallon il-2

kh_celltypea_il21r_cd132=0.035;% min ̂-1 TEMP Fallon il-2

kh_celltypea_cd129_cd132=0.035;% min ̂-1 TEMP Fallon il-2

kh_celltypea_il9_cd129_cd132=0.035;% min ̂-1 TEMP Fallon il-2

kh_celltypea_il21_il21r_cd132=0.035;% min ̂-1 TEMP Fallon il-2

kh_celltypea_il13_cd124_cd213=0.035;% min ̂-1 TEMP Fallon il-2

kh_celltypea_il4_cd124_cd213=0.035;% min ̂-1 TEMP Fallon il-2

kh_celltypea_il4_cd124_cd132=0.035;% min ̂-1 TEMP Fallon il-2

kh_celltypea_il7_cd127_cd132=0.035;% min ̂-1 TEMP Fallon il-2

kh_celltypea_tslp_cd127_tslpr=0.035;% min ̂-1 TEMP Fallon il-2

kh_celltypea_il2_cd122_cd132=0.035;% min ̂-1 TEMP Fallon il-2

kh_celltypea_il15r_cd122_cd132=0.035;% min ̂-1 TEMP Fallon il-2

kh_celltypea_il15r=0.035;% min ̂-1 TEMP Fallon il-2

kh_celltypea_cd25=0.035;% min ̂-1 TEMP Fallon il-2%%%%%%%%%%%%%%%%%%%%%%%%%%%%%

kh_il21_il21r_cd132=0.035;% min ̂-1 TEMP Fallon il-2

kh_il9_cd129_cd132=0.035;% min ̂-1 TEMP Fallon il-2

kh_il2_cd132=0.035;% min ̂-1 TEMP Fallon il-2

kh_il2_cd122_cd132=0.035;% min ̂-1 TEMP Fallon il-2

kh_il2_cd25_cd122_cd132=0.035;% minA-1 TEMP Fallon il-2

kh_il2_cd25=0.035;% min ̂-1 TEMP Fallon il-2

kh_il15_il15r=0.035;% min ̂-1 TEMP Fallon il-2

kh_il7_cd127=0.035;% min ̂-1 TEMP Fallon il-2

kh_tslp_tslpr=0.035;% min ̂-1 TEMP Fallon il-2

kh_il4_cd124=0.035;% min ̂-1 TEMP Fallon il-2

kh_il4_cd213=0.035;% min ̂-1 TEMP Fallon il-2

kh_il13_cd213=0.035;% min ̂-1 TEMP Fallon il-2

kh_il13_cd124=0.035;% min ̂-1 TEMP Fallon il-2

kh_il21_il21r=0.035;% min ̂-1 TEMP Fallon il-2

kh_il9_cd129=0.035;% min ̂-1 TEMP Fallon il-2

kh_il2_cd122=0.035;% min ̂-1 TEMP Fallon il-2

kh_il2_cd25_cd122=0.035;% min ̂-1 TEMP Fallon il-2

kh_celltypea_il9_cd129=0.035;% minA-1 TEMP Fallon il-2

kh_celltypea_il21_il21r=0.035;% minA-1 TEMP Fallon il-2

kh_celltypea_il4_cd124=0.035;% minA-1 TEMP Fallon il-2

kh_celltypea_il4_cd213=0.035;% minA-1 TEMP Fallon il-2

kh_celltypea_il13_cd213=0.035;% minA-1 TEMP Fallon il-2

kh_celltypea_il13_cd124=0.035;% minA-1 TEMP Fallon il-2

kh_celltypea_il7_cd127=0.035;% min ̂-1 TEMP Fallon il-2

kh_celltypea_tslp_tslpr=0.035;% min ̂-1 TEMP Fallon il-2

kh_celltypea_cd25_cd122=0.035;% minA-1 TEMP Fallon il-2

kh_celltypea_il2_cd25=0.035;% minA-1 TEMP Fallon il-2

kh_celltypea_il2_cd25_cd122=0.035;% minA-1 TEMP Fallon il-2

kh_celltypea_il2_cd122=0.035;% min ̂-1 TEMP Fallon il-2

kh_celltypea_il15r_cd122=0.035;% minA-1 TEMP Fallon il-2

kh_celltypea_il15_il15r_cd122=0.035;% minA-1 TEMP Fallon il-2

kh_celltypea_il15_cd122_cd132=0.035;% minA-1 TEMP Fallon il-2

kh_celltypea_il15_il15r=0.035;% min ̂-1 TEMP Fallon il-2

kh_celltypea_il15_cd122=0.035;% min ̂-1 TEMP Fallon il-2

kh_celltypea_il13_il3ra2=0.035;% min ̂-1 TEMP Fallon il-2

kh_celltypea_il3ra2=0.035;% min ̂-1 TEMP Fallon il-2

kh_celltypea_il15_cd132=0.035;% minA-1 TEMP Fallon il-2

kx_celltypea_il15=0.15;% min ̂-1 TEMP Fallon il-2

kx_celltypea_il7=0.15;% min ̂-1 TEMP Fallon il-2

kx_celltypea_tslp=0.15;% min ̂-1 TEMP Fallon il-2;%

kx_celltypea_il4=0.15;% min ̂-1 TEMP Fallon il-2

kx_celltypea_il13=0.15;% min ̂-1 TEMP Fallon il-2

kx_celltypea_il21=0.15;% min ̂-1 TEMP Fallon il-2

kx_celltypea_il9=0.15;% min ̂-1 TEMP Fallon il-2

kx_celltypea_il2=0.15;% min ̂-1 Fallon il-2

kx_celltypea_cd25=0.15;% min ̂-1 Fallon il-2

In one embodiment, the method for assessing the provided values comprises the following equations:

$$\frac{d {R}_{S}^{CellTypeA : CD 132}}{d t} = - {k}_{f}^{IL 2 : CD 132} \cdot {L}^{IL 2} [ t ] \cdot {R}_{S}^{CellTypeA : CD 132} [ t ] + {k}_{r}^{IL 2 : CD 132} \cdot {C}_{S}^{CellTypeA : IL 2 : CD 132} [ t ] - {k}_{f}^{CD 122 : CD 132} \cdot {R}_{S}^{CellTypeA : CD 122} [ t ] \cdot {R}_{S}^{CellTypeA : CD 132} [ t ] + {k}_{r}^{CD 122 : CD 132} \cdot {R}_{S}^{CellTypeA : CD 122 : CD 132} [ t ] - {k}_{f}^{CD 127 : CD 132} \cdot {R}_{S}^{CellTypeA : CD 127} [ t ] \cdot {R}_{S}^{CellTypeA : CD 132} [ t ] + {k}_{r}^{CD 127 : CD 132} \cdot {R}_{S}^{CellTypeA : CD 127 : CD 132} [ t ] - {k}_{f }^{IL 4 RA : CD 132} \cdot {R}_{S}^{CellTypeA : IL 4 RA} [ t ] \cdot {R}_{S}^{CellTypeA : CD 132} [ t ] + {k}_{r}^{IL 4 RA : CD 132} \cdot {R}_{S}^{CellTypeA : IL 4 RA : CD 132} [ t ] - {k}_{f}^{IL 21 R : CD 132} \cdot {R}_{S}^{CellTypeA : IL 21 R} [ t ] \cdot {R}_{S}^{CellTypeA : CD 132} [ t ] + {k}_{r}^{IL 21 R : CD 132} \cdot {R}_{S}^{CellTypeA : IL 21 R : CD 132} [ t ] - {k}_{f}^{IL 9 R : CD 132} \cdot {R}_{S}^{CellTypeA : IL 9 R} [ t ] \cdot {R}_{S}^{CellTypeA : CD 132} [ t ] + {k}_{r}^{IL 9 R : CD 132} \cdot {R}_{S}^{CellTypeA : IL 9 R : CD 132} [ t ] - {k}_{t}^{CellTypeA : CD 132} \cdot {R}_{S}^{CellTypeA : CD 132} [ t ] + {V}_{S}^{ CellTypeA : CD 132} + {k}_{syn}^{CellTypeA : IL 2 : CD 132} \cdot {C}_{S}^{CellTypeA : IL 2 : CD 132} [ t ] + ( \begin{matrix}{k}_{syn}^{CD 132 : IL 2 : CD 25} \cdot {C}_{S}^{CellTypeA : IL 2 : CD 25 : CD 122 : CD 132} + \\ {k}_{syn}^{CD 132 : IL 2 : CD 122} \cdot {C}_{S}^{CellTypeA : IL 2 : CD 122 : CD 132} + \\ {k}_{syn}^{CD 132 : IL 4 : CD 213} \cdot {C}_{S}^{CellTypeA : IL 4 : CD 124 : CD 213} + \\ {k}_{syn}^{CD 132 : IL 4 : CD 132} \cdot {C}_{S}^{CellTypeA : IL 4 : CD 124 : CD 132} + \\ {k}_{syn}^{CD 132 : IL 7} \cdot {C}_{S}^{CellTypeA : IL 7 : CD 127 : CD 132} + \\ {k}_{syn}^{CD 132 : IL 9} \cdot {C}_{S}^{CellTypeA : IL 9 : CD 129 : CD 132} + \\ {k}_{syn}^{CD 132 : IL 13} \cdot {C}_{S}^{CellTypeA : IL 13 : CD 124 : CD 213} + \\ {k}_{syn}^{CD 132 : IL 15} \cdot {C}_{S}^{CellTypeA : IL 15 : IL 15 R : CD 122 : CD 132} + \\ {k}_{syn}^{CD 132 : TSLP} \cdot {C}_{S}^{CellTypeA : TSLP : CD 127 : TSLPR} + \\ {k}_{syn}^{CD 132 : IL 21} \cdot {C}_{S}^{CellTypeA : IL 21 : IL 21 R : CD 132}\end{matrix} ) - {k}_{f}^{CD 132 : IL 9 : IL 9 R} \cdot {C}_{S}^{CellTypeA : IL 9 : IL 9 R} [ t ] \cdot {R}_{S}^{CellTypeA : CD 132} [ t ] + {k}_{r}^{CD 132 : IL 9 : IL 9 R} \cdot {C}_{S}^{CellTypeA : IL 9 : IL 9 R : CD 132} [ t ] - {k}_{f}^{CD 132 : IL 4 : IL 4 RA} \cdot {C}_{S}^{CellTypeA : IL 4 : IL 4 RA} [ t ] \cdot {R}_{S}^{CellTypeA : CD 132} [ t ] + {K}_{r}^{CD 132 : IL 4 : IL 4 RA} \cdot {C}_{S}^{CellTypeA : IL 4 : IL 4 RA : CD 132} [ t ] - {k}_{f}^{CD 132 : IL 21 : IL 21 R} \cdot {C}_{S}^{CellTypeA : IL 21 : IL 21 R} [ t ] \cdot {R}_{S}^{CellTypeA : CD 132} [ t ] + {k}_{r}^{CD 132 : IL 2 : IL 21 R} \cdot {C}_{S}^{CellTypeA : IL 21 : IL 21 R : CD 132} [ t ] - {k}_{f}^{CD 132 : IL 7 : CD 127} \cdot {C}_{S}^{CellTypeA : IL 7 : CD 127} [ t ] \cdot {R}_{S}^{CellTypeA : CD 132} [ t ] + {k}_{r}^{CD 132 : IL 7 : CD 127} \cdot {C}_{S}^{CellTypeA : IL 7 : CD 127 : CD 132} [ t ] - {k}_{f}^{CD 132 : IL 2 : CD 122} \cdot {C}_{S}^{CellTypeA : IL 2 : CD 122} [ t ] \cdot {R}_{S}^{CellTypeA : CD 132} [ t ] + {k}_{r}^{CD 132 : IL 2 : CD 122} \cdot {C}_{S}^{CellTypeA : IL 2 : CD 122 : CD 132} [ t ] - {k}_{f}^{CD 132 : IL 2 : CD 25 : CD 122} \cdot {C}_{S}^{CellTypeA : IL 2 : CD 25 : CD 122} [ t ] \cdot {R}_{S}^{CellTypeA : CD 132} [ t ] + {k}_{r}^{CD 132 : IL 2 : CD 25 : CD 122} \cdot {C}_{S}^{CellTypeA : IL 2 : CD 25 : CD 122 : CD 132} [ t ] - {k}_{f}^{CD 132 : IL 15 : IL 15 R : CD 122} \cdot {R}_{S}^{CellTypeA : CD 132} [ t ] \cdot {C}_{S}^{CellTypeA : IL 15 : IL 15 R : CD 122} [ t ] + {k}_{r}^{CD 132 : IL 15 : IL 15 R : CD 122} \cdot {C}_{S}^{CellTypeA : IL 15 : IL 15 R : CD 122 : CD 132} [ t ] - {k}_{f}^{CD 132 : IL 15 R : CD 122} \cdot {R}_{S}^{CellTypeA : CD 132} [ t ] \cdot {R}_{S}^{CellTypeA : IL 15 R : CD 122} [ t ] + {k}_{r}^{CD 132 : IL 15 R : CD 122} \cdot {R}_{S}^{CellTypeA : IL 15 R : CD 122 : CD 132} [ t ] - {k}_{f}^{CD 132 : IL 15 : CD 122} \cdot {R}_{S}^{CellTypeA : CD 132} [ t ] \cdot {C}_{S}^{CellTypeA : IL 15 : CD 122} [ t ] + {k}_{r}^{CD 132 : IL 15 : CD 122} \cdot {C}_{S}^{CellTypeA : IL 15 : CD 122 : CD 132} [ t ] - {k}_{f}^{IL 15 : CD 132} \cdot {L}^{IL 15} [ t ] \cdot {R}_{S}^{CellTypeA : CD 132} [ t ] + {k}_{r}^{IL 15 : CD 132} \cdot {C}_{S}^{CellTypeA : IL 15 : CD 132} [ t ] \qquad 1$$

$$\frac{d {R}_{i}^{CellTypeA : CD 132}}{d t} = - {k}_{fe}^{IL 2 : CD 132} \cdot {L}_{i}^{CellTypeA : IL 2} [ t ] \cdot {R}_{i}^{CellTypeA : CD 132} [ t ] + {k}_{re}^{IL 2 : CD 132} \cdot {C}_{i}^{CellTypeA : IL 2 : CD 132} [ t ] - {k}_{fe}^{CD 122 : CD 132} \cdot {R}_{i}^{CellTypeA : CD 122} [ t ] \cdot {R}_{i}^{CellTypeA : CD 132} [ t ] + {k}_{re}^{CD 122 : CD 132} \cdot {R}_{i}^{CellTypeA : CD 122 : CD 132} [ t ] - {k}_{fe}^{CD 127 : CD 132} \cdot {R}_{i}^{CellTypeA : CD 127} [ t ] \cdot {R}_{i}^{CellTypeA : CD 132} [ t ] + {k}_{re}^{CD 127 : CD 132} \cdot {R}_{i}^{CellTypeA : CD 127 : CD 132} [ t ] - {k}_{fe}^{IL 4 RA : CD 132} \cdot {R}_{i}^{CellTypeA : IL 4 RA} [ t ] \cdot {R}_{i }^{CellTypeA : CD 132} [ t ] + {k}_{re}^{IL 4 RA : CD 132} \cdot {R}_{i}^{CellTypeA : IL 4 RA : CD 132} [ t ] - {k}_{fe}^{IL 21 R : CD 132} \cdot {R}_{i}^{CellTypeA : IL 21 R} [ t ] \cdot {R}_{i}^{CellTypeA : CD 132} [ t ] + {k}_{re}^{IL 21 R : CD 132} \cdot {R}_{i}^{CellTypeA : IL 21 R : CD 132} [ t ] - {k}_{fe}^{IL 9 R : CD 132} \cdot {R}_{i}^{CellTypeA : IL 9 R} [ t ] \cdot {R}_{i}^{CellTypeA : CD 132} [ t ] + {k}_{re}^{IL 9 R : CD 132} \cdot {R}_{i}^{CellTypeA : IL 9 R : CD 132} [ t ] + {k}_{t}^{CellTypeA : CD 132} \cdot {R}_{S}^{CellTypeA : CD 132} [ t ] - {k}_{h}^{CellTypeA : CD 132} \cdot {R}_{i}^{CellTypeA : CD 132} [ t ] - {k}_{fe}^{CD 132 : IL 9 : IL 9 R} \cdot {C}_{i}^{CellTypeA : IL 9 : IL 9 R} [ t ] \cdot {R}_{i}^{CellTypeA : CD 132} [ t ] + {k}_{re}^{CD 132 : IL 9 : IL 9 R} \cdot {C}_{i}^{CellTypeA : IL 9 : IL 9 R : CD 132} [ t ] - {k}_{fe}^{CD 132 : IL 4 : IL 4 RA} \cdot {C}_{i}^{CellTypeA : IL 4 : IL 4 R} [ t ] \cdot {R}_{i}^{CellTypeA : CD 132} [ t ] + {k}_{re}^{CD 132 : IL 4 : IL 4 R} \cdot {C}_{i}^{CellTypeA : IL 4 : IL 4 RA : CD 132} [ t ] - {k}_{fe}^{CD 132 : IL 21 : IL 21 R} \cdot {C}_{i}^{CellTypeA : IL 21 : IL 2 R} [ t ] \cdot {R}_{i}^{CellTypeA : CD 132} [ t ] + {k}_{re}^{CD 132 : IL 21 : IL 21 R} \cdot {C}_{i}^{CellTypeA : IL 21 : IL 21 R : CD 132} [ t ] - {k}_{fe}^{CD 132 : IL 7 : CD 127} \cdot {C}_{i}^{CellTypeA : IL 7 : CD 127} [ t ] \cdot {R}_{i}^{CellTypeA : CD 132} [ t ] + {k}_{re}^{CD 132 : IL 7 : CD 127} \cdot {C}_{i}^{CellTypeA : IL 7 : CD 127 : CD 132} [ t ] - {k}_{fe}^{CD 132 : IL 2 : CD 122} \cdot {C}_{i}^{CellTypeA : IL 2 : CD 122} [ t ] \cdot {R}_{i}^{CellTypeA : CD 132} [ t ] + {k}_{re}^{CD 132 : IL 2 : CD 122} \cdot {C}_{i}^{CellTypeA : IL 2 : CD 122 : CD 132} [ t ] - {k}_{fe}^{CD 132 : IL 2 : CD 25 : CD 122} \cdot {C}_{i}^{CellTypeA : IL 2 : CD 25 : CD 122} [ t ] \cdot {R}_{i}^{CellTypeA : CD 132} [ t ] + {k}_{re}^{CD 132 : IL 2 : CD 25 : CD 122} \cdot {C}_{S}^{CellTypeA : IL 2 : CD 25 : CD 122 : CD 132} [ t ] - {k}_{fe}^{CD 132 : IL 15 : CD 122} \cdot {R}_{i}^{CellTypeA : CD 132} [ t ] \cdot {C}_{i}^{CellTypeA : IL 15 : CD 122} [ t ] + {k}_{re}^{CD 132 : IL 15 : CD 122} \cdot {C}_{i}^{CellTypeA : IL 15 : CD 122 : CD 132} [ t ] - {k}_{fe}^{IL 15 : CD 132} \cdot {L}_{i}^{CellTypeA : IL 15} [ t ] \cdot {R}_{i}^{CellTypeA : CD 132} [ t ] + {k}_{re}^{IL 15 : CD 132} \cdot {C}_{i}^{CellTypeA : IL 15 : CD 132} [ t ] \qquad 2$$

$$\frac{d {C}_{S}^{CellTypeA : IL 2 : CD 132}}{d t} = {k}_{f}^{IL 2 : CD 132} \cdot {L}^{IL 2} [ t ] \cdot {R}_{S}^{CellTypeA : CD 132} [ t ] - {k}_{r}^{IL 2 : CD 132} \cdot {C}_{S}^{CellTtypeA : IL 2 : CD 132} [ t ] - {k}_{e}^{CellTypeA : IL 2 : CD 132} \cdot {C}_{S}^{CellTypeA : IL 2 : CD 132} [ t ] \qquad 3$$

$$\frac{d {C}_{i}^{CellTypeA : IL 2 : CD 132}}{d t} = {k}_{fe}^{IL 2 : CD 132} \cdot {L}_{i}^{CellTypeA : IL 2} [ t ] \cdot {R}_{i}^{CellTypeA : CD 132} [ t ] - {k}_{re}^{IL 2 : CD 132} \cdot {C}_{i}^{CellTypeA : IL 2 : CD 132} [ t ] + {k}_{e}^{CellTypeA : IL 2 : CD 132} \cdot {C}_{S}^{CellTypeA : IL 2 : CD 132} [ t ] - {k}_{h}^{CellTypeA : IL 2 : CD 132} \cdot {C}_{i}^{CellTypeA : IL 2 : CD 132} [ t ] \qquad 4$$

$$\frac{d {R}_{S}^{CellTypeA : CD 122 : CD 132}}{d t} = - {k}_{f}^{IL 2 : CD 122 : CD 132} \cdot {L}^{IL 2} [ t ] \cdot {R}_{S}^{CellTypeA : CD 122 : CD 132} [ t ] + {k}_{r}^{IL 2 : CD 122 : CD 132} \cdot {C}_{S}^{CellTypeA : IL 2 : CD 122 : CD 132} [ t ] - {k}_{f}^{CD 25 : CD 122 : CD 132} \cdot {R}_{S}^{CellTypeA : CD 25} [ t ] \cdot {R}_{S}^{CellTypeA : CD 122 : CD 132} [ t ] + {k}_{r}^{CD 25 : CD 122 : CD 132} \cdot {R}_{S}^{CellTypeA : CD 25 : CD 122 : CD 132} [ t ] - {k}_{f}^{IL 15 RA : CD 122 : CD 132} \cdot {R}_{S}^{CellTypeA : IL 15 RA} [ t ] \cdot {R}_{S}^{CellTypeA : CD 122 : CD 132} [ t ] + {k}_{r}^{IL 15 RA : CD 122 : CD 132} \cdot {R}_{S}^{CellTypeA : IL 15 RA : CD 122 : CD 132} [ t ] + {k}_{f}^{CD 122 : CD 132} \cdot {R}_{S}^{CellTypeA : CD 122} [ t ] \cdot {R}_{S}^{CellTypeA : CD 132} [ t ] - {k}_{r}^{CD 122 : CD 132} \cdot {R}_{S}^{CellTypeA : CD 122 : CD 132} [ t ] - {k}_{t }^{CellTypeA : CD 122 : CD 132} \cdot {R}_{S}^{CellTypeA : CD 122 : CD 132} [ t ] - {k}_{f}^{CD 122 : CD 132 : IL 15 : IL 15 RA} \cdot {C}_{S}^{CellTypeA : IL 15 : IL 15 RA} [ t ] \cdot {R}_{S}^{CellTypeA : CD 122 : CD 132} [ t ] + {k}_{r}^{CD 122 : CD 132 : Il 15 : 15 RA} \cdot {C}_{S }^{CellTypeA : IL 15 : IL 15 RA : CD 122 : CD 132} [ t ] \qquad 5$$

$$\begin{matrix}\frac{d {R}_{i}^{CellTypeA : CD 122 : CD 132}}{d t} = - {k}_{fe}^{IL 2 : CD 122 : CD 132} \cdot {L}_{i}^{CellTypeA : IL 2} [ t ] \cdot {R}_{i}^{CellTypeA : CD 122 : CD 132} [ t ] + {k}_{re }^{IL 2 : CD 122 : CD 132} \cdot {C}_{i}^{CellTypeA : IL 2 : CD 122 : CD 132} [ t ] - {k}_{fe}^{CD 25 : CD 122 : CD 132} \cdot {R}_{i}^{CellTypeA : CD 25} [ t ] \cdot {R}_{i}^{CellTypeA : CD 122 : CD 132} [ t ] + {k}_{re }^{CD 25 : CD 122 : CD 132} \cdot {R}_{i}^{CellTypeA : CD 25 : CD 122 : CD 132} [ t ] - {k}_{fe }^{IL 15 RA : CD 122 : CD 132} \cdot {R}_{i}^{CellTypeA : IL 15 RA} [ t ] \cdot {R}_{i}^{CellTypeA : CD 122 : CD 132} [ t ] + {k}_{re}^{IL 15 RA : CD 122 : CD 132} \cdot {R}_{i}^{CellTypeA : IL 15 RA : CD 122 : CD 132} [ t ] + {k}_{fe }^{CD 122 : CD 132} \cdot {R}_{i}^{CellTypeA : CD 122} [ t ] \cdot {R}_{i}^{CellTypeA : CD 132} [ t ] - {k}_{re }^{CD 122 : CD 132} \cdot {R}_{i}^{CellTypeA : CD 122 : CD 132} [ t ] + {k}_{t}^{CellTypeA : CD 122 : CD 132} \cdot {R}_{S }^{CellTypeA : CD 122 : CD 132} [ t ] - {k}_{h}^{CellTypeA : CD 122 : CD 132} \cdot {R}_{i}^{CellTypeA : CD 122 : CD 132} [ t ] - {k}_{fe}^{CD 122 : CD 132 : IL 15 : IL 15 RA} \cdot {C}_{i}^{CellTypeA : IL 15 : IL 15 RA} [ t ] \cdot {R}_{i}^{CelltypeA : CD 122 : CD 132} [ t ] + {k}_{re}^{CD 122 : CD 132 : Il 14 : IL 15 RA} \cdot {C}_{i}^{CellTypeA : IL 15 : IL 15 RA : CD 122 : CD 132} [ t ] & 6\end{matrix}$$

$$\begin{matrix}\frac{d {R}_{s}^{CellTypeA : CD 122}}{d t} = - {k}_{f}^{CD 122 : CD 132} \cdot {R}_{s}^{CellTypeA : CD 122} [ t ] \cdot {R}_{s}^{CellTypeA : CD 132} [ t ] + {k}_{r}^{CD 122 : CD 132} \cdot {R}_{s}^{CellTypeA : CD 122 : CD 132} [ t ] - {k}_{t}^{CellTypeA : CD 122} \cdot {R}_{S}^{CellTypeA : CD 122} + {V}_{S}^{CellTypeA : CD 122} + ( \begin{matrix}{k}_{syn}^{CD 122 : IL 2 : CD 25} \cdot {C}_{S}^{CellTypeA : IL 2 : CD 25 : CD 122 : CD 132} + \\ {k}_{syn}^{CD 122 : IL 2 : CD 122} \cdot {C}_{S}^{CellTypeA : IL 2 : CD 122 : CD 132} + \\ {k}_{syn}^{CD 122 : IL 4 : CD 213} \cdot {C}_{S}^{CellTypeA : IL 4 : CD 124 : CD 213} + \\ {k}_{syn}^{CD 122 : IL 4 : CD 132} \cdot {C}_{S}^{CellTypeA : IL 4 : CD 124 : CD 132} + \\ {k}_{syn}^{CD 122 : IL 7} \cdot {C}_{S}^{CellTypeA : IL 7 : CD 127 : CD 132} + \\ {k}_{syn}^{CD 122 : IL 9} \cdot {C}_{S}^{CellTypeA : IL 9 : CD 129 : CD 132} + \\ {k}_{syn}^{CD 122 : IL 13} \cdot {C}_{S}^{CellTypeA : IL 13 : CD 124 : CD 213} + \\ {k}_{syn}^{CD 122 : IL 15} \cdot {C}_{S}^{CellTypeA : IL 15 : IL 15 R : CD 122 : CD 132} + \\ {k}_{syn}^{CD 122 : TSLP} \cdot {C}_{S}^{CellTypeA : TSLP : CD 127 : TSLPR} + \\ {k}_{syn}^{CD 122 : IL 21} \cdot {C}_{S}^{CellTypeA : IL 21 : IL 21 R : CD 132}\end{matrix} ) - {k}_{f}^{IL 2 : CD 122} \cdot {R}_{s}^{CellTypeA : CD 122} [ t ] \cdot {L}^{IL 2} [ t ] + {k}_{r}^{IL 2 : CD 122} \cdot {C}_{s}^{CellTypeA : IL 2 : CD 122} [ t ] - {k}_{f}^{CD 122 : CD 25} \cdot {R}_{s}^{CellTypeA : CD 122} [ t ] \cdot {R}_{s}^{CellTypeA : CD 25} + {k}_{r}^{CD 122 : CD 25} \cdot {R}_{s}^{CellTypeA : CD 122 : CD 25} [ t ] - {k}_{f}^{CD 122 : IL 2 : CD 25} \cdot {R}_{s}^{CellTypeA : CD 122} [ t ] \cdot {C}_{s}^{CellTypeA : IL 2 : CD 25} [ t ] + {k}_{r}^{CD 122 : IL 2 : CD 25} \cdot {C}_{s}^{CellTypeA : CD 122 : IL 2 : CD 25} [ t ] & 7\end{matrix}$$

$$\begin{matrix}\frac{d {R}_{i}^{CellTypeA : CD 122}}{d t} = - {k}_{fe}^{CD 122 : CD 132} \cdot {R}_{i}^{CellTypeA : CD 122} [ t ] \cdot {R}_{i}^{CellTypeA : CD 132} [ t ] + {k}_{re}^{CD 122 : CD 132} \cdot {R}_{i}^{CellTypeA : CD 122 : CD 132} [ t ] + {k}_{t}^{CellTypeA : CD 122} \cdot {R}_{S}^{CellTypeA : CD 122} [ t ] - {k}_{h}^{CellTypeA : CD 122} \cdot {R}_{i}^{CellTypeA : CD 122} [ t ] - {k}_{fe}^{IL 2 : CD 122} \cdot {R}_{i}^{CellTypeA : CD 122} [ t ] \cdot {L}_{i}^{CellTypeA : IL 2} [ t ] + {k}_{re}^{IL 2 : CD 122} \cdot {C}_{i}^{CelltypeA : IL 2 : CD 122} [ t ] - {k}_{fe}^{CD 122 : CD 25} \cdot {R}_{i}^{CellTypeA : CD 122} [ t ] \cdot {R}_{i}^{CellTypeA : CD 25} [ t ] + {k}_{re}^{CD 122 : CD 25} \cdot {R}_{i}^{CellTypeA : CD 122 : CD 25} [ t ] - {k}_{fe}^{CD 122 : IL 2 : CD 25} \cdot {R}_{i}^{CellTypeA : CD 122} [ t ] \cdot {C}_{i}^{CellTypeA : IL 2 : CD 25} [ t ] + {k}_{re }^{CD 122 : IL 2 : CD 25} \cdot {C}_{i}^{CellTypeA : CD 122 : IL 2 : CD 25} [ t ] & 8\end{matrix}$$

$$\begin{matrix}\frac{d {R}_{S}^{CellTypeA : CD 127 : CD 132}}{d t} = {k}_{f}^{CD 127 : CD 132} \cdot {R}_{S}^{CellTypeA : CD 127} [ t ] \cdot {R}_{S}^{CellTypeA : CD 132} [ t ] - {k}_{r}^{CD 127 : CD 132} \cdot {R}_{S}^{CellTypeA : CD 127 : CD 132} [ t ] - {k}_{f}^{IL 7 : CD 127 : CD 132} \cdot {R}_{S}^{CellTypeA : CD 127 : CD 132} [ t ] \cdot {L}^{IL 7} [ t ] + {k}_{r}^{IL 7 : CD 127 : CD 132} \cdot {C}_{S}^{CellTypeA : CD 127 : CD 132} [ t ] - {k}_{t}^{CellTypeA : CD 127 : CD 132} \cdot {R}_{S}^{CellTypeA : CD 127 : CD 132} [ t ] & 9\end{matrix}$$

$$\begin{matrix}\frac{d {R}_{i}^{CellTypeA : CD 127 : CD 132}}{d t} = {k}_{fe}^{CD 127 : CD 132} \cdot {R}_{i}^{CellTypeA : CD 127} [ t ] \cdot {R}_{i}^{CellTypeA : CD 132} [ t ] - {k}_{re}^{CD 127 : CD 132} \cdot {R}_{i}^{CellTypeA : CD 127 : CD 132} [ t ] - {k}_{fe}^{IL 7 : CD 127 : CD 132} \cdot {R}_{i}^{CellTypeA : CD 127 : CD 132} [ t ] \cdot {L}_{i}^{CellTypeA : IL 7} [ t ] + {k}_{re}^{IL 7 : CD 127 : CD 132} \cdot {C}_{i}^{CellTypeA : IL 7 : CD 127 : CD 132} [ t ] + {k}_{t}^{CellTypeA : CD 127 : CD 132} \cdot {R}_{S }^{CellTypeA : CD 127 : CD 132} [ t ] k - {k}_{h}^{CellTypeA : CD 127 : CD 132} \cdot {R}_{i}^{CellTypeA : CD 127 : CD 132} [ t ] & 10\end{matrix}$$

$$\begin{matrix}\frac{d {R}_{S}^{CellTypeA : CD 127}}{d t} = - {k}_{f}^{CD 127 : CD 132} \cdot {R}_{S}^{CellTypeA : CD 127} [ t ] \cdot {R}_{S}^{CellTypeA : CD 132} [ t ] + {k}_{r}^{CD 127 : CD 132} \cdot {R}_{S}^{CellTypeA : CD 127 : CD 132} [ t ] - {k}_{f}^{CD 127 : TSLPR} \cdot {R}_{S}^{CellTypeA : CD 127} [ t ] \cdot {R}_{S}^{CellTypeA : TSLPR} [ t ] + {k}_{r}^{CD 127 : TSLPR} \cdot {R}_{S}^{CelltypeA : CD 127 : TSLPR} [ t ] - {k}_{t}^{CellTypeA : CD 127} \cdot {R}_{S}^{CellTypeA : CD 127} [ t ] + {V}_{S}^{CellTypeA : CD 127} + ( \begin{matrix}\begin{matrix}\begin{matrix}\begin{matrix}\begin{matrix}{k}_{syn}^{CD 127 : IL 2 : CD 25} \cdot {C}_{S}^{CellTypeA : IL : CD 2 : CD 25 : CD 122 : CD 132} + \\ {k}_{syn}^{CD 127 : IL 2 : CD 122} \cdot {C}_{S}^{CellTypeA : IL 2 : CD 122 : CD 132} +\end{matrix} \\ {k}_{syn}^{CD 127 : IL 4 : CD 213} \cdot {C}_{S}^{CellTypeA : IL 4 : CD 124 : CD 213} +\end{matrix} \\ {k}_{syn}^{CD 127 : IL 4 : CD 132} \cdot {C}_{S }^{CellTypeA : CD 124 : CD 132} +\end{matrix} \\ {k}_{syn}^{CD 127 : IL 7} \cdot {C}_{S }^{CellTypeA : IL 7 : CD 127 : CD 132} +\end{matrix} \\ {k}_{syn}^{CD 127 : IL 9} \cdot {C}_{S}^{CellTypeA : IL 9 : CD 129 : CD 132} + \\ {k}_{syn}^{CD 127 : IL 13} \cdot {C}_{S}^{CellTypeA : IL 13 : CD 124 : CD 213} + \\ {k}_{syn}^{CD 127 : IL 15} \cdot {C}_{S}^{CellTypeA : IL 15 : IL 15 R : CD 122 : CD 132} + \\ {k}_{syn}^{CD 127 : TSLP} \cdot {C}_{S}^{CellTypeA : TSLP : CD 127 : TSLP} + \\ {k}_{syn}^{CD 127 : IL 21} \cdot {C}_{S}^{CellTypeA : IL 21 : IL 21 R : CD 132}\end{matrix} ) - {k}_{f}^{IL 7 : CD 127} \cdot {R}_{S}^{CellTypeA : CD 127} [ t ] \cdot {k}_{r}^{IL 7 : CD 127} \cdot {C}_{S}^{CellTypeA : IL 7 : CD 127} [ t ] - {k}_{f}^{CD 127 : TSLP : TSLPR} \cdot {R}_{S}^{CellTypeA : CD 127} [ t ] \cdot {C}_{S}^{CellTypeA : TSLP : TSLPR} [ t ] + {k}_{r}^{CD 127 : TSLP : TSLPR} \cdot {C}_{S}^{CellTypeA : CD 127 : TSLP : TSLPR} [ t ] & 11\end{matrix}$$

$$\begin{matrix}\frac{d {R}_{i}^{CellTypeA : CD 127}}{d t} = - {k}_{fe}^{CD 127 : CD 132} \cdot {R}_{i}^{CellTypeA : CD 127} [ t ] \cdot {R}_{i}^{CellTypeA : CD 132} [ t ] + {k}_{re}^{CD 127 : CD 132} \cdot {R}_{i}^{CellTypeA : CD 127 : CD 132} [ t ] - {k}_{fe}^{CD 127 : TSLPR} \cdot {R}_{i}^{CellTypeA : CD 127} [ t ] \cdot {R}_{i}^{CellTypeA : TSPLR} [ t ] + {k}_{re}^{CD 127 : TSLPR} \cdot {R}_{i}^{CellTypeA : CD 127 : TSLPR} [ t ] + {k}_{t}^{CellTypeA : CD 127} \cdot {R}_{S}^{CellTypeA : CD 127} [ t ] - {k}_{h}^{CellTypeA : CD 127} \cdot {R}_{i}^{CellTypeA : CD 127} [ t ] - {k}_{fe}^{IL 7 : CD 127} \cdot {R}_{i}^{CellTypeA : CD 127} [ t ] \cdot {L}_{i}^{CellTypeA : IL 7} [ t ] + {k}_{re}^{IL 7 : CD 127} \cdot {C}_{i}^{CellTypeA : IL 7 : CD 127} [ t ] - {k}_{fe}^{CD 127 : TSLP : TSLPR} \cdot {R}_{i}^{CellTypeA : CD 127} [ t ] \cdot {C}_{i}^{CellTypeA : TSLP : TSLPR} [ t ] + {k}_{re}^{CD 127 : TSLP : TSLPR} \cdot {C}_{i}^{CellTypeA : CD 127 : TSLP : TSLPR} [ t ] & 12\end{matrix}$$

$$\begin{matrix}\frac{d {R}_{S}^{CellTypeA : TSLPR}}{d t} = - {k}_{f}^{CD 127 : TSLPR} [ t ] \cdot {R}_{S}^{CellTypeA : CD 127} [ t ] \cdot {R}_{S}^{CellTypeA : TSPR} [ t ] + {k}_{r}^{CD 127 : TSLPR} \cdot {R}_{S}^{CellTypeA : CD 127 : TSLPR} [ t ] - {k}_{t}^{CellTypeA : TSLPR} \cdot {R}_{S}^{CellTypeA : TSLPR} [ t ] + {V}_{S}^{CellTypeA : TSLPR} + ( \begin{matrix}{k}_{syn}^{TSLPR : IL 2 : CD 25} \cdot {C}_{S}^{CellTyeA : IL 2 : IL 2 : CD 25 : CD 122 : CD 132} + \\ {k}_{syn}^{TSLPR : IL 2 : CD 122} \cdot {C}_{S}^{CellTypeA : IL 2 : CD 122 : CD 132} + \\ {k}_{syn}^{TSLPR : IL 4 : CD 213} \cdot {C}_{S}^{CellTypeA : IL 4 : CD 124 : CD 213} + \\ {k}_{syn}^{TSLPR : IL 4 : CD 132} \cdot {C}_{S}^{CellTypeA : IL 4 : CD 124 : CD 132} + \\ {k}_{syn}^{TSLPR : IL 7} \cdot {C}_{S}^{CellTypeA : IL 7 : CD 127 : CD 132} + \\ {k}_{syn}^{TSLPR : IL 9} \cdot {C}_{S}^{CellTypeA : IL 9 : CD 129 : CD 132} + \\ {k}_{syn}^{TSLPR : IL 13} \cdot {C}_{S}^{CellTypeA : IL 13 : CD 124 : CD 213} + \\ {k}_{syn}^{TSLPR : IL 15} \cdot {C}_{S}^{CellTypeA : IL 15 : IL 15 R : CD 122 : CD 132} + \\ {k}_{syn}^{TSLPR : TSLP} \cdot {C}_{S}^{CellTypeA : TSLP : CD 127 : TSLPR} + \\ {k}_{syn}^{TSLPR : IL 21} \cdot {C}_{S}^{CellTypeA : IL 21 : IL 21 R : CD 132}\end{matrix} ) - {k}_{f}^{TSLP : TSLPR} \cdot {L}^{TSLP} [ t ] \cdot {R}_{S}^{CellTypeA : TSLPR} [ t ] + {k}_{r}^{TSLP : TSLPR} \cdot {C}_{S}^{CellTypeA : TSLP : TSLPR} [ t ] & 13\end{matrix}$$

$$\begin{matrix}\frac{d {R}_{i}^{CellTypeA : TSLPR}}{d t} = - {k}_{fe}^{CD 127 : TSLPR} \cdot {R}_{i}^{CellTypeA : CD 127} [ t ] \cdot {R}_{i}^{CellTypeA : TSLPR} [ t ] + {k}_{re}^{CD 127 : TSLPR} \cdot {R}_{i}^{CellTypeA : CD 127 : TSLPR} [ t ] + {k}_{t}^{CellTypeA : TSLPR} \cdot {C}_{S}^{CellTypeA : TSLPR} [ t ] - {k}_{h }^{CellTypeA : TSLPR} \cdot {R}_{i}^{CellTypeA : TSLPR} [ t ] - {k}_{fe}^{TSLP : TSLPR} \cdot {L}_{i}^{CellTypeA : TSLP} [ t ] \cdot {R}_{i}^{CellTypeA : TSLR} [ t ] + {k}_{re}^{TSLP : TSLPR} \cdot {C}_{i}^{CellTypeA : TSLP : TSLPR} [ t ] & 14\end{matrix}$$

$$\begin{matrix}\frac{d {R}_{S}^{CellTypeA : CD 127 : TSLPR}}{d t} = {k}_{f}^{CD 127 : TSLPR} \cdot {R}_{S}^{CellTypeA : CD 127} [ t ] \cdot {R}_{S}^{CellTypeA : TSLPR} [ t ] - {k}_{r}^{CD 127 : TSLPR} \cdot {R}_{S}^{CelTypeA : CD 127 : TSLPR} [ t ] - {k}_{f}^{TSLP : CD 127 : TSLPR} \cdot {R}_{S}^{CellTypeA : CD 127 : TSLPR} [ t ] \cdot {L}^{TSLP} [ t ] + {k}_{r}^{TSLP : CD 127 : TSLPR} \cdot {C}_{S}^{CellTypeA : TSLP : CD 127 : TSLPR} [ t ] - {k}_{t}^{CellTypeA : CD 127 : TSLPR} \cdot {R}_{S}^{CellTypeA : CD 127 : TSLPR} [ t ] & 15\end{matrix}$$

$$\begin{matrix}\frac{d {R}_{i}^{CellTypeA : CD 127 : TSLPR}}{d t} = {k}_{fe}^{CD 127 : TSLPR} \cdot {R}_{i}^{CellTypeA : CD 127} [ t ] \cdot {R}_{i}^{CellTypeA : TSLPR} [ t ] - {k}_{re}^{CD 127 : TSLPR} \cdot {R}_{i}^{CellTypeA : CD 127 : TSLPR} [ t ] - {k}_{fe}^{TSLP : CD 127 : TSLPR} \cdot {R}_{i}^{CellTypeA : CD 127 : TSLPR} [ t ] \cdot {L}_{i}^{CellTypeA : TSLP} [ t ] + {k}_{re}^{TSLP : CD 127 : TSLPR} \cdot {C}_{i}^{CellTypeA : TSLPR : CD 127 : TSLPR} [ t ] + {k}_{t}^{CellTypeA : CD 127 : TSLPR} \cdot {R}_{S}^{CellTypeA : CD 127 : TSLPR} [ t ] - {k}_{h}^{CellTypeA : CD 127 : TSLPR} \cdot {R}_{i}^{CellTypeA : CD 127 : TSLPR} [ t ] & 16\end{matrix}$$

$$\begin{matrix}\frac{d {R}_{S}^{CellTypeA : CD 124}}{d t} = - {k}_{f}^{CD 124 : CD 132} \cdot {R}_{S}^{CellTypeA : CD 124} [ t ] \cdot {R}_{S}^{CellTypeA : CD 132} [ t ] + {k}_{r}^{CD 124 : CD 132} \cdot {R}_{S}^{CellTypeA : CD 124 : CD 132} [ t ] - {k}_{f}^{CD 124 : CD 213} \cdot {R}_{S}^{CellTypeA : CD 124} [ t ] \cdot {R}_{S}^{CellTypeA : CD 213} [ t ] + {k}_{r}^{CD 124 : CD 213} \cdot {R}_{S}^{CellTypeA : CD 124 : CD 213} [ t ] - {k}_{t}^{CellTypeA : CD 124} \cdot {R}_{S}^{CellTypeA : CD 124} [ t ] + {V}_{S}^{CellTypeA : CD 124} + ( \begin{matrix}{k}_{syn}^{CD 124 : IL 2 : CD 25} \cdot {C}_{S}^{CellTypeA : IL 2 : CD 25 : CD 122 : CD 132} + \\ {k}_{syn}^{CD 124 : IL 2 : CD 122} \cdot {C}_{S}^{CellTypeA : IL 2 : CD 122 : CD 132} + \\ {k}_{syn}^{CD 124 : IL 4 : CD 213} \cdot {C}_{S}^{CellTypeA : IL 4 : CD 124 : CD 213} + \\ {k}_{syn}^{CD 124 : IL 4 : CD 132} \cdot {C}_{S}^{CellTypeA : IL 4 : CD 124 : CD 132} + \\ {k}_{syn}^{CD 124 : IL 7} \cdot {C}_{S}^{CellTypeA : IL 7 : CD 127 : CD 132} + \\ {k}_{syn}^{CD 124 : IL 9} \cdot {C}_{S}^{CellTypeA : IL 9 : CD 129 : CD 132} + \\ {k}_{syn}^{CD 124 : IL 13} \cdot {C}_{S}^{CellTypeA : IL 13 : CD 124 : CD 213} + \\ {k}_{syn}^{CD 124 : IL 15} \cdot {C}_{S}^{CellTypeA : IL 15 : IL 15 R : CD 132} + \\ {k}_{syn}^{CD 124 : TSLP} \cdot {C}_{S}^{CellTypeA : TSLP : CD 127 : TSLPR} + \\ {k}_{syn}^{CD 124 : IL 21} \cdot {C}_{S}^{CellTypeA : IL 21 : IL 21 R : CD 132}\end{matrix} ) - {k}_{f}^{IL 4 : CD 124} \cdot {R}_{S}^{CellTypeA : CD 124} [ t ] \cdot {L}^{IL 4} [ t ] + {k}_{r}^{IL 4 : CD 124} \cdot {C}_{S}^{CellTypeA : IL 4 : CD 124} [ t ] - {k}_{f}^{IL 13 : CD 124} \cdot {R}_{S}^{CellTypeA : CD 124} [ t ] \cdot {L}^{IL 13} [ t ] + {k}_{r}^{IL 13 : CD 124} \cdot {C}_{S }^{CellTypeA : IL 13 : CD 124} [ t ] - {k}_{f}^{CD 124 : IL 4 : CD 213} \cdot {C}_{S}^{CellTypeA : IL 4 : CD 124} [ t ] \cdot {C}_{S}^{CellTypeA : IL 4 : CD 213} [ t ] + {k}_{r}^{CD 124 : IL 4 : CD 213} \cdot {C}_{S}^{CellTypeA : IL 4 : CD 124 : CD 213} [ t ] - {k}_{f}^{CD 124 : IL 13 : CD 213} \cdot {C}_{S}^{CellTypeA : CD 124} [ t ] \cdot {C}_{S}^{CellTypeA : IL 13 : CD 213} [ t ] + {k}_{r}^{CD 124 : IL 13 : CD 213} \cdot {C}_{S}^{CellTypeA : IL 13 : CD 124 : CD 213 } [ t ] & 17\end{matrix}$$

$$\begin{matrix}\frac{d {R}_{i}^{CellTypeA : CD 124}}{d t} = - {k}_{fe}^{CD 124 : CD 132} \cdot {R}_{i}^{CellTypeA : CD 124} \cdot {R}_{i}^{CellTypeA : CD 132} [ t ] + {k}_{re}^{CD 124 : CD 132} \cdot {R}_{i}^{CellTypeA : CD 124 : CD 132} [ t ] - {k}_{fe}^{CD 124 : CD 213} \cdot {R}_{i}^{CellTypeA : CD 124} [ t ] \cdot {R}_{i}^{CellTypeA : CD 213} [ t ] + {k}_{re}^{CD 124 : CD 213} \cdot {R}_{i}^{CellTypeA : CD 124 : CD 213} [ t ] + {k}_{t}^{CellTypeA : CD 124} \cdot {R}_{S}^{CellTypeA : CD 124} [ t ] - {k}_{h}^{CellTypeA : CD 124} \cdot {R}_{i}^{CellTypeA : CD 124} [ t ] - {k}_{fe}^{IL 4 : CD 124} \cdot {R}_{i}^{CellTypeA : CD 124} [ t ] \cdot {L}_{i}^{CellTypeA : IL 4} [ t ] + {k}_{re}^{IL 4 : CD 124} \cdot {C}_{i}^{CellTypeA : IL 4 : CD 124} [ t ] - {k}_{fe}^{IL 13 : CD 124} \cdot {R}_{i}^{CellTypeA : CD 124} [ t ] \cdot {L}_{i}^{CellTypeA : IL 13} [ t ] + {k}_{re}^{IL 13 : CD 124} \cdot {C}_{i}^{CellTypeA : IL 13 : CD 124} [ t ] - {k}_{fe }^{CD 124 : IL 4 : CD 213} \cdot {R}_{i}^{CellTypeA : CD 124} [ t ] \cdot {C}_{i}^{CellTypeA : IL 4 : CD 213} [ t ] + {k}_{re}^{CD 124 : IL 4 : CD 213} \cdot {C}_{i}^{CelltypeA : IL 4 : CD 124 : CD 213} [ t ] - {k}_{fe}^{CD 124 : IL 13 : CD 213} \cdot {R}_{i}^{CellTypeA : CD 124} [ t ] \cdot {C}_{i}^{CellTypeA : IL 13 : CD 213} [ t ] + {k}_{re}^{CD 124 : IL 13 : CD 213} \cdot {C}_{i}^{CellTypeA : IL 13 : CD 124 : CD 213} [ t ] & 18\end{matrix}$$

$$\begin{matrix}\frac{d {R}_{S}^{CellTypeA : CD 124 : CD 132}}{d t} = {k}_{f}^{CD 124 : CD 132} \cdot {R}_{S}^{CellTypeA : CD 124} [ t ] \cdot {R}_{S}^{CellTypeA : CD 132} [ t ] - {k}_{r}^{CD 124 : CD 132} \cdot {R}_{S}^{CellTypeA : CD 124 : CD 132} [ t ] - {k}_{f}^{IL 4 : CD 124 : CD 132} \cdot {R}_{S}^{CellTypeA : CD 124 : CD 132} [ t ] \cdot {L}^{IL 4 } [ t ] + {k}_{r}^{IL 4 : CD 124 : CD 132} \cdot {C}_{S}^{CellTypeA : IL 4 : CD 124 : CD 132} [ t ] - {k}_{t}^{CellTypeA : CD 124 : CD 132} \cdot {R}_{S}^{CellTypeA : CD 124 : CD 132} [ t ] & 19\end{matrix}$$

$$\begin{matrix}\frac{d {R}_{i}^{CellTypeA : CD 124 : CD 132}}{d t} = {k}_{fe}^{CD 124 : CD 132} \cdot {R}_{i}^{CellTypeA : CD 124} [ t ] \cdot {R}_{i}^{CellTypeA : CD 132} [ t ] - {k}_{re}^{CD 124 : CD 132} \cdot {R}_{i}^{CellTypeA : CD 124 : CD 132} [ t ] - {k}_{fe}^{IL 4 : CD 124 : CD 132} \cdot {R}_{i}^{CellTypeA : CD 124 : CD 132} [ t ] \cdot {L}_{i}^{CellTypeA : IL 4} [ t ] + {k}_{re}^{IL 4 : CD 124 : CD 132} \cdot {C}_{i}^{CellTypeA : IL 4 : CD 124 : CD 132} [ t ] + {k}_{t}^{CellTypeA : CD 124 : CD 132} \cdot {R}_{S}^{CellTypeA : CD 124 : CD 132} [ t ] - {k}_{h}^{CellTypeA : CD 124 : CD 122} \cdot {R}_{i}^{CellTypeA : CD 124 : CD 132} [ t ] & 20\end{matrix}$$

$$\frac{d {R}_{S}^{CellTypeA : CD 213}}{d t} = - {k}_{f}^{CD 124 : CD 213} \cdot {R}_{S}^{CellTypeA : CD 124} [ t ] \cdot {R}_{S}^{CellTypeA : CD 213} + {k}_{r}^{CD 124 : CD 213} \cdot {R}_{S}^{CellTypeA : CD 124 : CD 213} [ t ] - {k}_{t}^{CellTypeA : CD 213} \cdot {R}_{S}^{CellTypeA : CD 213} [ t ] + {V}_{S}^{CellTypeA : CD 213} + ( {k}_{syn}^{CD 213 : IL 2 : CD 25} \cdot {C}_{S}^{CellTypeA : IL 2 : CD 25 : CD 122 : CD 132} + {k}_{syn}^{CD 213 : IL 2 : CD 122} \cdot {C}_{S}^{CellTypeA : IL 2 : CD 122 : CD 132} + {k}_{syn}^{CD 213 : IL 4 : CD 213} \cdot {C}_{S}^{CellTypeA : IL 4 : CD 124 : CD 213} + {k}_{syn}^{CD 213 : IL 4 : CD 132} \cdot {C}_{S}^{CellTypeA : IL 4 : CD 124 : CD 132} + {k}_{syn}^{CD 213 : IL 7} \cdot {C}_{S}^{CellTypeA : IL 7 : CD 127 : CD 132} + {k}_{syn}^{CD 213 : IL 9} \cdot {C}_{S}^{CellTypeA : IL 9 : CD 129 : CD 132} + {k}_{syn}^{CD 213 : IL 13} \cdot {C}_{S}^{CellTypeA : IL 13 : CD 124 : CD 213} + {k}_{syn}^{CD 213 : IL 15} \cdot {C}_{S}^{CellTypeA : IL 15 : IL 15 R : CD 122 : CD 132} + {k}_{syn}^{CD 213 : TSLP} \cdot {C}_{S}^{CellTypeA : TSLP : CD 127 : TSLPR} + {k}_{syn}^{CD 213 : IL 21} \cdot {C}_{S}^{CellTypeA : IL 21 : IL 21 R : CD 132} ) - {k}_{f}^{IL 13 : CD 213} \cdot {R}_{S}^{CellTypeA : CD 213} [ t ] \cdot {L}^{IL 13} [ t ] + {k}_{r}^{IL 13 : CD 213} \cdot {C}_{S}^{CellTypeA : IL 13 : CD 213} [ t ] - {k}_{f}^{IL 4 : CD 213} \cdot {R}_{S}^{CellTypeA : CD 213} [ t ] \cdot {L}^{IL 4} [ t ] + {k}_{r}^{IL 4 : CD 213} \cdot {C}_{S}^{CellTypeA : IL 4 : CD 213} [ t ] - {k}_{f}^{CD 213 : IL 13 : CD 124} \cdot {C}_{S}^{CellTypeA : IL 13 : CD 124} [ t ] \cdot {R}_{S}^{CellTypeA : CD 213} [ t ] + {k}_{r}^{CD 213 : IL 13 : CD 124} \cdot {C}_{S}^{CellTypeA : IL 13 : CD 124 : CD 213} [ t ] - {k}_{f}^{CD 213 : IL 4 : CD 124} \cdot {C}_{S}^{CellTypeA : IL 4 : CD 124} [ t ] \cdot {R}_{s}^{CellTypeA : CD 213} [ t ] + {k}_{r}^{CD 213 : IL 4 : CD 124} \cdot {C}_{S}^{CellTypeA : IL 4 : CD 124 : CD 213} [ t ] \qquad 21$$

$$\frac{d {R}_{i}^{CellTypeA : CD 213}}{d t} = - {k}_{fe}^{CD 124 : CD 213} \cdot {R}_{i}^{CellTypeA : CD 124} [ t ] \cdot {R}_{i}^{CellTypeA : CD 213} [ t ] + {k}_{re}^{CD 124 : CD 213} \cdot {R}_{i}^{CellTypeA : CD 124 : CD 213} [ t ] + {k}_{t}^{CellTypeA : CD 213} \cdot {R}_{S}^{CellTypeA : CD 213} [ t ] - {k}_{h}^{CellTypeA : CD 213} \cdot {R}_{i}^{CellTypeA : CD 213} [ t ] - {k}_{fe}^{IL 13 : CD 213} \cdot {R}_{i}^{CellTypeA : CD 213} [ t ] \cdot {L}_{i}^{CellTypeA : IL 13} [ t ] + {k}_{re}^{IL 13 : CD 213} \cdot {C}_{i}^{CellTypeA : IL 13 : CD 213} [ t ] - {k}_{fe}^{IL 4 : CD 213} \cdot {R}_{i}^{CellTypeA : CD 213} [ t ] \cdot {L}_{i}^{CellTypeA : IL 4} [ t ] + {k}_{re}^{IL 4 : CD 213} \cdot {C}_{i}^{CellTypeA : IL 4 : CD 213} [ t ] - {k}_{fe}^{CD 213 : IL 13 : CD 124} \cdot {C}_{i}^{CellTypeA : IL 13 : CD 124} [ t ] \cdot {R}_{i}^{CellTypeA : CD 213} [ t ] + {k}_{re}^{CD 213 : IL 13 : CD 124} \cdot {C}_{i}^{CellTypeA : IL 13 : CD 124 : CD 213} [ t ] - {k}_{fe}^{CD 213 : IL 4 : CD 124} \cdot {C}_{i}^{CellTypeA : IL 4 : CD 124} [ t ] \cdot {R}_{i}^{CellTypeA : CD 213} [ t ] + {k}_{re}^{CD 213 : IL 4 : CD 124} \cdot {C}_{i}^{CellTypeA : IL 4 : CD 124 : CD 213} [ t ] \qquad 22$$

$$\frac{d {R}_{s}^{CellTypeA : CD 124 : CD 213}}{d t} = {k}_{f}^{CD 124 : CD 213} \cdot {R}_{S}^{CellTypeA : CD 124} [ t ] \cdot {R}_{S}^{CellTypeA : CD 213} - {k}_{r}^{CD 124 : CD 213} \cdot {R}_{S}^{CellTypeA : CD 124 : CD 213} [ t ] - {k}_{f}^{IL 13 : CD 124 : CD 213} \cdot {R}_{S}^{CellTypeA : CD 124 : CD 213} [ t ] \cdot {L}^{IL 13} [ t ] + {k}_{r}^{IL 13 : CD 124 : CD 213} \cdot {C}_{s}^{CellTypeA : IL 13 : CD 124 : CD 213} [ t ] - {k}_{f}^{IL 4 : CD 124 : CD 213} \cdot {R}_{S}^{CellTypeA : CD 124 : CD 213} [ t ] \cdot {L}^{IL 4} [ t ] + {k}_{r}^{IL 4 : CD 124 : CD 213} \cdot {C}_{S}^{CellTypeA : IL 4 : CD 124 : CD 213} [ t ] - {k}_{t}^{CellTypeA : CD 124 : CD 213} \cdot {R}_{S}^{CellTypeA : CD 124 : CD 213} [ t ] \qquad 23$$

$$\frac{d {R}_{i}^{CellTypeA : CD 124 : CD 213}}{d t} = {k}_{fe}^{CD 124 : CD 213} \cdot {R}_{i}^{CellTypeA : CD 124} [ t ] \cdot {R}_{i}^{CellTypeA : CD 213} [ t ] - {k}_{re}^{CD 124 : CD 213} \cdot {R}_{i}^{CellTypeA : CD 124 : CD 213} [ t ] - {k}_{fe}^{IL 13 : CD 124 : CD 213} \cdot {R}_{i}^{CellTypeA : CD 124 : CD 213} [ t ] \cdot {L}_{i}^{CellTypeA : IL 13} [ t ] + {k}_{re}^{IL 13 : CD 124 : CD 213} \cdot {C}_{i}^{CellTypeA : IL 13 : CD 124 : CD 213} [ t ] - {k}_{fe}^{IL 4 : CD 124 : CD 213} \cdot {R}_{i}^{CellTypeA : CD 124 : CD 213} [ t ] \cdot {L}_{i}^{CellTypeA : IL 4} [ t ] + {k}_{re}^{IL 4 : CD 124 : CD 213} \cdot {C}_{i}^{CellTypeA : IL 4 : CD 124 : CD 213} [ t ] + {k}_{t}^{CellTypeA : CD 124 : CD 213} \cdot {R}_{S}^{CellTypeA : CD 124 : CD 213} [ t ] - {k}_{h}^{CellTypeA : CD 124 : Cd 213} \cdot {R}_{i}^{CellTypeA : CD 124 : CD 213} [ t ] \qquad 24$$

$$\frac{d {R}_{S}^{CellTypeA : IL 21 R}}{d t} = - {k}_{f}^{IL 21 R : CD 132} \cdot {R}_{S}^{CellTypeA : IL 21 R} [ t ] \cdot {R}_{S}^{CellTypeA : CD 132} [ t ] + {k}_{r}^{IL 21 R : CD 132} \cdot {R}_{S}^{CellTypeA : IL 21 R : CD 132} [ t ] - {k}_{t}^{CellTypeA : IL 21 R} \cdot {R}_{S}^{CellTypeA : IL 21 R} + {V}_{S}^{CellTypeA : CD 213} + ( {k}_{syn}^{IL 21 R : IL 2 : CD 25} \cdot {C}_{S}^{CellTypeA : IL 2 : CD 25 : CD 122 : CD 132} + {k}_{syn}^{IL 21 R : IL 2 : CD 122} \cdot {C}_{S}^{CellTypeA : IL 2 : CD 122 : CD 132} + {k}_{syn}^{IL 21 R : IL 4 : CD 213} \cdot {C}_{S}^{CellTypeA : IL 4 : CD 124 : CD 213} + {k}_{syn}^{IL 21 R : IL 4 : CD 132} \cdot {C}_{S}^{CellTypeA : IL 4 : CD 124 : CD 132} + {k}_{syn}^{IL 21 R : IL 7} \cdot {C}_{S}^{CellTypeA : IL 7 : CD 127 : CD 132} + {k}_{syn}^{IL 21 R : IL 9} \cdot {C}_{S}^{CellTypeA : IL 9 : CD 129 : CD 132} + {k}_{syn}^{IL 21 R : IL 13} \cdot {C}_{S}^{CellTypeA : IL 13 : CD 124 : CD 213} + {k}_{syn}^{IL 21 R : IL 15} \cdot {C}_{S}^{CellTypeA : IL 15 : IL 15 R : CD 122 : CD 132} + {k}_{syn}^{IL 21 R : TSLP} \cdot {C}_{S}^{CellTypeA : TSLP : CD 127 : TSLPR} + {k}_{syn}^{IL 21 R : IL 21} \cdot {C}_{S}^{CellTypeA : IL 21 : IL 21 R : CD 132} ) - {k}_{f}^{IL 21 : IL 21 R} \cdot {R}_{S}^{CellTypeA : IL 21 R} [ t ] \cdot {L}^{IL 21} [ t ] + {k}_{r}^{IL 21 : IL 21 R} \cdot {C}_{S}^{CellTypeA : IL 21 : IL 21 R} [ t ] \qquad 25$$

$$\frac{d {R}_{i}^{CellTypeA : IL 21 R}}{d t} = - {k}_{fe}^{IL 21 R : CD 132} \cdot {R}_{i}^{CellTypeA : IL 21 R} [ t ] \cdot {R}_{i}^{CellTypeA : CD 132} [ t ] + {k}_{re}^{IL 21 R : CD 132} \cdot {R}_{i}^{CellTypeA : IL 21 R : CD 132} [ t ] + {k}_{t}^{CellTypeA : IL 21 R} \cdot {R}_{S}^{CellTypeA : IL 21 R} [ t ] - {k}_{h}^{CellTypeA : IL 21 R} \cdot {R}_{i}^{CellTypeA : IL 21 R} [ t ] - {k}_{fe}^{IL 21 : IL 21 R} \cdot {R}_{i}^{CellTypeA : IL 21 R} [ t ] \cdot {L}_{i}^{CellTypeA : IL 21} [ t ] + {k}_{re}^{IL 21 : IL 21 R} \cdot {C}_{i}^{CellTypeA : IL 21 : IL 21 R} [ t ] \qquad 26$$

$$\frac{d {R}_{S}^{CellTypeA : CD 129}}{d t} = - {k}_{f}^{CD 129 : CD 132} \cdot {R}_{S}^{CellTypeA : CD 129} [ t ] \cdot {R}_{S}^{CellTypeA : CD 132} [ t ] + {k}_{r}^{CD 129 : CD 132} \cdot {R}_{S}^{CellTypeA : CD 129 : CD 132} [ t ] - {k}_{t}^{CellTypeA : CD 129} \cdot {R}_{S}^{CellTypeA : CD 129} [ t ] + {V}_{S}^{CellTypeA : CD 129} + ( {k}_{syn}^{CD 129 : IL 2 : CD 25} \cdot {C}_{S}^{CellTypeA : IL 2 : CD 25 : CD 122 : CD 132} + {k}_{syn}^{CD 129 : IL 2 : CD 122} \cdot {C}_{S}^{CellTypeA : IL 2 : CD 122 : CD 132} + {k}_{syn}^{CD 129 : IL 4 : CD 213} \cdot {C}_{S}^{CellTypeA : IL 4 : CD 124 : CD 213} + {k}_{syn}^{CD 129 : IL 4 : CD 132} \cdot {C}_{S}^{CellTypeA : IL 4 : CD 124 : CD 132} + {k}_{syn}^{CD 129 : IL 7} \cdot {C}_{S}^{CellTypeA : IL 7 : CD 127 : CD 132} + {k}_{syn}^{CD 129 : IL 9} \cdot {C}_{S}^{CellTypeA : IL 9 : CD 129 : CD 132} + {k}_{syn}^{CD 129 : IL 13} \cdot {C}_{S}^{CellTypeA : IL 13 : CD 124 : CD 213} + {k}_{syn}^{CD 129 : IL 15} \cdot {C}_{S}^{CellTypeA : IL 15 : IL 15 R : CD 122 : CD 132} + {k}_{syn}^{CD 129 : TSLP} \cdot {C}_{S}^{CellTypeA : TSLP : CD 127 : TSLPR} + {k}_{syn}^{CD 129 : IL 21} \cdot {C}_{S}^{CellTypeA : IL 21 : IL 21 R : CD 132} ) - {k}_{f}^{IL 9 : CD 129} \cdot {R}_{S}^{CellTypeA : CD 129} [ t ] \cdot {L}^{IL 9} [ t ] + {k}_{r}^{IL 9 : CD 129} \cdot {C}_{S}^{CellTypeA : IL 9 : CD 129} [ t ] \qquad 27$$

$$\frac{d {R}_{i}^{CellTypeA : CD 129}}{d t} = - {k}_{fe}^{CD 129 : CD 132} \cdot {R}_{i}^{CellTypeA : CD 129} [ t ] \cdot {R}_{i}^{CellTypeA : CD 132} [ t ] + {k}_{re}^{CD 129 : CD 132} \cdot {R}_{i}^{CellTypeA : CD 129 : CD 132} [ t ] + {k}_{t}^{CellTypeA : CD 129} \cdot {R}_{S}^{CellTypeA : CD 129} [ t ] - {k}_{h}^{CellTypeA : CD 129} \cdot {R}_{i}^{CellTypeA : CD 129} [ t ] - {k}_{fe}^{IL 9 : CD 129} \cdot {R}_{i}^{CellTypeA : CD 129} [ t ] \cdot {L}_{i}^{CellTypeA : IL 9} [ t ] + {k}_{re}^{IL 9 : CD 129} \cdot {C}_{i}^{CellTypeA : IL 9 : CD 129} [ t ] \qquad 28$$

$$\frac{d {R}_{S}^{CellTypeA : IL 21 R : CD 132}}{d t} = {k}_{f}^{IL 21 R : CD 132} \cdot {R}_{S}^{CellTypeA : IL 21 R} [ t ] \cdot {R}_{S}^{CellTypeA : CD 132} [ t ] - {k}_{r}^{IL 21 R : CD 132} \cdot {R}_{S}^{CellTypeA : IL 21 R : CD 132} [ t ] - {k}_{f}^{IL 21 : IL 21 R : CD 132} \cdot {R}_{S}^{CellTypeA : IL 21 R : CD 132} [ t ] \cdot {L}^{IL 21} [ t ] + {k}_{r}^{IL 21 : IL 21 R : CD 132} \cdot {C}_{S}^{CellTypeA : IL 21 : IL 21 R : CD 132} [ t ] - {k}_{t}^{CellTypeA : IL 21 R : CD 132} \cdot {R}_{S}^{CellTypeA : IL 21 R : CD 132} [ t ] \qquad 29$$

$$\frac{d {R}_{i}^{CellTypeA : IL 21 R : CD 132}}{d t} = {k}_{fe}^{IL 21 R : CD 132} \cdot {R}_{i}^{CellTypeA : IL 21 R} [ t ] \cdot {R}_{i}^{CellTypeA : CD 132} [ t ] - {k}_{re}^{IL 21 R : CD 132} \cdot {R}_{i}^{CellTypeA : IL 21 R : CD 132} [ t ] - {k}_{fe}^{IL 21 : IL 21 R : CD 132} \cdot {R}_{i}^{CellTypeA : IL 21 R : CD 132} [ t ] \cdot {L}_{i}^{CellTypeA : IL 21} [ t ] + {k}_{re}^{IL 21 : IL 21 R : CD 132} \cdot {C}_{i}^{CellTypeA : IL 21 : IL 21 R : CD 132} [ t ] + {k}_{t}^{CellTypeA : IL 21 R : CD 132} \cdot {R}_{S}^{CellTypeA : IL 21 R : CD 132} [ t ] - {k}_{h}^{CellTypeA : IL 21 R : CD 132} \cdot {R}_{i}^{CellTypeA : IL 21 R : CD 132} [ t ] \qquad 30$$

$$\frac{d {R}_{S}^{CellTypeA : CD 129 : CD 132}}{d t} = {k}_{f}^{CD 129 : CD 132} \cdot {R}_{S}^{CellTypeA : CD 129} [ t ] \cdot {R}_{S}^{CellTypeA : CD 132} [ t ] - {k}_{r}^{CD 129 : CD 132} \cdot {R}_{S}^{CellTypeA : CD 129 : CD 132} [ t ] - {k}_{f}^{IL 9 : CD 129 : CD 132} \cdot {R}_{S}^{CellTypeA : CD 129 : CD 132} [ t ] \cdot {L}^{IL 9} [ t ] + {k}_{r}^{IL 9 : CD 129 : CD 132} \cdot {C}_{S}^{CellTypeA : IL 9 : CD 129 : CD 132} [ t ] - {k}_{t}^{CellTypeA : CD 129 : CD 132} \cdot {R}_{S}^{CellTypeA : CD 129 : CD 132} [ t ] \qquad 31$$

$$\frac{d {R}_{i}^{CellTypeA : CD 129 : CD 132}}{d t} = {k}_{fe}^{CD 129 : CD 132} \cdot {R}_{i}^{CellTypeA : CD 129} [ t ] \cdot {R}_{i}^{CellTypeA : CD 132} [ t ] - {k}_{re}^{CD 129 : CD 132} \cdot {R}_{i}^{CellTypeA : CD 129 : CD 132} [ t ] - {k}_{fe}^{IL 9 : CD 129 : CD 132} \cdot {R}_{i}^{CellTypeA : CD 129 : CD 132} [ t ] \cdot {L}_{i}^{CellTypeA : IL 9} [ t ] + {k}_{re}^{IL 9 : CD 129 : CD 132} \cdot {C}_{i}^{CellTypeA : IL 9 : CD 129 : CD 132} [ t ] + {k}_{t}^{CellTypeA : CD 129 : CD 132} \cdot {R}_{S}^{CellTypeA : CD 129 : CD 132} [ t ] - {k}_{h}^{CellTypeA : CD 129 : CD 132} \cdot {R}_{i}^{CellTypeACD 129 : CD 132} [ t ] \qquad 32$$

$$\frac{d {C}_{S}^{CellTypeA : IL 9 : CD 129 : CD 132}}{d t} = {k}_{f}^{IL 9 : CD 129 : CD 132} \cdot {R}_{S}^{CellTypeA : CD 129 : CD 132} [ t ] \cdot {L}^{IL 9} - {k}_{r}^{IL 9 : CD 129 : CD 132} \cdot {C}_{S}^{CellTypeA : IL 9 : CD 129 : CD 132} [ t ] - {k}_{e}^{CellTypeA : IL 9 : CD 129 : CD 132} \cdot {C}_{S}^{CellTypeA : IL 9 : Cd 129 : Cd 132} [ t ] + {k}_{f}^{CD 132 : IL 9 : CD 129} \cdot {R}_{S}^{CellTypeA : CD 132} [ t ] \cdot {C}_{S}^{CellTypeA : IL 9 : CD 129} - {k}_{r}^{CD 132 : IL 9 : CD 129} \cdot {C}_{S}^{CellTypeA : IL 9 : CD 129 : CD 132} [ t ] \qquad 33$$

$$\frac{d {C}_{i}^{CellTypeA : IL 9 : CD 129 : CD 132}}{d t} = {k}_{fe}^{IL 9 : CD 129 : CD 132} \cdot {R}_{i}^{CellTypeA : CD 129 : CD 132} [ t ] \cdot {L}_{i}^{CellTypeA : IL 9} - {k}_{re}^{IL 9 : CD 129 : CD 132} \cdot {C}_{i}^{CellTypeA : Il 9 : CD 129 : CD 132} [ t ] + {k}_{e}^{CellTypeA : IL 9 : CD 129 : CD 132} \cdot {C}_{S}^{CellTypeA : IL 9 : CD 129 : CD 132} [ t ] - {k}_{h}^{CellTypeA : IL 9 : CD 129 : CD 132} \cdot {C}_{i}^{CellTypeA : IL 9 : CD 129 : CD 132} [ t ] {k}_{fe}^{CD 132 : IL 9 : CD 129} \cdot {R}_{i}^{CellTypeA : CD 132} [ t ] \cdot {C}_{i}^{CellTypeA : IL 9 : CD 129} - {k}_{re}^{CD 132 : IL 9 : CD 129} \cdot {C}_{i}^{CellTypeA : IL 9 : CD 129 : CD 132} [ t ] \qquad 34$$

$$\frac{d {C}_{S}^{CellTypeA : IL 21 : IL 21 R : CD 132}}{d t} = {k}_{f}^{IL 21 : IL 21 R : CD 132} \cdot {R}_{S}^{CellTypeA : IL 21 R : CD 132} [ t ] \cdot {L}^{IL 21} - {k}_{r}^{IL 21 : IL 21 R : CD 132} \cdot {C}_{S}^{CellTypeA : IL 21 : IL 21 R : CD 132} [ t ] - {k}_{e}^{CellTypeA : IL 21 : IL 21 R : CD 132} \cdot {C}_{S}^{CellTypeA : IL 21 : IL 21 R : CD 132} [ t ] + {k}_{f}^{CD 132 : IL 21 : IL 21 R} \cdot {C}_{S}^{CellTypeA : IL 21 : IL 21 R} [ t ] \cdot {R}_{S}^{CellTypeA : CD 132} - {k}_{r}^{CD 132 : IL 21 : IL 21 R} \cdot {C}_{S}^{CellTypeA : IL 21 : IL 21 R : CD 132} [ t ] \qquad 35$$

$$\frac{d {C}_{i}^{CellTypeA : IL 21 : IL 21 R : CD 132}}{d t} = {k}_{fe}^{IL 21 : IL 21 R : CD 132} \cdot {R}_{i}^{CellTypeA : IL 21 R : CD 132} [ t ] \cdot {L}_{i}^{CellTypeA : IL 21} - {k}_{re}^{IL 21 : IL 21 R : CD 132} \cdot {C}_{i}^{CellTypeA : IL 21 : IL 21 R : CD 132} [ t ] + {k}_{e}^{CellTypeA : IL 21 : IL 21 R : CD 132} \cdot {C}_{S}^{CellTypeA : IL 21 : IL 21 R : CD 132} [ t ] - {k}_{h}^{CellTypeA : IL 21 : IL 21 R : CD 132} \cdot {C}_{i}^{CellTypeA : IL 21 : IL 21 R : CD 132} [ t ] + {k}_{fe}^{CD 132 : IL 21 : IL 21 R} \cdot {C}_{i}^{CellTypeA : IL 21 : IL 21 R} [ t ] \cdot {R}_{i}^{CellTypeA : CD 132} - {k}_{re}^{CD 132 : IL 21 : IL 21 R} \cdot {C}_{i}^{CellTypeA : IL 21 : IL 21 R : CD 132} [ t ] \qquad 36$$

$$\frac{d {C}_{S}^{CellTypeA : IL 13 : CD 124 : CD 213}}{d t} = {k}_{f}^{IL 13 : CD 124 : CD 213} \cdot {R}_{S}^{CellTypeA : CD 124 : CD 213} [ t ] \cdot {L}^{IL 13} - {k}_{r}^{IL 13 : CD 124 : CD 213} \cdot {C}_{S}^{CellTypeA : IL 13 : CD 124 : CD 213} [ t ] - {k}_{e}^{CellTypeA : IL 13 : CD 124 : CD 213} \cdot {C}_{S}^{CellTypeA : IL 13 : CD 124 : CD 213} [ t ] {k}_{f}^{CD 124 : IL 13 : CD 213} \cdot {C}_{S}^{CellTypeA : IL 13 : CD 213} [ t ] \cdot {R}_{S}^{CellTypeA : CD 124} - {k}_{r}^{CD 124 : IL 13 : CD 213} \cdot {C}_{S}^{CellTypeA : IL 13 : CD 124 : CD 213} [ t ] {k}_{f}^{CD 213 : IL 13 : CD 124} \cdot {C}_{S}^{ellTypeA : IL 13 : CD 124} [ t ] \cdot {R}_{S}^{CellTypeA : CD 213} - {k}_{r}^{CD 213 : IL 13 : CD 124} \cdot {C}_{S}^{CellTypeA : IL 13 : CD 124 : CD 213} [ t ] \qquad 37$$

$$\frac{d {C}_{i}^{CellTypeA : IL 13 : CD 124 : CD 213}}{d t} = {k}_{fe}^{IL 13 : CD 124 : CD 213} \cdot {R}_{i}^{CellTypeA : CD 124 : CD 213} [ t ] \cdot {L}_{i}^{CellTypeA : IL 13} - {k}_{re}^{IL 13 : CD 124 : CD 213} \cdot {C}_{i}^{CellTypeA : IL 13 : CD 124 : CD 213} [ t ] + {k}_{e}^{CellTypeA : IL 13 : CD 124 : CD 213} \cdot {C}_{S}^{CellTypeA : IL 13 : CD 124 : CD 213} [ t ] - {k}_{h}^{CellTypeA : IL 13 : CD 124 : CD 213} \cdot {C}_{i}^{CellTypeA : IL 13 : CD 124 : CD 213} [ t ] {k}_{fe}^{CD 124 : IL 13 : CD 213} \cdot {C}_{i}^{CellTypeA : IL 13 : CD 213} [ t ] \cdot {R}_{i}^{CellTypeA : CD 124} - {k}_{re}^{CD 124 : IL 13 : CD 213} \cdot {C}_{i}^{CellTypeA : IL 13 : CD 124 : CD 213} [ t ] {k}_{fe}^{CD 213 IL 13 : CD 124} \cdot {C}_{i}^{CellTypeA : IL 13 : CD 124} [ t ] \cdot {R}_{i}^{CellTypeA : CD 213} - {k}_{re}^{CD 213 : IL 13 : CD 124} \cdot {C}_{i}^{CellTypeA : IL 13 : CD 124 : CD 213} [ t ] \qquad 38$$

$$\frac{d {C}_{S}^{CellTypeA : IL 4 : CD 124 : CD 213}}{d t} = {k}_{f}^{IL 4 : CD 124 : CD 213} \cdot {R}_{S}^{CellTypeA : CD 124 : CD 213} [ t ] \cdot {L}^{IL 4} - {k}_{r}^{IL 4 : CD 124 : CD 213} \cdot {C}_{S}^{CellTypeA : IL 4 : CD 124 : CD 213} [ t ] - {k}_{e}^{CellTypeA : IL 4 : CD 124 : CD 213} \cdot {C}_{S}^{CellTypeA : IL 4 : CD 124 : CD 213} [ t ] + {k}_{f}^{CD 213 : IL 4 : CD 124} \cdot {C}_{S}^{CellTypeA : IL 4 : CD 124} [ t ] \cdot {R}_{S}^{CellTypeA : CD 213} - {k}_{r}^{CD 213 : IL 4 : CD 124} \cdot {C}_{S}^{CellTypeA : IL 4 : CD 124 : CD 213} [ t ] + {k}_{f}^{CD 124 : IL 4 : CD 213} \cdot {C}_{S}^{CellTypeA : IL 4 : CD 213} [ t ] \cdot {R}_{S}^{CellTypeA : CD 124} - {k}_{r}^{CD 124 : IL 4 : CD 213} \cdot {C}_{S}^{CellTypeA : IL 4 : CD 124 : CD 213} [ t ] \qquad 39$$

$$\frac{d {C}_{i}^{CellTypeA : IL 4 : CD 124 : CD 213}}{d t} = {k}_{fe}^{IL 4 : CD 124 : CD 213} \cdot {R}_{i}^{CellTypeA : CD 124 : CD 213} [ t ] \cdot {L}_{i}^{CellTypeA : IL 4} - {k}_{re}^{IL 4 : CD 124 : CD 213} \cdot {C}_{i}^{CellTypeA : IL 4 : CD 124 : CD 213} [ t ] + {k}_{e}^{CellTypeA : IL 4 : CD 124 : CD 213} \cdot {C}_{S}^{CellTypeA : IL 4 : CD 124 : CD 213} [ t ] - {k}_{h}^{CellTypeA : IL 4 : CD 124 : CD 213} \cdot {C}_{i}^{CellTypeA : IL 4 : CD 124 : CD 213} [ t ] + {k}_{fe}^{CD 213 : IL 4 : CD 124} \cdot {C}_{i}^{CellTypeA : IL 4 : CD 124} [ t ] \cdot {R}_{i}^{CellTypeA : CD 213} - {k}_{re}^{CD 213 : IL 4 : CD 124} \cdot {C}_{i}^{CellTypeA : IL 4 : CD 124 : CD 213} [ t ] + {k}_{fe}^{CD 124 : IL 4 : CD 213} \cdot {C}_{i}^{CellTypeA : IL 4 : CD 213} [ t ] \cdot {R}_{i}^{CellTypeA : CD 124} - {k}_{re}^{CD 124 : IL 4 : CD 213} \cdot {C}_{i}^{CellTypeA : IL 4 : CD 124 : CD 213} [ t ] \qquad 40$$

$$\frac{d {C}_{S}^{CellTypeA : IL 4 : CD 124 : CD 132}}{d t} = {k}_{f}^{IL 4 : CD 124 : CD 132} \cdot {R}_{S}^{CellTypeA : CD 124 : CD 132} [ t ] \cdot {L}^{IL 4} - {k}_{r}^{IL 4 : CD 124 : CD 132} \cdot {C}_{S}^{CellTypeA : IL 4 : CD 124 : CD 132} [ t ] - {k}_{e}^{CellTypeA : IL 4 : CD 124 : CD 132} \cdot {C}_{S}^{CellTypeA : IL 4 : CD 124 : CD 132} [ t ] {k}_{f}^{CD 132 : IL 4 : CD 124} \cdot {C}_{S}^{CellTypeA : IL 4 : CD 124} [ t ] \cdot {R}_{S}^{CellTypeA : CD 132} - {k}_{r}^{CD 132 : IL 4 : CD 124} \cdot {C}_{S}^{CellTypeA : IL 4 : CD 124 : CD 132} [ t ] \qquad 41$$

$$\frac{d {C}_{i}^{CellTypeA : IL 4 : CD 124 : CD 132}}{d t} = {k}_{fe}^{IL 4 : CD 124 : CD 132} \cdot {R}_{i}^{CellTypeA : CD 124 : CD 132} [ t ] \cdot {L}_{i}^{CellTypeA : IL 4} - {k}_{re}^{IL 4 : CD 124 : CD 132} \cdot {C}_{i}^{CellTypeA : IL 4 : CD 124 : CD 132} [ t ] + {k}_{e}^{CellTypeA : IL 4 : CD 124 : CD 132} \cdot {C}_{S}^{CellTypeA : IL 4 : CD 124 : CD 132} [ t ] - {k}_{h}^{CellTypeA : IL 4 : CD 124 : CD 132} \cdot {C}_{i}^{CellTypeA : IL 4 : CD 124 : CD 132} [ t ] {k}_{fe}^{CD 132 : IL 4 : CD 124} \cdot {C}_{i}^{CellTypeA : IL 4 : CD 124} [ t ] \cdot {R}_{i}^{CellTypeA : CD 132} - {k}_{re}^{CD 132 : IL 4 : CD 124} \cdot {C}_{i}^{CellTypeA : IL 4 : CD 124 : CD 132} [ t ] \qquad 42$$

$$\frac{d {C}_{S}^{CellTypeA : TSLP : CD 127 : TSLPR}}{d t} = {k}_{f}^{TSLP : CD 127 : TSLPR} \cdot {R}_{S}^{CellTypeA : CD 127 : TSLPR} [ t ] \cdot {L}^{TSLP} - {k}_{r}^{TSLP : CD 127 : TSLPR} \cdot {C}_{S}^{CellTypeA : TSLP : CD 127 : TSLPR} [ t ] - {k}_{e}^{CellTypeA : TSLP : CD 127 : TSLPR} \cdot {C}_{S}^{CellTypeA : TSLP : CD 127 : TSLPR} [ t ] {k}_{f}^{CD 127 : TSLP : TSLPR} \cdot {C}_{S}^{CellTypeA : TSLP : TSLPR} [ t ] \cdot {R}_{S}^{CellTypeA : CD 127} - {k}_{r}^{D 127 : TSLP : TSLPR} \cdot {C}_{S}^{CellTypeA : TSLP : CD 127 : TSLPR} [ t ] \qquad 43$$

$$\frac{d {C}_{i}^{CellTypeA : TSLP : D 127 : TSLPR}}{d t} = {k}_{fe}^{TSLP : CD 127 : TSLPR} \cdot {R}_{i}^{CellTypeA : CD 127 : TSLPR} [ t ] \cdot {L}_{i}^{CellTypeA : TSLP} - {k}_{re}^{TSLP : CD 127 : TSLPR} \cdot {C}_{i}^{CellTypeA : TSLP : CD 127 : TSLPR} [ t ] + {k}_{e}^{CellTypeA : TSLP : CD 127 : TSLPR} \cdot {C}_{S}^{CellTypeA : TSLP : CD 127 : TSLPR} [ t ] - {k}_{h}^{CellTypeA : TSLP : CD 127 : TSLPR} \cdot {C}_{i}^{CellTypeA : TSLP : CD 127 : TSLPR} [ t ] {k}_{fe}^{CD 127 : TSLP : TSLPR} \cdot {C}_{i}^{CellTypeA : TSLP : TSLPR} [ t ] \cdot {R}_{i}^{CellTypeA : CD 127} - {k}_{re}^{CD 127 : TSLP : TSLPR} \cdot {C}_{i}^{CellTypeA : TSLP : CD 127 : TSLPR} [ t ] \qquad 44$$

$$\frac{d {C}_{S}^{CellTypeA : IL 7 : CD 127 : CD 132}}{d t} = {k}_{f}^{IL 7 : CD 127 : CD 132} \cdot {R}_{S}^{CellTypeA : CD 127 : CD 132} [ t ] \cdot {L}^{IL 7} - {k}_{r}^{IL 7 : CD 127 : CD 132} \cdot {C}_{S}^{CellTypeA : IL 7 : CD 127 : CD 132} [ t ] - {k}_{e}^{CellTypeA : IL 7 : CD 127 : CD 132} \cdot {C}_{S}^{CellTypeA : IL 7 : CD 127 : CD 132} [ t ] {k}_{f}^{CD 132 : IL 7 : CD 127} \cdot {C}_{S}^{CellTypeA : IL 7 : CD 127} [ t ] \cdot {R}_{S}^{CellTypeA : CD 132} - {k}_{r}^{CD 132 : IL 7 : CD 127} \cdot {C}_{S}^{CellTypeA : IL 7 : CD 127 : CD 132} [ t ] \qquad 45$$

$$\frac{d {C}_{i}^{CellTypeA : IL 7 : CD 127 : CD 132}}{d t} = {k}_{fe}^{IL 7 : CD 127 : CD 132} \cdot {R}_{i}^{CellTypeA : CD 127 : CD 132} [ t ] \cdot {L}_{i}^{CellTypeA : IL 7} - {k}_{re}^{IL 7 : CD 127 : CD 132} \cdot {C}_{i}^{CellTypeA : IL 7 : CD 127 : CD 132} [ t ] + {k}_{e}^{CellTypeA : IL 7 : CD 127 : CD 132} \cdot {C}_{S}^{CellTypeA : IL 7 : CD 127 : CD 132} [ t ] - {k}_{h}^{CellTypeA : IL 7 : CD 127 : CD 132} \cdot {C}_{i}^{CellTypeA : IL 7 : CD 127 : CD 132} [ t ] {k}_{fe}^{CD 132 : IL 7 : CD : 127} \cdot {C}_{i}^{CellTypeA : IL 7 : CD 127} [ t ] \cdot {R}_{i}^{CellTypeA : CD 132} - {k}_{re}^{CD 132 : IL 7 : CD 127} \cdot {C}_{i}^{CellTypeA : IL 7 : CD 127 : CD 132} [ t ] \qquad 46$$

$$\frac{d {C}_{S}^{CellTypeA : IL 2 : CD 122 : CD 132}}{d t} = {k}_{f}^{IL 2 : CD 122 : CD 132} \cdot {R}_{S}^{CellTypeA : CD 122 : CD 132} [ t ] \cdot {L}^{IL 2} - {k}_{r}^{IL 2 : CD 122 : CD 132} \cdot {C}_{S}^{CellTypeA : IL 2 : CD 122 : CD 132} [ t ] - {k}_{e}^{CellTypeA : IL 2 : CD 122 : CD 132} \cdot {C}_{S}^{CellTypeA : IL 2 : CD 122 : CD 132} [ t ] {k}_{f}^{CD 132 : IL 2 : CD 122} \cdot {C}_{S}^{CellTypeA : IL 2 : CD 122} [ t ] \cdot {R}_{S}^{CellTypeA : CD 132} - {k}_{r}^{CD 132 : IL 2 : CD 122} \cdot {C}_{S}^{CellTypeA : IL 2 : CD 122 : CD 132} [ t ] - {k}_{f}^{CD 25 : IL 2 : CD 122 : CD 132} \cdot {C}_{S}^{CellTypeA : IL 2 : CD 122 : CD 132} [ t ] \cdot {R}_{S}^{CellTypeA : CD 25} + {k}_{r}^{CD 25 : IL 2 : CD 122 : CD 132} \cdot {C}_{S}^{CellTypeA : IL 2 : CD 25 : CD 122 : CD 132} [ t ] \qquad 47$$

$$\frac{d {C}_{i}^{CellTypeA : IL 2 : CD 122 : CD 132}}{d t} = {k}_{fe}^{IL 2 : CD 122 : CD 132} \cdot {R}_{i}^{CellTypeA : CD 122 : CD 132} [ t ] \cdot {L}_{i}^{CellTypeA : IL 2} - {k}_{re}^{IL 2 : CD 122 : CD 132} \cdot {C}_{i}^{CellType : IL 2 : CD 122 : CD 132} [ t ] + {k}_{e}^{CellTypeA : IL 2 : CD 122 : CD 132} \cdot {C}_{S}^{CellTypeA : IL 2 : CD 122 : CD 132} [ t ] - {k}_{h}^{CellTypeA : IL 2 : CD 122 : CD 132} \cdot {C}_{i}^{CellTypeA : IL 2 : CD 122 : CD 132} [ t ] {k}_{fe}^{CD 132 : IL 2 : CD 122} \cdot {C}_{i}^{CellTypeA : IL 2 : CD 122} [ t ] \cdot {R}_{i}^{CellTypeA : CD 132} - {k}_{re}^{CD 132 : IL 2 : CD 122} \cdot {C}_{i}^{CellTypeA : IL 2 : CD 122 : CD 132} [ t ] - {k}_{fe}^{CD 25 : IL 2 : CD 122 : CD 132} \cdot {C}_{i}^{CellTypeA : IL 2 : CD 122 : CD 132} [ t ] \cdot {R}_{i}^{CellTypeA : CD 25} + {k}_{re}^{CD 25 : IL 2 : CD 122 : CD 132} \cdot {C}_{i}^{CellTypeA : IL 2 : CD 25 : CD 122 : CD 132} [ t ] \qquad 48$$

$$\frac{d {R}_{S}^{CellTypeA : IL 15 R : CD 122 : CD 132}}{d t} = {k}_{f}^{IL 15 R : CD 122 : CD 132} \cdot {R}_{S}^{CellTypeA : CD 122 : CD 132} [ t ] \cdot {R}_{S}^{CellTypeA : IL 15 R} - {k}_{r}^{IL 15 : CD 122 : CD 132} \cdot {R}_{S}^{CellTypeA : IL 15 R : CD 122 : CD 132} [ t ] - {k}_{f}^{IL 15 : IL 15 R : CD 122 : CD 132} \cdot {R}_{S}^{CellTypeA : IL 15 R : CD 122 : CD 132} [ t ] \cdot {L}^{IL 15} + {k}_{r}^{IL 15 : IL 15 R : CD 122 : CD 132} \cdot {C}_{S}^{CellTypeA : IL 15 : IL 15 R : CD 122 : CD 132} [ t ] - {k}_{t}^{CellTypeA : IL 15 R : CD 122 : CD 132} \cdot {R}^{CellTypeA : IL 15 R : CD 122 : CD 132} [ t ] + {k}_{f}^{CD 132 : IL 15 R : CD 122} [ t ] \cdot {R}_{S}^{CellTypeA : IL 15 R : CD 122} [ t ] \cdot {R}_{S}^{CellTypeA : CD 132} [ t ] - {k}_{r}^{CD 132 : IL 15 R : CD 122} [ t ] \cdot {R}_{S}^{CellTypeA : IL 15 R : CD 122 : CD 132} [ t ] \qquad 49$$

$$\frac{d {R}_{i}^{CellTypeA : IL 15 R : CD122 : CD 132}}{d t} = {k}_{fe}^{IL 15 R : CD 122 : CD 132} \cdot {R}_{i}^{CellTypeA : CD 122 : CD 132} [ t ] \cdot {R}_{i}^{CellTypeA : IL 15 R} - {k}_{re}^{IL 15 R : CD 122 : CD 132} \cdot {R}_{i}^{CellTypeA : IL 15 R : CD 122 : CD 132} [ t ] - {k}_{fe}^{IL 15 : IL 15 R : CD 122 : CD 132} \cdot {R}_{i}^{CellTypeA : IL 15 R : CD 122 : CD 132} [ t ] \cdot {L}_{i}^{CellTypeA : IL 15} + {k}_{re}^{IL 15 : IL 15 R : CD 122 : CD 132} \cdot {C}_{i}^{CellTypeA : IL 15 : IL 15 R : CD 122 : CD 132} [ t ] + {k}_{t}^{CellTypeA : IL 15 R : CD 122 : CD 132} \cdot {R}_{S}^{CellTypeA : IL 15 R : CD 122 : CD 132} [ t ] - {k}_{h}^{CellTypeA : IL 15 R : CD 122 : CD 132} \cdot {R}_{i}^{CellTypeA : IL 15 R : CD 122 : CD 132} [ t ] + {k}_{fe}^{CD 132 : IL 15 R : CD 122} [ t ] \cdot {R}_{i}^{CellTypeA : IL 15 R : CD 122} [ t ] \cdot {R}_{i}^{CellTypeA : CD 132} [ t ] - {k}_{re}^{CD 132 : IL 15 R : CD 122} [ t ] \cdot {R}_{i}^{CellTypeA : IL 15 R : CD 122 : CD 132} [ t ] \qquad 50$$

$$\begin{matrix}\frac{d {R}_{S}^{CellTypeA : IL 15 R}}{d t} = - {k}_{f}^{IL 15 R : CD 122 : CD 132} \cdot {R}_{S}^{CellTypeA : CD 122 : CD 132} [ t ] \cdot {R}_{S}^{CellTypeA : IL 15 R} + {k}_{r}^{IL 15 R : CD 122 : CD 132} \cdot {R}_{S}^{CellTypeA : IL 15 R : CD 122 : CD 132} [ t ] - {k}_{t}^{CellTypeA : IL 15 R} \cdot {R}_{S}^{CellTypeA : IL 15 R} [ t ] + {V}_{S}^{CellTypeA : IL 15 R} + ( {k}_{syn}^{IL 15 R : IL 2 : CD 25} \cdot {C}_{S}^{CellTypeA : IL 2 : CD 25 : CD 122 : CD 132} + {k}_{syn}^{IL 15 R : IL 2 : CD 122} \cdot {C}_{S}^{CellTypeA : IL 2 : CD 122 : CD 132} + {k}_{syn}^{IL 15 R : IL 4 : CD 213} \cdot {C}_{S}^{CellTypeA : IL 4 : CD 124 : CD 213} + {k}_{syn}^{IL 15 R : IL 4 : CD 132} \cdot {C}_{S}^{CellTypeA : IL 4 : CD 124 : CD 132} + {k}_{syn}^{IL 15 R : IL 7} \cdot {C}_{S}^{CellTypeA : IL 7 : CD 127 : CD 132} + {k}_{syn}^{IL 15 R : IL 9} \cdot {C}_{S}^{CellTypeA : IL 9 : CD 129 : CD 132} + {k}_{syn}^{IL 15 R : IL 13} \cdot {C}_{S}^{CellTypeA : IL 13 : CD 124 : CD 213} + {k}_{syn}^{IL 15 R : IL 15} \cdot {C}_{S}^{CellTypeA : IL 15 : IL 15 R : CD 122 : CD 132} + {k}_{syn}^{IL 15 R : TSLP} \cdot {C}_{S}^{CellTypeA : TSLP : CD 127 : TSLPR} + {k}_{syn}^{IL 15 R : IL 21} \cdot {C}_{S}^{CellTypeA : IL 21 : IL 21 R : CD 132} ) - {k}_{f}^{IL 15 : IL 15 R} \cdot {R}_{S}^{CellTypeA : IL 15 R} [ t ] \cdot {L}^{IL 15} + {k}_{r}^{IL 15 : IL 15 R} \cdot {C}_{S}^{CellTypeA : IL 15 : IL 15 R} [ t ] & 51\end{matrix}$$

$$\begin{matrix}\frac{d {R}_{i}^{CellTypeA : IL 15 R}}{d t} = - {k}_{fe}^{IL 15 R : CD 122 : CD 132} \cdot {R}_{i}^{CellTypeA : CD 122 : CD 132} [ t ] \cdot {R}_{i}^{CellTypeA : IL 15 R} + {k}_{re}^{IL 15 R : CD 122 : CD 132} \cdot {R}_{i}^{CellTypeA : IL 15 R : CD 122 : CD 132} [ t ] + {k}_{t}^{CellTypeA : IL 15 R} \cdot {R}_{S}^{CellType A : IL 15 R} [ t ] - {k}_{h}^{CellTypeA : IL 15 R} \cdot {R}_{i}^{CellTypeA : IL 15 R} [ t ] - {k}_{fe}^{IL 15 : IL 15 R} \cdot {R}_{i}^{CellTypeA : IL 15 R} [ t ] \cdot {L}_{i}^{CellTypeA : IL 15} + {k}_{re}^{IL 15 : IL 15 R} \cdot {C}_{i}^{CellTypeA : IL 15 : IL 15 R} [ t ] & 52\end{matrix}$$

$$\begin{matrix}\frac{d {R}_{S}^{CellTypeA : CD 25}}{d t} = - {k}_{f}^{CD 25 : CD 122 : CD 132} \cdot {R}_{S}^{CellTypeA : CD 122 : CD 132} [ t ] \cdot {R}_{S}^{CellTypeA : CD 25} + {k}_{r}^{CD 25 : CD 122 : CD 132} \cdot {R}_{S}^{CellTypeA : CD 25 : CD 122 : CD 132} [ t ] - {k}_{t}^{CellTypeA : CD 25} \cdot {R}_{S}^{CellTypeA : CD 25} [ t ] + {V}_{S}^{CellTypeA : CD 25} + ( {k}_{syn}^{CD 25 IL 2 : CD 25} \cdot {C}_{S}^{CellTypeA : IL 2 : CD 25 : CD 122 : CD 132} + {k}_{syn}^{CD 25 : IL 2 : CD 122} \cdot {C}_{S}^{CellTypeA : IL 2 : CD 122 : CD 132} + {k}_{syn}^{CD 25 : IL 4 : CD 213} \cdot {C}_{S}^{CellTypeA : IL 4 : CD 124 : CD 213} + {k}_{syn}^{CD 25 : IL 4 : CD 132} \cdot {C}_{S}^{CellTypeA : IL 4 : CD 124 : CD 132} + {k}_{syn}^{CD 25 : IL 7} \cdot {C}_{S}^{CellTypeA : IL 7 : CD 127 : CD 132} + {k}_{syn}^{CD 25 : IL 9} \cdot {C}_{S}^{CellTypeA : IL 9 : CD 129 : CD 132} + {k}_{syn}^{CD 25 : IL 13} \cdot {C}_{S}^{CellTypeA : IL 13 : CD 124 : CD 213} + {k}_{syn}^{CD 25 : IL 15} \cdot {C}_{S}^{CellTypeA : IL 15 : IL 15 R : CD 122 : CD 132} + {k}_{syn}^{CD 25 : TSLP} \cdot {C}_{S}^{CellTypeA : TSLP : CD 127 : TSLPR} + {k}_{syn}^{CD 25 : IL 21} \cdot {C}_{S}^{CellTypeA : IL 21 : IL 21 R : CD 132 } ) - {k}_{f}^{IL 2 : CD 25} \cdot {L}^{IL 2} [ t ] \cdot {R}_{S}^{CellTypeA : CD 25} + {k}_{r}^{IL 2 : CD 25} \cdot {C}_{S}^{CellTypeA : IL 2 : CD 25} [ t ] - {k}_{f}^{CD 25 : CD 122} \cdot {R}_{S}^{CellTypeA : CD 122} [ t ] \cdot {R}_{S}^{CellTypeA : CD 25} + {k}_{r}^{CD 25 : CD 122} \cdot {R}_{S}^{CellTypeA : CD 25 : CD 122} [ t ] - {k}_{f}^{CD 25 : IL 2 : CD 122 : CD 132} \cdot {C}_{S}^{CellTypeA : IL 2 : CD 122 : CD 132} [ t ] \cdot {R}_{S}^{CellTypeA : CD 25} + {k}_{r}^{CD 25 : IL 2 : CD 122 : CD 132} \cdot {C}_{S}^{CellTypeA : CD 25 : IL 2 : CD 122 : CD 132} [ t ] & 53\end{matrix}$$

$$\begin{matrix}\frac{d {R}_{i}^{CellTypeA : CD 25}}{d t} = - {k}_{fe}^{CD : 25 : CD 122 : CD 132} \cdot {R}_{i}^{CellTypeA : CD 122 : CD 132} [ t ] \cdot {R}_{i}^{CellTypeA : CD 25} + {k}_{re}^{CD 25 : CD 122 : CD 132} \cdot {R}_{i}^{CellTypeA : CD 25 : CD 122 : CD 132} [ t ] + {k}_{t}^{CellTypeA : CD 25} \cdot {R}_{S}^{CellTypeA : CD 25} [ t ] - {k}_{h}^{CellTypeA : CD 25} \cdot {R}_{i}^{CellTypeA : CD 25} [ t ] - {k}_{fe}^{IL 2 : CD 25} \cdot {L}_{i}^{CellTypeA : IL 2} [ t ] \cdot {R}_{i}^{CellTypeA : CD 25} + {k}_{re}^{IL 2 : CD 25} \cdot {C}_{i}^{CellTypeA : IL 2 : CD 25} [ t ] - {k}_{fe}^{CD 25 : CD 122} \cdot {R}_{i}^{CellTypeA : CD 122} [ t ] \cdot {R}_{i}^{CellTypeA : CD 25} + {k}_{re}^{CD 25 : CD 122} \cdot {R}_{i}^{CellTypeA : CD 25 : CD 122} [ t ] - {k}_{fe}^{CD 25 : IL 2 : CD 122 : CD 132} \cdot {C}_{i}^{CellTypeA : IL 2 : CD 122 : CD 132} [ t ] \cdot {R}_{i}^{CellTypeA : CD 25} + {k}_{re}^{CD 25 : IL 2 : CD 122 : CD 132} \cdot {C}_{i}^{CellTypeA : CD 25 : IL 2 : CD 122 : CD 132} [ t ] & 54\end{matrix}$$

$$\begin{matrix}\frac{d {R}_{S}^{CellTypeA : CD 25 : CD 122 : CD 132}}{d t} = {k}_{f}^{CD 25 : CD 122 : CD 132} \cdot {R}_{S}^{CellTypeA : CD 122 : CD 132} [ t ] \cdot {R}_{S}^{CellTypeA : CD 25} - {k}_{r}^{CD 25 : CD 122 : CD 132} \cdot {R}_{S}^{CellTypeA : CD 25 : CD 122 : CD 132} [ t ] - {k}_{f}^{IL 2 : CD 25 : CD 122 : CD 132} \cdot {R}_{S}^{CellTypeA : CD 25 : CD 122 : CD 132} [ t ] \cdot {L}^{IL 2} + {k}_{r}^{IL 2 : CD 25 : CD 122 : CD 132} \cdot {C}_{S}^{CellTypeA : IL 2 : CD 25 : CD 122 : CD 132} [ t ] - {k}_{t}^{CellTypeA : CD 25 : CD 122 : CD 132} \cdot {R}_{S}^{CellTypeA : CD 25 : CD 122 : CD 132} [ t ] + {k}_{f}^{CD 132 : CD 25 : CD 122} \cdot {R}_{S}^{CellTypeA : CD 25 : CD 122} [ t ] \cdot {R}_{S}^{CellTypeA : CD 132} - {k}_{r}^{CD 132 : CD 25 : CD 122} \cdot {R}_{S}^{CellTypeA : CD 25 : CD 122 : CD 132} [ t ] & 55\end{matrix}$$

$$\begin{matrix}\frac{d {R}_{i}^{CellTypeA : CD 25 : CD 122 : CD 132}}{d t} = {k}_{fe}^{CD 25 : CD 122 : CD 132} \cdot {R}_{i}^{CellTypeA : CD 122 : CD 132} [ t ] \cdot {R}_{i}^{CellTypeA : CD 25} - {k}_{re}^{CD 25 : CD 122 : CD 132} \cdot {R}_{i}^{CellTypeA : CD 25 : CD 122 : CD 132} [ t ] - {k}_{fe}^{IL 2 : CD 25 : CD 122 : CD 132} \cdot {R}_{i}^{CellTypeA : CD 25 : CD 122 : CD 132} [ t ] \cdot {L}_{i}^{CellTypeA : IL 2} + {k}_{re}^{IL 2 : CD 25 : CD 122 : CD 132} \cdot {C}_{i}^{CellTypeA : IL 2 : CD 25 : CD 122 : CD 132} [ t ] + {k}_{t}^{CellTypeA : CD 25 : CD 122 : CD 132} \cdot {R}_{S}^{CellTypeA : CD 25 : CD 122 : CD 132} [ t ] - {k}_{h}^{CellTypeA : CD 25 : CD 122 : CD 132} \cdot {R}_{i}^{CellTypeA : CD 25 : CD 122 : CD 132} [ t ] + {k}_{fe}^{CD 132 : CD 25 : CD 122} \cdot {R}_{i}^{CellTypeA : CD 25 : CD 122} [ t ] \cdot {R}_{i}^{CellTypeA : CD 132} - {k}_{re}^{CD 132 : CD 25 : CD 122} \cdot {R}_{i}^{CellTypeA : CD 25 : CD 122 : CD 132} [ t ] & 56\end{matrix}$$

$$\begin{matrix}\frac{d {C}_{S}^{CellTypeA : IL 15 R : CD 122 : CD 132}}{d t} = {k}_{f}^{IL 15 : IL 15 R : CD 122 : CD 132} \cdot {R}_{S}^{CellTypeA : IL 15 R : CD 122 : CD 132} [ t ] \cdot {L}^{IL 15} - {k}_{r}^{IL 15 : IL 15 R : CD 122 : CD 132} \cdot {C}_{S}^{CellTypeA : IL 15 : IL 15 R : CD 122 : CD 132} [ t ] - {k}_{e}^{CellTypeA : IL 15 : IL 15 R : CD 122 : CD 132} \cdot {C}_{S}^{CellTypeA : IL 15 : IL 15 R : CD 122 : CD 132} [ t ] + {k}_{f}^{CD 122 : CD 132 : IL 15 : IL 15 R} \cdot {R}_{S}^{CellTypeA : IL 15 : IL 15 R} [ t ] \cdot {R}_{S}^{CellTypeA : CD 122 : CD 132} - {k}_{r}^{CD 122 : CD 132 : IL 15 : IL 15 R} \cdot {C}_{S}^{CellTypeA : IL 15 : IL 15 R : CD 122 : CD 132} [ t ] & 57\end{matrix}$$

$$\begin{matrix}\frac{d {C}_{i}^{CellTypeA : IL 15 : IL 15 R : CD 122 : CD 132}}{d t} = {k}_{fe}^{IL 15 : IL 15 R : CD 122 : CD 132} \cdot {R}_{i}^{CellTypeA : IL 15 R : CD 122 : CD 132} [ t ] \cdot {L}_{i}^{CellTypeA : IL 15} - {k}_{re}^{IL 15 : IL 15 R : CD 122 : CD 132} \cdot {C}_{i}^{CellTypeA : IL 15 : IL 15 R : CD 122 : CD 132} [ t ] + {k}_{e}^{CellTypeA : IL 15 : IL 15 R : CD 122 : CD 132} \cdot {C}_{S}^{CellTypeA : IL 15 : IL 15 R : CD 122 : CD 132} [ t ] - {k}_{h}^{CellTypeA : IL 15 : IL 15 R : CD 122 : CD 132} \cdot {C}_{i}^{CellTypeA : IL 15 : IL 15 R : CD 122 : CD 132} [ t ] + {k}_{fe}^{CD 122 : CD 132 : IL 15 : IL 15 R} \cdot {R}_{i}^{CellTypeA : IL 15 : IL 15 R} [ t ] \cdot {R}_{i}^{CellTypeA : CD 122 : CD 132} - {k}_{re}^{CD 122 : CD 132 : IL 15 : IL 15 R} \cdot {C}_{i}^{CellTypeA : IL 15 : IL 15 R : CD 122 : CD 132} [ t ] & 58\end{matrix}$$

$$\begin{matrix}\frac{d {C}_{S}^{CellTypeA : IL 2 : CD 25 : CD 122 : CD 132}}{d t} = {k}_{f}^{IL 2 : CD 25 : CD 122 : CD 132} \cdot {R}_{S}^{CellTypeA : CD 25 : CD 122 : CD 132} [ t ] \cdot {L}^{IL 2} - {k}_{r}^{IL 2 : CD 25 : CD 122 : CD 132} \cdot {C}_{S}^{CellTypeA : IL 2 : CD 25 : CD 122 : CD 132} [ t ] - {k}_{e}^{CellTypeA : IL 2 : CD 25 : CD 122 : CD 132} \cdot {C}_{S}^{CellTypeA : IL 2 : CD 25 : CD 122 : CD 132} [ t ] + {k}_{f}^{CD 25 : IL 2 : CD 122 : CD 132} \cdot {C}_{S}^{CellTypeA : IL 2 : CD 122 : CD 132} [ t ] \cdot {R}_{S}^{CellTypeA : CD 25} - {k}_{r}^{CD 25 : IL 2 : CD 122 : CD 132} \cdot {C}_{S}^{CellTypeA : IL 2 : CD 25 : CD 122 : CD 132} [ t ] + {k}_{f}^{CD 132 : IL 2 : CD 25 : CD 122} \cdot {C}_{S}^{CellTypeA : IL 2 : CD 25 : CD 122} [ t ] \cdot {R}_{S}^{CellTypeA : CD 132} - {k}_{r}^{CD 132 : IL 2 : CD 25 : CD 122} \cdot {C}_{S}^{CellTypeA : IL 2 : CD 25 : CD 122 : CD 132} [ t ] & 59\end{matrix}$$

$$\begin{matrix}\frac{d {C}_{i}^{CellTypeA : IL 2 : CD 25 : CD 122 : CD 132}}{d t} = {k}_{fe}^{IL 2 : CD 25 : CD 122 : CD 132} \cdot {R}_{i}^{CellTypeA : CD 25 : CD 122 : CD 132} [ t ] \cdot {L}_{i}^{CellTypeA : IL 2} - {k}_{re}^{IL 2 : CD 25 : CD 122 : CD 132} \cdot {C}_{i}^{CellTypeA : IL 2 : CD 25 : CD 122 : CD 132} [ t ] + {k}_{e}^{CellTypeA : IL 2 : CD 25 : CD 122 : CD 132} \cdot {C}_{S}^{CellTypeA : IL 2 : CD 25 : CD 122 : CD 132} [ t ] - {k}_{h}^{CellTypeA : IL 2 : CD 25 : CD 122 : CD 132} \cdot {C}_{i}^{CellTypeA : IL 2 : CD 25 : CD 122 : CD 132} [ t ] + {k}_{fe}^{CD 25 : IL 2 : CD 122 : CD 132} \cdot {C}_{i}^{CellTypeA : IL 2 : CD 122 : CD 132} [ t ] \cdot {R}_{i}^{CellTypeA : CD 25} - {k}_{re}^{CD 25 : IL 2 : CD 122 : CD 132} \cdot {C}_{i}^{CellTypeA : IL 2 : CD 25 : CD 122 : CD 132} [ t ] + {k}_{fe}^{CD 132 : IL 2 : CD 25 : CD 122} \cdot {C}^{CellTypeA : IL 2 : CD 25 : CD 122} [ t ] \cdot {R}_{i}^{CellTypeA : CD 132} - {k}_{re}^{CD 132 : IL 2 : CD 25 : CD 122} \cdot {C}_{i}^{CellTypeA : IL 2 : CD 25 : CD 122 : CD 132} [ t ] & 60\end{matrix}$$

$$\begin{matrix}\frac{d {L}^{IL 15}}{d t} = ( - {k}_{f}^{IL 15 : IL 15 R : CD 122 : CD 132} \cdot {R}_{S}^{CellTypeA : IL 15 R : CD 122 : CD 132} [ t ] \cdot {L}^{IL 15} + {k}_{r}^{IL 15 : IL 15 R : CD 122 : CD 132} \cdot {C}_{S}^{CellTypeA : IL 15 : IL 15 R : CD 122 : CD 132} [ t ] - {k}_{f}^{IL 15 : IL 15 R} \cdot {R}_{S}^{CellTypeA : IL 15 R} [ t ] \cdot {L}^{IL 15} + {k}_{r}^{IL 15 : IL 15 R} \cdot {C}_{S}^{CellTypeA : IL 15 : IL 15 R} [ t ] + {k}_{x}^{CellTypeA : IL 15} \cdot {L}_{i}^{CellTypeA : IL 15} \cdot {V}_{e} \cdot {N}_{A} ) \cdot \frac{{Y}^{CellTypeA} [ t ]}{{N}_{A}} + ( repeat\_above \_for \_additional \_cell \_types ) & 61\end{matrix}$$

$$\begin{matrix}\frac{d {L}_{i}^{CellTypeA : IL 15}}{d t} = ( - {k}_{fe}^{IL 15 : IL 15 R : CD 122 : CD 132} \cdot {R}_{i}^{CellTypeA : IL 15 R : CD 122 : CD 132} [ t ] \cdot {L}_{i}^{CellTypeA : IL 15} + {k}_{re}^{IL 15 : IL 15 R : CD 122 : CD 132} \cdot {C}_{i}^{CellTypeA : IL 15 : IL 15 R : CD 122 : CD 132} [ t ] - {k}_{fe}^{IL 15 : IL 15 R} \cdot {R}_{i}^{CellTypeA : IL 15 R} [ t ] \cdot {L}_{i}^{CellTypeA : IL 15} + {k}_{re}^{IL 15 : IL 15 R} \cdot {C}_{i}^{CellTypeA : IL 15 : IL 15 R} [ t ] ) \cdot \frac{1}{{V}_{e} \cdot {N}_{A}} - {k}_{x}^{CellTypeA : IL 15} \cdot {L}_{i}^{CellTypeA : IL 15} & 62\end{matrix}$$

$$\begin{matrix}\frac{d {L}_{d}^{CellTypeA : IL 15}}{d t} = {k}_{h}^{IL 15 : IL 15 R : CD 122 : CD 132} \cdot {C}_{i}^{CellTypeA : IL 15 : IL 15 R : CD 122 : CD 132} [ t ] + {k}_{h}^{IL 15 : IL 15 R} \cdot {C}_{i}^{CellTypeA : IL 15 : IL 15 R} [ t ] & 63\end{matrix}$$

$$\begin{matrix}\frac{d {L}^{IL 7}}{d t} = ( - {k}_{f}^{IL 7 : CD 127 : CD 132} \cdot {R}_{S}^{CellTypeA : CD 127 : CD 132} [ t ] \cdot {L}^{IL 7} + {k}^{IL 7 : CD 127 : CD 132} \cdot {C}_{S}^{CellTypeA : IL 7 : CD 127 : CD 132} [ t ] - {k}_{f}^{IL 7 : CD 127} \cdot {R}_{S}^{CellTypeA : CD 127} [ t ] \cdot {L}^{IL 7} + {k}_{r}^{IL 7 : CD 127} \cdot {C}_{S}^{CellTypeA : IL 7 : CD 127} [ t ] + {k}_{x}^{CellTypeA : IL 7} \cdot {L}_{i}^{CellTypeA : IL 7} \cdot {V}_{e} \cdot {N}_{A} ) \cdot \frac{{Y}^{CellTypeA} [ t ]}{{N}_{A}} + ( repeat\_above \_for \_additional \_cell \_types ) & 64\end{matrix}$$

$$\begin{matrix}\frac{d {L}_{i}^{CellTypeA : IL 7}}{d t} = ( - {k}_{fe}^{IL 7 : CD 127 : CD 132} \cdot {R}_{i}^{CellTypeA : CD 127 : CD 132} [ t ] \cdot {L}_{i}^{CellTypeA : IL 7} + {k}_{re}^{IL 7 : CD 127 : CD 132} \cdot {C}_{i}^{CellTypeA : IL 7 : CD 127 : CD 132} [ t ] - {k}_{fe}^{IL 7 : CD 127} \cdot {R}_{i}^{CellTypeA : CD 127} [ t ] \cdot {L}_{i}^{CellTypeA : IL 7} + {k}_{re}^{IL 7 : CD 127} \cdot {C}_{i}^{CellTypeA : IL 7 : CD 127} [ t ] ) \cdot \frac{1}{{V}_{e} \cdot {N}_{A}} - {k}_{x}^{CellTypeA : IL 7} \cdot {L}_{i}^{CellTypeA : IL 7} & 65\end{matrix}$$

$$\begin{matrix}\frac{d {L}_{d}^{CellTypeA : IL 7}}{d t} = {k}_{h}^{IL 7 : CD 127 : C D 132} \cdot {C}^{CellTypeA : IL 7 : CD 127 : CD 132} [ t ] + {k}_{h}^{IL 7 : CD 127} \cdot {C}_{i}^{CellTypeA : IL 7 : CD 127} [ t ] & 66\end{matrix}$$

$$\begin{matrix}\frac{d {L}^{TSLP}}{d t} = ( \begin{matrix}- {k}_{f}^{TSLP : CD 127 : TSLPR} \cdot {R}_{S}^{CellTypeA : CD 127 : TSLPR} [ t ] \cdot {L}^{TSLP} + \\ {k}_{r}^{TSLP : CD 127 : TSLPR} \cdot {C}_{S}^{CellTypeA : TSLP : CD 127 : TSLPR} [ t ] - \\ {k}_{f}^{TSLP : TSLPR} \cdot {R}_{S}^{CellTypeA : TSLPR} [ t ] \cdot {L}^{TSLP} + \\ \begin{matrix}{k}_{r}^{TSLP : TSLPR} \cdot {C}_{S}^{CellTypeA : TSLP : TSLPR} [ t ] + {k}_{x}^{CellTypeA : TSLP} \cdot \\ {L}_{i}^{CellType : TSLP} \cdot {V}_{e} \cdot {N}_{A}\end{matrix}\end{matrix} ) \cdot \frac{{Y}^{CellTypeA} [ t ]}{{N}_{A}} + ( repeat\_above \_for \_additional \_cell \_types ) & 67\end{matrix}$$

$$\begin{matrix}\frac{d {L}_{i}^{CellTypeA : TSLP}}{d t} = ( \begin{matrix}- {k}_{fe}^{TSLP : CD 127 : TSLPR} \cdot {R}^{CellTypeA : CD 127 : TSLPR} [ t ] \cdot {L}_{i}^{CellTypeA : TSLP} + \\ {k}_{re}^{TSLP : CD 127 : TSLPR} \cdot {C}_{i}^{CellTypeA : TSLP : CD 127 : TSLPR} [ t ] - \\ {k}_{fe}^{TSLP : TSLPR} \cdot {R}_{i}^{CellTypeA : TSLPR} [ t ] \cdot {L}_{i}^{CellTypeA : TSLP} + \\ {k}_{re}^{TSLP : TSLPR} \cdot {C}_{i}^{CellTypeA : TSLP : TSLPR} [ t ]\end{matrix} ) \cdot \frac{1}{{V}_{e} \cdot {N}_{A}} - {k}_{x}^{CellTypeA : TSLP} \cdot {L}_{i}^{CellTypeA : TSLP} & 68\end{matrix}$$

$$\begin{matrix}\frac{d {L}_{d}^{CellTypeA : TSLP}}{d t} = {k}_{h}^{TSLP : CD 127 : TSLPR} \cdot {C}_{i}^{CellTypeA : TSLP : CD 127 : TSLPR} [ t ] + {k}_{h}^{TSLP : TSLPR} \cdot {C}_{i}^{CellTypeA : TSLP : TSLPR} [ t ] & 69\end{matrix}$$

$$\frac{d {L}^{IL 4}}{d t} = ( \begin{matrix}\begin{matrix}\begin{matrix}\begin{matrix}- {k}_{f}^{IL 4 : CD 124 : CD 132} \cdot {R}_{S}^{CellTypeA : CD 124 : CD 132} [ t ] \cdot {L}^{IL 4} + \\ {k}_{r}^{IL 4 : CD 124 : CD 132} \cdot {C}_{S}^{CellTypeA : IL 4 : CD 124 : CD 132} [ t ] -\end{matrix} \\ {k}_{f}^{IL 4 : CD 124 : CD 213} \cdot {R}_{S}^{CellTypeA : CD 214 : CD 213} [ t ] \cdot {L}^{IL 4} +\end{matrix} \\ {k}_{r}^{IL 4 : CD 124 : CD 132} \cdot {C}_{S}^{CellTypeA : IL 4 : CD 124 : CD 132} [ t ] -\end{matrix} \\ {k}_{f}^{IL 4 : CD 124} \cdot {R}_{S}^{CellTypeA : CD 124} [ t ] \cdot {L}^{IL 4} + {k}_{r}^{IL 4 : CD 124} \cdot \\ {C}_{S}^{CellTypeA : IL 4 : CD 124} [ t ] - \\ {k}_{f}^{IL 4 : CD 213} \cdot {R}_{S}^{CellTypeA : CD 213} [ t ] \cdot {L}^{IL 4} + {k}_{r}^{IL 4 : CD 213} \cdot \\ {C}_{S}^{CellTypeA : IL 4 : CD 213} [ t ] + {k}_{x}^{CellTypeA : IL 4} \cdot {L}_{x}^{CellTypeA : IL 4} \cdot \\ {V}_{e} \cdot {N}_{A}\end{matrix} ) \cdot \frac{{Y}^{CellTypeA} [ t ]}{{N}_{A}} \qquad 70$$

$$\frac{d {L}_{i}^{CellTypeA : IL 4}}{d t} = ( \begin{matrix}- {k}_{fe}^{IL 4 : CD 124 : CD 132} \cdot {R}_{i}^{CellTypeA : CD 124 : CD 132} [ t ] \cdot {L}_{i}^{CellTypeA : IL 4} + \\ {k}_{re}^{IL 4 : CD 124 : CD 132} \cdot {C}_{i}^{CellTypeA : IL 4 : CD 124 : CD 132} [ t ] - \\ {k}_{fe}^{IL 4 : CD 124 : CD 213} \cdot {R}_{i}^{CellTypeA : CD 124 : CD 213} [ t ] \cdot {L}_{i}^{CellTypeA : IL 4} + \\ {k}_{re}^{IL 4 : CD 124 : CD 213} \cdot {C}_{i}^{CellTypeA : IL 4 : CD 124 : CD 213} [ t ] - \\ {k}_{fe}^{IL 4 : CD 124} \cdot {R}_{i}^{CellTypeA : CD 124} [ t ] \cdot {L}_{i}^{CellTypeA : IL 4} + \\ {k}_{re}^{IL 4 : CD 124} \cdot {C}_{i}^{CellTypeA : IL 4 : CD 124} [ t ] - \\ {k}_{re}^{IL 4 : CD 213} \cdot {R}_{i}^{CellTypeA : IL 4 : CD 123} [ t ] + \\ {k}_{re}^{IL 4 : CD 213} \cdot {C}_{i}^{CellTypeA : IL 4 : CD 213} [ t ]\end{matrix} ) \cdot \frac{1}{{V}_{e} {N}_{A}} - {k}_{x}^{CellTypeA : IL 4} \cdot {L}_{i}^{CellTypeA : IL 4} \qquad 71$$

$$\begin{matrix}\frac{d {L}_{d}^{CellTypeA : IL 4}}{d t} = {k}_{h}^{IL 4 : CD 124 : CD 132} \cdot {C}_{i}^{CellTypeA : IL 4 : CD 124 : CD 132} [ t ] + {k}_{h}^{IL 4 : CD 124} \cdot {C}_{i}^{CellTypeA : IL 4 : CD 124} [ t ] + {k}_{h}^{IL 4 : CD 213} \cdot {C}_{i}^{CellTypeA : IL 4 : CD 213} [ t ] & 72\end{matrix}$$

$$\frac{d {L}^{IL 13}}{d t} = ( \begin{matrix}- {k}_{f}^{IL 13 : CD 124 : CD 213} \cdot {R}_{S}^{CellTypeA : CD 124 : CD 213} [ t ] \cdot {L}^{IL 13} + \\ {k}_{r}^{IL 13 : CD 124 : CD 213} \cdot {C}_{S}^{CellTypeA : IL 13 : CD 124 : CD 213} [ t ] - \\ {k}_{f}^{IL 13 : CD 124} \cdot {R}_{S}^{CellTypeA : CD 124} [ t ] \cdot {L}^{IL 13} + \\ {k}_{r}^{IL 13 : CD 124} \cdot {C}_{S}^{CellTypeA : IL 13 : CD 124} [ t ] - \\ {k}_{f}^{IL 13 : CD 213} \cdot {R}_{S}^{CellTypeA : CD 213} [ t ] \cdot {L}^{IL 13} + \\ {k}_{r}^{IL 13 : CD 213} \cdot {C}_{S}^{CellTypeA : IL 13 : CD 213} [ t ] - \\ {k}_{f}^{IL 13 : IL 13 Ra 2} \cdot {R}_{S}^{CellTypeA : IL 13 Ra 2} [ t ] \cdot {L}^{IL 13} + \\ {k}_{r}^{IL 13 : IL 13 Ra 2} \cdot {C}_{S}^{CellTypeA : IL 13 : IL 13 Ra 2} [ t ] + \\ {k}_{x}^{CellTypeA : IL 13} \cdot {L}_{i}^{CellTypeA : IL 13} \cdot {V}_{e} \cdot {N}_{A}\end{matrix} ) \cdot \frac{{Y}^{CellTypeA} [ t ]}{{N}_{A}} + ( repeat\_above \_for \_additional \_cell \_types ) \qquad 73$$

$$\frac{d {L}_{i}^{CellTypeA : IL 13}}{d t} = ( \begin{matrix}\begin{matrix}\begin{matrix}\begin{matrix}\begin{matrix}- {k}_{fe}^{IL 13 : CD 124 : CD 213} \cdot {R}_{i}^{CellTypeA : CD 124 : CD 213} [ t ] \cdot {L}_{i}^{CellTypeA : IL 13} + \\ {k}_{re}^{IL 13 : CD 124 : CD 213} \cdot {C}_{i }^{CellTypeA : IL 13 : CD 124 : CD 213} [ t ] -\end{matrix} \\ {k}_{fe}^{IL 13 : CD 124} \cdot {R}_{i}^{CellTypeA : CD 124} [ t ] \cdot {L}_{i}^{CellTypeA : IL 13} +\end{matrix} \\ {k}_{e}^{IL 13 CD 124} \cdot {C}_{i}^{CellTypeA : IL 13 : CD 124} [ t ] -\end{matrix} \\ {k}_{fe}^{IL 13 : CD 213} \cdot {R}_{i}^{CellTypeA : CD 213} [ t ] \cdot {L}_{i}^{CellTypeA : IL 13} -\end{matrix} \\ {k}_{fe}^{IL 13 : IL 13 Ra 2} \cdot {R}_{i}^{CellTypeA : IL 13 Ra 2} [ t ] \cdot {L}_{i}^{CellTypeA : IL 13} + \\ {k}_{re }^{IL 13 : IL 13 Ra 2} \cdot {C}_{i}^{CellTypeA : IL 13 : IL 13 Ra 2} [ t ] + \\ {k}_{re}^{IL 13 : CD 213} \cdot {C}_{i}^{CellTypeA : IL 13 : CD 213} [ t ]\end{matrix} ) \cdot \frac{1}{{V}_{e} \cdot {N}_{A }} - {k}_{x}^{CellTypeA : IL 13} \cdot {L}_{i}^{CellTypeA : IL 13} \qquad 74$$

$$\begin{matrix}\frac{d {L}_{d}^{CellTypeA : IL 13}}{d t} = {k}_{h}^{IL 13 : CD 124 : CD 213} \cdot {C}_{i}^{CellTypeA : IL 13 : CD 124 : CD 213} [ t ] + {k}_{h}^{IL 13 : CD 213} \cdot {C}_{i}^{CellTypeA : IL 13 : CD 213} [ t ] + {k}_{h}^{IL 13 : IL 13 Ra 2} \cdot {C}_{i}^{CellTypeA : IL 13 : IL 13 Ra 2} [ t ] + {k}_{h}^{IL 13 : CD 124} \cdot {C}_{i}^{CellTypeA : IL 13 : CD 124} [ t ] & 75\end{matrix}$$

$$\frac{d {L}^{IL 21}}{d t} = ( \begin{matrix}- {k}_{f}^{IL 21 : IL 21 R : CD 132} \cdot {R}_{S}^{CellTypeA : IL 2 R : CD 132} [ t ] \cdot {L}^{IL 21} + \\ {k}_{r}^{IL 21 : IL 21 R : CD 132} \cdot {C}_{S}^{CellTypeA : IL 21 : IL 21 R : CD 132} [ t ] - \\ {k}_{f }^{IL 21 : IL 21 R} \cdot {R}_{S}^{CellTypeA : IL 21 R} [ t ] \cdot {L}^{IL 21} + \\ {k}_{r}^{IL 21 : IL 21 R} \cdot {C}_{S}^{CellTypeA : IL 21 : IL 21 R} [ t ] + {k}_{x}^{CellTypeA : IL 21} \cdot \\ {L}_{i}^{CellTypeA : IL 21} \cdot {V}_{e} \cdot {N}_{A}\end{matrix} ) \cdot \frac{{T}^{CellTypeA} [ t ]}{{N}_{A}} + ( repeat\_above \_for \_additional \_cell \_types ) \qquad 76$$

$$\frac{d {L}_{i}^{CellTypeA : IL 21}}{d t} = ( \begin{matrix}- {k}_{fe}^{IL 21 : IL 21 R : CD 132} \cdot {R}_{i}^{CellTypeA : IL 21 : CD 132} [ t ] \cdot {L}_{i}^{CellTypeA : IL 21} + \\ {k}_{re}^{IL 21 : IL 21 R : CD 132} \cdot {C}_{i}^{CellTypeA : IL 2 : IL 21 R : CD 132} [ t ] - \\ {k}_{fe}^{IL 21 : IL 21 R} \cdot {R}_{i}^{CellTypeA : IL 21 R} [ t ] \cdot {L}_{i}^{CellTypeA : IL 21} + \\ {k}_{re}^{IL 21 : IL 21 R} \cdot {C}_{i}^{CellTypeA : IL 21 : IL 21 R} [ t ]\end{matrix} ) \cdot \frac{1}{{V}_{e} \cdot {N}_{A}} - {k}_{x}^{CellTypeA : IL 21} \cdot {L}_{i}^{CellTypeA : IL 21} \qquad 77$$

$$\begin{matrix}\frac{d {L}_{d}^{CellTypeA : IL 21}}{d t} = {k}_{h}^{IL 21 : IL 21 R : CD 132} \cdot {C}_{i}^{CellTypeA : IL 21 R : CD 132} [ t ] + {k}_{h}^{IL 21 : IL 21 R} \cdot {C}_{i}^{CellTypeA : IL 22 : IL 21 R} [ t ] & 78\end{matrix}$$

$$\begin{matrix}\frac{d {L}^{IL 9}}{d t} = ( \begin{matrix}- {k}_{f}^{IL 9 : CD 129 : CD 132} \cdot {R}_{S}^{CellTypeA : CD 129 : CD 132} [ t ] \cdot {L}^{IL 9} + \\ {k}_{r}^{IL 9 : CD 129 : CD 132} \cdot {C}_{S}^{CellTypeA : IL 9 : CD 129 : CD 132} [ t ] - \\ {k}_{f}^{IL 9 : CD 129} \cdot {R}_{S}^{CellTypeA : CD 129} [ t ] \cdot {L}^{IL 9} + \\ {k}_{r}^{IL 9 : CD 129} \cdot {C}_{S}^{CelTypeA : IL 9 : CD 129} [ t ] + \\ {k}_{x}^{CellTypeA : IL 9} \cdot {L}_{i}^{CellTypeA : IL 9} \cdot {V}_{e} \cdot {N}_{A}\end{matrix} ) \cdot \frac{{Y}^{CellTypeA} [ t ]}{{N}_{A}} + ( repeat\_above \_for \_additional \_cell \_types ) & 79\end{matrix}$$

$$\begin{matrix}\frac{d {L}_{i}^{CellTypeA : IL 9}}{d t} = ( \begin{matrix}- {k}_{fe}^{IL 9 : CD 129 : CD 132} \cdot {R}_{i}^{CellTypeA : CD 129 : CD 132} [ t ] \cdot {L}_{i}^{CellTypeA : IL 9} + \\ {k}_{re}^{IL 9 : CD 129 : CD 132} \cdot {C}_{i}^{CellTypeA : IL 9 : CD 129 : CD 132} [ t ] - \\ {k}_{fe}^{IL 9 : CD 129} \cdot {R}_{i}^{CellTypeA : CD 129} [ t ] \cdot {L}_{i}^{CellTypeA : IL 9} + \\ {k}_{re}^{IL 9 : CD 129} \cdot {C}_{i}^{CellTypeA : IL 9 : CD 129} [ t ]\end{matrix} ) \cdot \frac{1}{{V}_{e} \cdot {N}_{A}} - {k}_{x}^{CellTypeA : IL 9} \cdot {L}_{i}^{CellTypeA : IL 9} & 80\end{matrix}$$

$$\frac{d {L}_{d}^{CellTypeA : IL 9}}{d t} = {k}_{h}^{IL 9 : CD 129 : CD 132} \cdot {C}_{i}^{CellTypeA : IL 9 : CD 129 : CD 132} [ t ] + {k}_{h}^{IL 9 : CD 129} \cdot {C}_{i}^{CellTypeA : IL 9 : CD 129} [ t ] \qquad 81$$

$$\frac{d {L}^{IL 2}}{d t} = \\ ( - {k}_{f}^{IL 2 : CD 132} \cdot {R}_{S}^{CellTypeA : CD 132} [ t ] \cdot {L}^{IL 2} + {k}_{r}^{IL 2 : CD 132} \cdot {C}_{S}^{CellTypeA : IL 2 : CD 132} [ t ] - {k}_{f}^{IL 2 : CD 122 : CD 132} \cdot {R}_{S}^{CellTypeA : CD 122 : CD 132} [ t ] \cdot {L}^{IL 2} + {k}_{r}^{IL 2 : CD 122 : CD 132} \cdot {C}_{S}^{CellTypeA : IL 2 : CD 122 : CD 132} [ t ] - {k}_{f}^{IL 2 : CD 25 : CD 122 : CD 132} \cdot {R}_{S}^{CellTypeA : CD 25 : CD 122 : CD 132} [ t ] \cdot {L}^{IL 2} + {k}_{r}^{IL 2 : CD 25 : CD 122 : CD 132} \cdot {C}_{S}^{CellTypeA : IL 2 : CD 25 : CD 122 : CD 132} [ t ] - {k}_{f}^{IL 2 : CD 25} \cdot {R}_{S}^{CellTypeA : CD 25} [ t ] \cdot {L}^{IL 2} + {k}_{r}^{IL 2 : CD 25} \cdot {C}_{S}^{CellTypeA : IL 2 : CD 25} [ t ] - {k}_{f}^{IL 2 : CD 25 : CD 122} \cdot {R}_{S}^{CellTypeA : CD 25 : CD 122} [ t ] \cdot {L}^{IL 2} + {k}_{r}^{IL 2 : CD 25 : CD 122} \cdot {C}_{S}^{CellTypeA : IL 2 : CD 25 : CD 122} [ t ] - {k}_{f}^{IL 2 : CD 122} \cdot {R}_{S}^{CellTypeA : CD 122} [ t ] \cdot {L}^{IL 2} + {k}_{r}^{IL 2 : CD 122} \cdot {C}_{S}^{CellTypeA : IL 2 : CD 122} [ t ] + {k}_{x}^{CellTypeA : IL 2} \cdot {L}_{i}^{CellTypeA : IL 2} \cdot {V}_{e} \cdot {N}_{A} ) \cdot \frac{{Y}^{CellTypeA} [ t ]}{{N}_{A}} + ( repeat\_above \_for \_additional \_cell \_types ) \qquad 82$$

$$\frac{d {L}_{i}^{CellTypeA : IL 2}}{d t} = ( - {k}_{fe}^{IL 2 : CD 132} \cdot {R}_{i}^{CellTypeA : CD 132} [ t ] \cdot {L}_{i}^{CellTypeA : IL 2} + {k}_{re}^{IL 2 : CD 132} \cdot {C}_{i}^{CellTypeA : IL 2 : CD 132} [ t ] - {k}_{fe}^{IL 2 : CD 122 : CD 132} \cdot {R}_{i}^{CellTypeA : CD 122 : CD 132} [ t ] \cdot {L}_{i}^{CellTypeA : IL 2} + {k}_{re}^{IL 2 : CD 122 : CD 132} \cdot {C}_{i}^{CellTypeA : IL 2 : CD 122 : CD 132} [ t ] - {k}_{fe}^{IL 2 : CD 25 : CD 122 : CD 132} \cdot {R}_{i}^{CellTypeA : CD 25 : CD 122 : CD 132} [ t ] \cdot {L}_{i}^{CellTypeA : IL 2} + {k}_{re}^{IL 2 : CD 25 : CD 122 : CD 132} \cdot {C}_{i}^{CellTypeA : IL 2 : CD 25 : CD 122 : CD 132} [ t ] - {k}_{fe}^{IL 2 : CD 25} \cdot {R}_{i}^{CellTypeA : CD 25} [ t ] \cdot {L}_{i}^{CellTypeA : IL 2} + {k}_{re}^{IL 2 : CD 25} \cdot {C}_{i}^{CellTypeA : IL 2 : CD 25} [ t ] - {k}_{fe}^{IL 2 : CD 25 : CD 122} \cdot {R}_{i}^{CellTypeA : CD 25 : CD 122} [ t ] \cdot {L}_{i}^{CellTypeA : IL 2} + {k}_{re}^{IL 2 : CD 25 : CD 122} \cdot {C}_{i}^{CellTypeA : IL 2 : CD 25 : CD 122} [ t ] - {k}_{fe}^{IL 2 : CD 122} \cdot {R}_{i}^{CellTypeA : CD 122} [ t ] \cdot {L}_{i}^{CellTypeA : IL 2} + {k}_{re}^{IL 2 : CD 122} \cdot {C}_{i}^{CellTypeA : IL 2 : CD 122} [ t ] ) \cdot \frac{1}{{V}_{e} \cdot {N}_{A}} - {k}_{x}^{CellTypeA : IL 2} \cdot {L}_{i}^{CellTypeA : IL 2} \qquad 83$$

$$\frac{d {L}_{d}^{CellTypeA : IL 2}}{d t} = {k}_{h}^{IL 2 : CD 132} \cdot {C}_{i}^{CellTypeA : IL 2 : CD 132} [ t ] + {k}_{h}^{IL 2 : CD 122 : CD 132} \cdot {C}_{i}^{CellTypeA : IL 2 : CD 122 : CD 132} [ t ] + {k}_{h}^{IL 2 : CD 25 : CD 122 : CD 132} \cdot {C}_{i}^{CellTypeA : IL 2 : CD 25 : CD 122 : CD 132} [ t ] + {k}_{h}^{IL 2 : CD 25} \cdot {C}_{i}^{CellTypeA : IL 2 : CD 25} [ t ] + {k}_{h}^{IL 2 : CD 122} \cdot {C}_{i}^{CellTypeA : IL 2 : CD 122} [ t ] + {k}_{h}^{IL 2 : CD 25 : CD 122} \cdot {C}_{i}^{CellTypeA : IL 2 : CD 25 : CD 122} [ t ] \qquad 84$$

$$\frac{d {Y}^{CellTypeA}}{d t} = factors\_affecting \_cell \_proliferation \qquad 85$$

$$\frac{d {C}_{S}^{CellTypeA : IL 9 : CD 129}}{d t} = {k}_{f}^{IL 9 : CD 129} \cdot {R}_{S}^{CellTypeA : CD 129} [ t ] \cdot {L}^{IL 9} - {k}_{r}^{IL 9 : CD 129} \cdot {C}_{S}^{CellTypeA : IL 9 : CD 129} [ t ] - {k}_{f}^{CD 132 : IL 9 : CD 129} \cdot {R}_{S}^{CellTypeA : CD 132} [ t ] \cdot {C}_{S}^{CellTypeA : IL 9 : CD 129} [ t ] + {k}_{r}^{CD 132 : IL 9 : CD 129} \cdot {C}_{S}^{CellTypeA : IL 9 : CD 129 : CD 132} [ t ] - {k}_{e}^{CellTypeA : IL 9 : CD 129} \cdot {C}_{S}^{CellTypeA : IL 9 : CD 129} [ t ] \qquad 86$$

$$\frac{d {C}_{i}^{CellTypeA : IL 9 : CD 129}}{d t} = {k}_{fe}^{IL 9 : CD 129} \cdot {R}_{i}^{CellTypeA : CD 129} [ t ] \cdot {L}_{i}^{CellTypeA : IL 9} - {k}_{re}^{IL 9 : CD 129} \cdot {C}_{i}^{CellTypeA : IL 9 : CD 129} [ t ] - {k}_{fe}^{CD 132 : IL 9 : CD 129} \cdot {R}_{i}^{CellTypeA : CD 132} [ t ] \cdot {C}_{i}^{CellTypeA : IL 9 : CD 129} + {k}_{re}^{CD 132 : IL 9 : CD 129} \cdot {C}_{i}^{CellTypeA : IL 9 : CD 129 : CD 132} [ t ] + {k}_{e}^{CellTypeA : IL 9 : CD 129} \cdot {C}_{S}^{CellTypeA : IL 9 : CD 129} [ t ] - {k}_{h}^{CellTypeA : IL 9 : CD 129} \cdot {C}_{i}^{CellTypeA : IL 9 : CD 129} [ t ] \qquad 87$$

$$\frac{d {C}_{S}^{CellTypeA : IL 21 : IL 21 R}}{d t} = {k}_{f}^{IL 21 : IL 21 R} \cdot {R}_{S}^{CellTypeA : IL 21 R} [ t ] \cdot {L}^{IL 21} - {k}_{r}^{IL 21 : IL 21 R} \cdot {C}_{S}^{CellTypeA : IL 21 : IL 21 R} [ t ] - {k}_{f}^{CD 132 : IL 21 : IL 21 R} \cdot {R}_{S}^{CellTypeA : CD 132} [ t ] \cdot {C}_{S}^{CellTypeA : IL 21 : IL 21 R} [ t ] + {k}_{r}^{CD 132 : IL 21 : IL 21 R} \cdot {C}_{S}^{CellTypeA : IL 21 : IL 21 R : CD 132} [ t ] - {k}_{e}^{CellTypeA : IL 21 : IL 21 R} \cdot {C}_{S}^{CellTypeA : IL 21 : IL 21 R} [ t ] \qquad 88$$

$$\frac{d {C}_{i}^{CellTypeA : IL 21 : IL 21 R}}{d t} = {k}_{fe}^{IL 21 : IL 21 R} \cdot {R}_{i}^{CellTypeA : IL 21 R} [ t ] \cdot {L}_{i}^{CellTypeA : IL 21} - {k}_{re}^{IL 21 : IL 21 R} \cdot {C}_{i}^{CellTypeA : IL 21 : IL 21 R} [ t ] - {k}_{fe}^{CD 132 : IL 21 : IL 21 R} \cdot {R}_{i}^{CellTypeA : CD 132} [ t ] \cdot {C}_{i}^{CellTypeA : IL 21 : IL 21 R} [ t ] + {k}_{re}^{CD 132 : IL 21 : IL 21 R} \cdot {C}_{i}^{CellTypeA : IL 21 : IL 21 R : CD 132} [ t ] + {k}_{e}^{CellTypeA : IL 21 : IL 21 R} \cdot {C}_{S}^{CellTypeA : IL 21 : IL 21 R} [ t ] - {k}_{h}^{CellTypeA : IL 21 : IL 21 R} \cdot {C}_{i}^{CellTypeA : IL 21 : IL 21 R} [ t ] \qquad 89$$

$$\frac{d {C}_{S}^{CellTypeA : IL 4 : CD 124}}{d t} = {k}_{f}^{IL 4 : CD 124} \cdot {R}_{S}^{CellTypeA : CD 124} [ t ] \cdot {L}^{IL 4} - {k}_{r}^{IL 4 : CD 124} \cdot {C}_{S}^{CellTypeA : IL 4 : CD 124} [ t ] - {k}_{f}^{CD 132 : IL 4 : CD 124} \cdot {R}_{S}^{CellTypeA : CD 132} [ t ] \cdot {C}_{S}^{CellTypeA : IL 4 : CD 124} [ t ] + {k}_{r}^{CD 132 : IL 4 : CD 124} \cdot {C}_{S}^{CellTypeA : IL 4 : CD 124 : CD 132} [ t ] - {k}_{f}^{CD 213 : IL 4 : CD 124} \cdot {R}_{S}^{CellTypeA : CD 213} [ t ] \cdot {C}_{S}^{CellTypeA : IL 4 : CD 124} [ t ] + {k}_{r}^{CD 213 : IL 4 : CD 124} \cdot {C}_{S}^{CellTypeA : IL 4 : CD 124 : CD 213} [ t ] - {k}_{e}^{CellTypeA : IL 4 : CD 124} \cdot {C}_{S}^{CellTypeA : IL 4 : CD 124} [ t ] \qquad 90$$

$$\frac{d {C}_{i}^{CellTypeA : IL 4 : CD 124}}{d t} = {k}_{fe}^{IL 4 : CD 124} \cdot {R}_{i}^{CellTypeA : CD 124} [ t ] \cdot {L}_{i}^{CellTypeA : IL 4} - {k}_{re}^{IL 4 : CD 124} \cdot {C}_{i}^{CellTypeA : IL 4 : CD 124} [ t ] - {k}_{fe}^{CD 132 : IL 4 : CD 124} \cdot {R}_{i}^{CellTypeA : CD 132} [ t ] \cdot {C}_{i}^{CellTypeA : IL 4 : CD 124} [ t ] + {k}_{re}^{CD 132 : IL 4 : CD 124} \cdot {C}_{i}^{CellTypeA : IL 4 : CD 124 : CD 132} [ t ] - {k}_{fe}^{CD 213 : IL 4 : CD 124} \cdot {R}_{i}^{CellTypeA : CD 213} [ t ] \cdot {C}_{i}^{CellTypeA : IL 4 : CD 124} [ t ] + {k}_{re}^{CD 213 : IL 4 : CD 124} \cdot {C}_{i}^{CellTypeA : IL 4 : CD 124 : CD 213} [ t ] + {k}_{e}^{CellTypeA : IL 4 : CD 124} \cdot {C}_{S}^{CellTypeA : IL 4 : CD 124} [ t ] - {k}_{h}^{CellTypeA : IL 4 : CD 124} \cdot {C}_{i}^{CellTypeA : IL 4 : CD 124} [ t ] \qquad 91$$

$$\frac{d {C}_{S}^{CellTypeA : IL 4 : CD 213}}{d t} = {k}_{f}^{IL 4 : CD 213} \cdot {R}_{S}^{CellTypeA : CD 213} [ t ] \cdot {L}^{IL 4} - {l}_{r}^{IL 4 : CD 213} \cdot {C}_{S}^{CellTypeA : IL 4 : CD 213} [ t ] - {k}_{f}^{CD 124 : IL 4 : CD 213} \cdot {R}_{S}^{CellTypeA : CD 124} [ t ] \cdot {C}_{S}^{CellTypeA : IL 4 : CD 213} [ t ] + {k}_{r}^{CD 124 : IL 4 : CD 213} \cdot {C}_{S}^{CellTypeA : IL 4 : CD 124 : CD 213} [ t ] - {k}_{e}^{CellTypeA : IL 4 : CD 213} \cdot {C}_{S}^{CellTypeA : IL 4 : CD 213} [ t ] \qquad 92$$

$$\frac{d {C}_{i}^{CellTypeA : IL 4 : CD 213}}{d t} = {k}_{fe}^{IL 4 : CD 213} \cdot {R}_{i}^{CellTypeA : CD 213} [ t ] \cdot {L}_{i}^{CellTypeA : IL 4} - {k}_{re}^{IL 4 : CD 213} \cdot {C}_{i}^{CellTypeA : IL 4 : CD 213} [ t ] - {k}_{fe}^{CD 124 : IL 4 : CD 213} \cdot {R}_{i}^{CellTypeA : CD 124} [ t ] \cdot {C}_{i}^{CellTypeA : IL 4 : CD 213} [ t ] + {k}_{re}^{CD 1124 : IL 4 : C 213} \cdot {C}_{i}^{CellTypeA : IL 4 : CD 124 : CD 213} [ t ] + {k}_{e}^{CellTypeA : IL 4 : CD 213} \cdot {C}_{S}^{CellTypeA : IL 4 : CD 213} [ t ] - {k}_{h}^{CellTypeA : IL 4 : CD 213} \cdot {C}_{i}^{CellTypeA : IL 4 : CD 213} [ t ] \qquad 93$$

$$\frac{d {C}_{S}^{CellTypeA : IL 13 : CD 213}}{d t} = {k}_{f}^{IL 13 : CD 213} \cdot {R}_{S}^{CellTypeA : CD 213} [ t ] \cdot {L}^{IL 13} - {k}_{r}^{IL 13 : CD 213} \cdot {C}_{S}^{CellTypeA : IL 13 : CD 213} [ t ] - {k}_{f}^{CD 124 : IL 13 : CD 213} \cdot {R}_{S}^{CellTypeA : CD 124} [ t ] \cdot {C}_{S}^{CellTypeA : IL 13 : CD 213} [ t ] + {k}_{r}^{CD 124 : IL 13 : CD 213} \cdot {C}_{S}^{CellTypeA : IL 13 : CD 124 : CD 213} [ t ] - {k}_{e}^{CellTypeA : IL 13 : CD 213} \cdot {C}_{S}^{CellTypeA : IL 13 : CD 213} [ t ] \qquad 94$$

$$\frac{d {C}_{i}^{CellTypeA : IL 13 : CD 213}}{d t} = {k}_{fe}^{IL 13 : CD 213} \cdot {R}_{i}^{CellTypeA : CD 213} [ t ] \cdot {L}_{i}^{CellTypeA : IL 13} - {k}_{re}^{IL 13 : CD 213} \cdot {C}_{i}^{CellTypeA : IL 13 : CD 213} [ t ] - {k}_{fe}^{CD 124 : IL 13 : CD 213} \cdot {R}_{i}^{CellTypeA : CD 124} [ t ] \cdot {C}_{i}^{CellTypeA : IL 13 : CD 213} [ t ] + {k}_{re}^{CD 124 : IL 13 : CD 213} \cdot {C}_{i}^{CellTypeA : IL 13 : CD 124 : CD 213} [ t ] + {k}_{e}^{CellTypeA : IL 13 : CD 213} \cdot {C}_{S}^{CellTypeA : IL 13 : CD 213} [ t ] - {k}_{h}^{CellTypeA : IL 13 : CD 213} \cdot {C}_{i}^{CellTypeA : IL 13 : CD 213} [ t ] \qquad 95$$

$$\begin{matrix}\frac{d {C}_{S}^{CellTypeA : IL 13 : CD 124}}{d t} = {k}_{f}^{IL 13 : CD 124} \cdot {R}_{S}^{CellTypeA : CD 124} [ t ] \cdot {L}^{IL 13} - {k}_{r}^{IL 13 : CD 124} \cdot {C}_{S}^{CellTypeA : IL 13 : CD 124} [ t ] - {k}_{f}^{CD 213 : IL 13 : CD 124} \cdot {R}_{S}^{CellTypeA : CD 213} [ t ] \cdot {C}_{S}^{CellTypeA : IL 13 : CD 214} [ t ] + {k}_{r}^{CD 213 : IL 13 : CD 124} \cdot {C}_{S}^{CellTypeA : IL 13 : CD 124 : CD 213} [ t ] - {k}_{e}^{CellTypeA : IL 13 : CD 124} \cdot {C}_{S}^{CellTypeA : IL 13 : CD 124} [ t ] & 96\end{matrix}$$

$$\begin{matrix}\frac{d {C}_{i}^{CellTypeA : IL 13 : CD 124}}{d t } = {k}_{fe }^{IL 13 : CD 124} \cdot {R}_{i}^{CellTypeA : CD 124} [ t ] \cdot {L}_{i}^{CellTypeA : IL 13} - {k}_{re}^{IL 13 : CD 124} \cdot {C}_{i}^{CellTypeA : IL 13 : CD 124} [ t ] - {k}_{fe}^{CD 213 : IL 13 : CD 124} \cdot {R}_{i}^{CellTypeA : CD 213} [ t ] \cdot {C}_{i}^{CellTypeA : IL 13 : CD 124} [ t ] + {k}_{re}^{CD 213 : IL 13 : CD 124} \cdot {C}_{i}^{CellTypeA : IL 13 : CD 124 : CD 213} [ t ] + {k}_{e}^{CellTypeA : IL 13 : CD 124} \cdot {C}_{S}^{CellTypeA : IL 13 : CD 124} [ t ] - {k}_{h}^{CellTypeA : IL 13 : CD 124} \cdot {C}_{i}^{CellTypeA : IL 13 : CD 124} [ t ] & 97\end{matrix}$$

$$\begin{matrix}\frac{d {C}_{S }^{CellTypeA : IL 7 : CD 127}}{d t} = {k}_{S}^{IL 7 : CD 127} [ t ] \cdot {R}_{S}^{CellTypeA : CD 127} \cdot {L}^{IL 7} - {k}_{r}^{IL 7 : CD 127} \cdot {C}_{S}^{CellTypeA : IL 7 : CD 127} [ t ] - {k}_{f}^{CD 132 : IL 7 : CD 127} \cdot {R}_{S}^{CellTypeA : CD 132} [ t ] \cdot {C}_{S}^{CellTypeA : IL 7 : CD 127} [ t ] + {k}_{r}^{CD 132 : IL 7 : CD 127} \cdot {C}_{S}^{CellTypeA : IL 7 : CD 127 : CD 132} [ t ] - {k}_{e}^{CellTypeA : IL 7 : CD 127} \cdot {C}_{S}^{CellTypeA : IL 7 : CD 127} [ t ] & 98\end{matrix}$$

$$\begin{matrix}\frac{d {C}_{i}^{CellTypeA : IL 7 : CD 127}}{d t} = {k}_{fe}^{IL 7 : CD 127} \cdot {R}_{i}^{CellTypeA : CD 127} [ t ] \cdot {L}_{i}^{CellTypeA : IL 7} - {k}_{re}^{IL 7 : CD 127} \cdot {C}_{i}^{CellTypeA : IL 7 : CD 127} [ t ] - {k}_{fe}^{CD 132 : IL 7 : CD 127} \cdot {R}_{i}^{CellTypeA : CD 132} [ t ] \cdot {C}_{i}^{CellTypeA : IL 7 : CD 127} [ t ] + {k}_{re}^{CD 132 : IL 7 : CD 127} \cdot {C}_{i}^{CellTypeA : IL 7 : CD 127 : CD 132} [ t ] + {k}_{e}^{CellTypeA : IL 7 : CD 127} \cdot {C}_{S}^{CellTypeA : IL 7 : CD 127} [ t ] - {k}_{h}^{CellTypeA : IL 7 : CD 127} \cdot {C}_{i}^{CellTypeA : IL 7 : CD 127} [ t ] & 99\end{matrix}$$

$$\begin{matrix}\frac{d {C}_{S}^{CellTypeA : TSLP : TSLPR}}{d t} = {k}_{f}^{TSLP : TSLPR} \cdot {R}_{S}^{CellTypeA : TSLPR} [ t ] \cdot {L}^{TSLP} - {k}_{r}^{TSLP : TSLPR} \cdot {C}_{S}^{CellTypeA : TSLP : TSLPR} [ t ] - {k}_{f}^{CD 127 : TSLP : TSLPR} \cdot {R}_{S}^{CellTypeA : CD 127} [ t ] \cdot {C}_{S}^{CellTypeA : TSLP : TSLPR} [ t ] + {k}_{r}^{CD 127 : TSLP : TSLPR} \cdot {C}_{S}^{CellTypeA : TSLP : CD 127 : TSLPR} [ t ] - {k}_{e}^{CellTypeA : TSLP : TSLPR} \cdot {C}_{S}^{CellTypeA : TSLP : TSLPR} [ t ] & 100\end{matrix}$$

$$\begin{matrix}\frac{d {C}_{i}^{CellTypeA : TSLP : TSLPR}}{d t} = {k}_{fe}^{TSLP : TSLPR} \cdot {R}_{i}^{CellTypeA : TSLPR} [ t ] \cdot {L}_{i}^{CellTypeA : TSLP} - {k}_{re}^{TSLP : TSLPR} \cdot {C}_{i}^{CellTypeA : TSLP : TSLPR} [ t ] - {k}_{fe}^{CD 127 : TSLP : TSLPR} \cdot {R}_{i}^{CellTypeA : CD 127} [ t ] \cdot {C}_{i}^{CellTypeA : TSLP : TSLPR} [ t ] + {k}_{re}^{CD 127 : TSLP : TSLPR} \cdot {C}_{i}^{CellTypeA : TSLP : CD 127 : TSLPR} [ t ] + {k}_{e}^{CellTypeA : TSLP : TSLPR} \cdot {C}_{S}^{CellTypeA : TSLP : TSLPR} [ t ] - {k}_{h}^{CellTypeA : TSLP : TSLPR} \cdot {C}_{i}^{CellTypeA : TSLP : TSLPR} [ t ] & 101\end{matrix}$$

$$\begin{matrix}\frac{d {R}_{S}^{CellTypeA : CD 25 : CD 122}}{d t} = {k}_{f}^{CD 25 : CD 122} \cdot {R}_{S}^{CellTypeA : CD 25} [ t ] \cdot {R}_{S}^{CellTypeA : CD 122} [ t ] - {k}_{r}^{CD 25 : CD 122} \cdot {R}_{S}^{CellTypeA : CD 25 : CD 122} [ t ] - {k}_{f}^{CD 132 : CD 25 : CD 122} \cdot {R}_{S}^{CellTypeA : CD 132} [ t ] \cdot {R}_{S}^{CellTypeA : CD 25 : CD 122} [ t ] + {k}_{r}^{CD 132 : CD 25 : CD 122} \cdot {R}_{S}^{CellTypeA : CD 25 : CD 122 : CD 132} [ t ] - {k}_{f}^{IL 2 : CD 25 : CD 122} \cdot {R}_{S}^{CellTypeA : CD 25 : CD 122} [ t ] \cdot {L}^{IL 2} [ t ] + {k}_{r}^{IL 2 : CD 25 : CD 122} \cdot {C}_{S}^{CellTypeA : IL 2 : CD 25 : CD 122} [ t ] - {k}_{t}^{CellTypeA : CD 25 : CD 122} \cdot {C}_{S}^{CellTypeA : CD 25 : CD 122} [ t ] & 102\end{matrix}$$

$$\begin{matrix}\frac{d {R}_{i}^{CellTypeA : CD 25 : CD 122}}{d t} = {k}_{fe}^{CD 25 : CD 122} \cdot {R}_{i}^{CellTypeA : CD 25} [ t ] \cdot {R}_{i}^{CellTypeA : CD 122} [ t ] - {k}_{re}^{CD 25 : CD 122} \cdot {R}_{i}^{CellTypeA : CD 25 : CD 122} [ t ] - {k}_{fe}^{CD 132 : CD 25 : CD 122} \cdot {R}_{i}^{CellTypeA : CD 132} [ t ] \cdot {R}_{i}^{CellTypeA : CD 25 : CD 122} [ t ] + {k}_{re}^{CD 132 : CD 25 : CD 122} \cdot {R}_{i}^{CellTypeA : CD 25 : CD 122 : CD 132} [ t ] - {k}_{fe}^{IL 2 : CD 25 : CD 122} \cdot {R}_{i}^{CellTypeA : CD 25 : CD 122} [ t ] \cdot {L}_{i }^{CellTypeA : IL 2} [ t ] + {k}_{re}^{IL 2 : CD 25 : CD 122} \cdot {C}_{i}^{CellTypeA : IL 2 : CD 25 : CD 122} [ t ] + {k}_{t}^{CellTypeA : CD 25 : CD 122} \cdot {C}_{S}^{CellTypeA : CD 25 : CD 122} [ t ] - {k}_{h }^{CellTypeA : CD 25 : CD 122} \cdot {C}_{i}^{CellTypeA : CD 25 : CD 122} [ t ] & 103\end{matrix}$$

$$\begin{matrix}\frac{d {C}_{S}^{CellTypeA : IL 2 : CD 25}}{d t} = {k}_{f}^{IL 2 : CD 25} \cdot {R}_{S}^{CellTypeA : CD 25} [ t ] \cdot {L}^{IL 2} [ t ] - {k}_{r}^{IL 2 : CD 25} \cdot {C}_{S}^{CellTypeA : IL 2 : CD 25} [ t ] - {k}_{f}^{CD 122 : IL 2 : CD 25} \cdot {R}_{S}^{CellTypeA : CD 122} [ t ] \cdot {C}_{S}^{CellTypeA : IL 2 : CD 25} [ t ] + {k}_{r}^{CD 122 : IL 2 : CD 25} \cdot {C}_{S}^{CellTypeA : IL 2 : CD 25 : CD 122} [ t ] - {k}_{e}^{CellTypeA : IL 2 : CD 25} \cdot {C}_{S}^{CellTypeA : IL 2 : CD 25} [ t ] & 104\end{matrix}$$

$$\begin{matrix}\frac{d {C}_{i}^{CellTypeA : IL 2 : CD 25}}{d t} = {k}_{fe}^{IL 2 : CD 25} \cdot {R}_{i}^{CellTypeA : CD 25} [ t ] \cdot {L}_{i}^{CelltypeA : IL 2} [ t ] - {k}_{re }^{IL 2 : CD 25} \cdot {C}_{i}^{CellTypeA : IL 2 : CD 25} [ t ] - {k}_{fe}^{C D 122 : IL 2 : CD 25} \cdot {R}_{i}^{CellTypeA : CD 122} [ t ] \cdot {C}_{i}^{CellTypA : IL 2 : CD 25} [ t ] + {k}_{re}^{CD 122 : IL 2 : CD 25} \cdot {C}_{i}^{CellTypeA : IL 2 : CD 25 : CD 122} [ t ] + {k}_{e}^{CellTypeA : IL 2 : CD 25} \cdot {C}_{S}^{CellTypeA : IL 2 : CD 25} [ t ] - {k}_{h}^{CellTypeA : IL 2 : CD 25} \cdot {C}_{i}^{CellTypeA : IL 2 : CD 25} [ t ] & 105\end{matrix}$$

$$\begin{matrix}\frac{d {C}_{S}^{CellTypeA : IL 2 : CD 24 : CD 122}}{d t} = {k}_{f}^{IL 2 : CD 25 : CD 122} \cdot {R}_{S}^{CellTypeA : CD 25 : CD 122} [ t ] \cdot {L}^{IL 2} [ t ] - {k}_{r}^{IL 2 : CD 25 : CD 122} \cdot {C}_{S}^{CellTypeA : IL 2 : CD 25 : CD 122} [ t ] + {k}_{f}^{CD 122 : IL 2 : CD 25} \cdot {R}_{S}^{CellTypeA : CD 122} [ t ] \cdot {C}_{S}^{CellTypeA : IL 2 : CD 25} [ t ] - {k}_{r}^{CD 122 : IL 2 : CD 25} \cdot {C}_{S}^{CellTypeA : IL 2 : CD 25 : CD 122} [ t ] + {k}_{f}^{CD 25 : IL 2 : CD 122} \cdot {R}_{S}^{CellTypeA : CD 25} [ t ] \cdot {C}_{S}^{CellTypeA : IL 2 : CD 122} [ t ] - {k}_{r}^{CD 25 : IL 2 : CD 122} \cdot {C}_{S}^{CellTypeA : IL 2 : CD 25 : CD 122} [ t ] - {k}_{f}^{CD 132 : IL 2 : CD 25 : CD 122} \cdot {R}_{S}^{CellTypeA : CD 132} [ t ] \cdot {C}_{S}^{CellTypeA : IL 2 : CD 25 : CD 122} [ t ] + {k}_{r}^{CD 132 : IL 2 : CD 25 : CD 122} \cdot {C}_{S}^{CellTypeA : IL 2 : CD 25 : CD 122 : CD 132} [ t ] - {k}_{e}^{CellTypeA : IL 2 : CD 25 : CD 122} \cdot {C}_{S}^{CellTypeA : IL 2 : CD 25 : CD 122} [ t ] & 106\end{matrix}$$

$$\begin{matrix}\frac{d {C}_{i}^{CellTypeA : IL 2 : CD 25 : CD 122}}{d t} = {k}_{fe}^{IL 2 : CD 25 : CD 122} \cdot {R}_{i}^{CellTypeA : CD 25 : CD 122} [ t ] \cdot {L}_{i}^{CelltypeA : IL 2} [ t ] - {k}_{re}^{IL 2 : CD 25 : CD 122} \cdot {C}_{i}^{CellTypeA : IL 2 : CD 25 : CD 122} [ t ] + {k}_{fe}^{CD 122 : IL 2 : CD 25} \cdot {R}_{i}^{CellTypeA : CD 122} [ t ] \cdot {C}_{i}^{CellTypeA : IL 2 : CD 25} [ t ] - {k}_{re}^{CD 122 : IL 2 : CD 25} \cdot {C}_{i}^{CellTypeA : IL 2 : CD 25 : CD 122} [ t ] + {k}_{fe}^{CD 25 : IL 2 : CD 122} \cdot {R}_{i}^{CellTypeA : CD 25} [ t ] \cdot {C}_{i}^{CellTypeA : IL 2 : CD 122} [ t ] - {k}_{re}^{CD 25 : IL 2 : CD 122} \cdot {C}_{i }^{CellTypeA : IL 2 : CD 25 : CD 122} [ t ] - {k}_{fe}^{CD 132 : IL 2 : CD 25 : CD 122} \cdot {R}_{i}^{CellTypeA : CD 132} [ t ] \cdot {C}_{i}^{CellTypeA : IL 2 : CD 25 : CD 122} [ t ] + {k}_{re}^{CD 132 : IL 2 : CD 25 : CD 122} \cdot {C}_{i}^{CellTypeA : IL 2 : CD 25 : CD 122 : CD 132} [ t ] + {k}_{e}^{CellTypeA : IL 2 : CD 25 : CD 122} \cdot {C}_{S}^{CellTypeA : IL 2 : CD 25 : CD 122} [ t ] - {k}_{h}^{CellTypeA : IL 2 : CD 25 : CD 122} \cdot {C}_{i}^{CellTypeA : IL 2 : CD 25 : CD 122} [ t ] & 107\end{matrix}$$

$$\begin{matrix}\frac{d {C}_{S}^{CellTypeA : IL 2 : CD 122}}{d t} = {k}_{f}^{IL 2 : CD 122} \cdot {R}_{S}^{CellTypeA : CD 122} [ t ] \cdot {L}^{IL 2} [ t ] - {k}_{r}^{IL 2 : CD 122} \cdot {C}_{S}^{CellTypeA : IL 2 : CD 122} [ t ] - {k}_{f}^{CD 132 : IL 2 : CD 122} \cdot {R}_{S}^{CellTypeA : CD 132} [ t ] \cdot {C}_{S}^{CellTypeA : IL 2 : CD 122} [ t ] + {k}_{r}^{CD 132 : IL 2 : CD 122} \cdot {C}_{S}^{CellTypeA : IL 2 : CD 122 : CD 132} [ t ] - {k}_{f}^{CD 25 : IL 2 : CD 122} \cdot {R}_{S}^{CellTypeA : CD 25} [ t ] \cdot {C}_{S}^{CellTypeA : IL 2 : CD 122} [ t ] + {k}_{r}^{CD 25 : IL 2 : CD 122} \cdot {C}_{S}^{CellTypeA : IL 2 : CD 25 : CD 122} [ t ] - {k}_{e}^{CelltypeA : IL 2 : CD 122} \cdot {C}_{S}^{CellTypeA : IL 2 : CD 122} [ t ] & 108\end{matrix}$$

$$\begin{matrix}\frac{d {C}_{i}^{CellTypeA : IL 2 : CD 122}}{d t} = {k}_{fe }^{IL 2 : CD 122} \cdot {R}_{i}^{CellTypeA : CD 122} [ t ] \cdot {L}_{i}^{CellTypeA : IL 2} [ t ] - {k}_{re}^{IL 2 : CD 122} \cdot {C}_{i}^{CellTypeA : IL 2 : CD 122} [ t ] - {k}_{fe}^{CD 132 : IL 2 : CD 122} \cdot {R}_{i}^{CellTypeA : CD 132} [ t ] \cdot {C}_{i}^{CellTypeA : IL 2 : CD 122} [ t ] + {k}_{re }^{CD 132 : IL 2 : CD 122} \cdot {C}_{i}^{CellTypeA : IL 2 : CD 122 : CD 132} [ t ] - {k}_{fe}^{CD 25 : IL 2 : CD 122} \cdot {R}_{i}^{CellTypeA : CD 25} [ t ] \cdot {C}_{i}^{CellTypeA : IL 2 : CD 122} [ t ] + {k}_{re}^{CD 25 : IL 2 : CD 122} \cdot {C}_{i}^{CellTypeA : IL 2 : CD 25 : CD 122} [ t ] + {k}_{e}^{CellTypeA : IL 2 : CD 122} \cdot {C}_{S}^{CellTypeA : IL 2 : CD 122} [ t ] - {k}_{i}^{CellTypeA : IL 2 : CD 122} [ t ] \cdot {C}_{i}^{CellTypeA : IL 2 : CD 122} [ t ] & 109\end{matrix}$$

$$\begin{matrix}\frac{d {R}_{S}^{CellTypeA : IL 15 R : CD 122}}{d t} = {k}_{f}^{IL 15 R : CD 122} \cdot {C}_{S}^{CellTypeA : IL 15 R} [ t ] \cdot {R}_{S}^{CellTypeA : CD 122} [ t ] - {k}_{r}^{IL 15 R : CD 122} \cdot {R}_{S}^{CellTypeA : IL 15 R : CD 122} [ t ] - {k}_{f}^{CD 132 : IL 15 R : CD 122} \cdot {R}_{S}^{CellTypeA : CD 132} [ t ] \cdot {R}_{S }^{CellTypeA : IL 15 R : CD 122} [ t ] + {k}_{r}^{CD 132 : IL 15 R : CD 122} \cdot {R}_{S}^{CellTypeA : IL 15 : CD 122 : CD 132} [ t ] - {k}_{f}^{IL 15 : IL 15 R : CD 122} \cdot {R}_{S}^{CellTypeA : IL 15 R : CD 122} [ t ] \cdot {L}^{IL 15} [ t ] + {k}_{r}^{IL 15 : IL 15 R : CD 122} \cdot {C}_{S}^{CellTypeA : IL 15 : IL 15 R : CD 122} [ t ] - {k}_{t}^{CellTypeA : IL 15 R : CD 122} \cdot {C}_{S}^{CellTypeA : IL 15 R : CD 122} [ t ] & 110\end{matrix}$$

$$\begin{matrix}\frac{d {R}_{i}^{CellTypeA : IL 15 R : CD 122}}{d t} = {k}_{fe}^{IL 15 R : CD 122} \cdot {R}_{i}^{CellTypeA : IL 15 R} [ t ] \cdot {R}_{i}^{CellTypeA : CD 122} [ t ] - {k}_{re}^{IL 15 R : CD 122} \cdot {R}_{i }^{CellTypeA : IL 15 R : CD 122} [ t ] - {k}_{fe}^{CD 132 : IL 15 R : CD 122} \cdot {R}_{i}^{CellTypeA : CD 132} [ t ] \cdot {R}_{i}^{CellTypeA : IL 15 R : CD 122} [ t ] + {k}_{re}^{CD 132 : IL 15 R : CD 122} \cdot {R}_{i}^{CellTypeA : IL 15 R : CD 122 : CD 132} [ t ] - {k}_{fe}^{IL 15 : IL 15 R : CD 122} \cdot {R}_{i}^{CellTypeA : IL 15 R : CD 122} [ t ] \cdot {L}_{i}^{CellTypeA : IL 15} [ t ] + {k}_{re}^{IL 15 : IL 15 R : CD 122} \cdot {C}_{i}^{CellTypeA : IL 15 : IL 15 R : CD 122} [ t ] + {k}_{t}^{CellTypeA : IL 15 R : CD 122} \cdot {C}_{S}^{CellTypeA : IL 15 R : CD 122} [ t ] - {k}_{h}^{CellTypeA : IL 15 R : CD 122} \cdot {C}_{i}^{CellTypeA : IL 15 R : CD 122} [ t ] & 111\end{matrix}$$

$$\frac{d {C}_{S}^{CellTypeA : IL 15 : IL 15 R}}{d t} = {k}_{f}^{IL 15 : IL 15 R} \cdot {R}_{S}^{CellTypeA : IL 15 R} [ t ] \cdot {L}^{IL 15} [ t ] - {k}_{r}^{IL 15 : IL 15 R} \cdot {C}_{S}^{CellTypeA : IL 15 : IL 15 R} [ t ] - {k}_{f}^{CD 122 : IL 15 : IL 15 R} \cdot {R}_{S}^{CellTypeA : CD 122} [ t ] \cdot {C}_{S}^{CellTtypeA : IL 15 : IL 15 R} [ t ] + {k}_{f}^{CD 122 : IL 15 : IL 15 R} \cdot {C}_{S}^{CellTypeA : IL 1 \; 5 : IL 15 RCD 122} [ t ] - {k}_{e}^{CellTypeA : IL 15 : IL 15 R} \cdot {C}_{S}^{CellTypeA : IL 15 : IL 15 R} [ t ] \qquad 112$$

$$\begin{matrix}\frac{d {C}_{i}^{CellTypeA : IL 15 : IL 15 R}}{d t} = {k}_{fe}^{IL 15 : IL 15 R} \cdot {R}_{i}^{CellTypeA : IL 15 R} [ t ] \cdot {L}_{i}^{CellTypeA : IL 15} [ t ] - {k}_{re}^{IL 15 : IL 15 R} \cdot {C}_{i}^{CellTypeA : IL 15 : IL 15 R} [ t ] - {k}_{fe}^{CD 122 : IL 15 : IL 15 R} \cdot {R}_{i}^{CellTypeA : CD 122} [ t ] \cdot {C}_{i}^{CellTypeA : IL 15 : IL 15 R} [ t ] + {k}_{re}^{CD 122 : IL 15 : IL 15 R} \cdot {C}_{i}^{CellTypeA : IL 15 : IL 15 R : CD 122} [ t ] + {k}_{e }^{CellTypeA : IL 15 : IL 15 R} \cdot {C}_{S}^{CellTypeA : IL 15 : IL 15 R} [ t ] - {k}_{h}^{CellTypeA : IL 15 : IL 15 R} \cdot {C}_{i}^{CellTypeA : IL 15 : IL 15 R} [ t ] & 113\end{matrix}$$

$$\begin{matrix}\frac{d {C}_{S}^{CellTypeA : IL 15 : IL 15 R : CD 122}}{d t} = {k}_{f}^{IL 15 : IL 15 R : CD 122} \cdot {R}_{S}^{CellTypeA : IL 15 : CD 122} [ t ] \cdot {L}^{IL 15} [ t ] - {k}_{r}^{IL 15 : IL 15 R : CD 122} \cdot {C}_{S}^{CellTypeA : IL 15 : IL 15 R : CD 122} [ t ] + {k}_{f}^{CD 122 : IL 15 : IL 15 R} \cdot {R}_{S}^{CellTypeA : CD 122} [ t ] \cdot {C}_{S}^{CellTypeA : IL 15 : IL 15 R} [ t ] - {k}_{r}^{CD 122 : IL 15 : IL 15 R} \cdot {C}_{S}^{CellTypeA : IL 15 : IL 15 R : CD 122} [ t ] + {k}_{f}^{IL 15 R : IL 15 : CD 122} \cdot {R}_{S}^{CellTypeA : IL 15 R} [ t ] \cdot {C}_{S}^{CellTypeA : IL 15 : CD 122} [ t ] - {k}_{r }^{IL 15 R : IL 15 : CD 122} \cdot {C}_{S}^{CellTypeA : IL 15 : IL 15 R : CD 122} [ t ] - {k}_{f}^{CD 132 : IL 15 : IL 15 R : CD 122} \cdot {R}_{S}^{CellTypeA : CD 132} [ t ] \cdot {C}_{S}^{CellTypeA : IL 15 : IL 15 R : CD 122} [ t ] + {k}_{r}^{CD 132 : IL 15 : IL 15 R : CD 122} \cdot {C}_{S}^{CellTypeA : IL 15 : IL 15 R : CD 122 : CD 132} [ t ] - {k}_{e}^{CellTypeA : IL 15 : IL 15 R : CD 122} \cdot {C}_{S}^{CellTypeA : IL 15 : IL 15 R : CD 122} [ t ] & 114\end{matrix}$$

$$\begin{matrix}\frac{d {C}_{i}^{CellTypeA : IL 15 : IL 15 R : CD 122}}{d t} = {k}_{fe}^{IL 15 : IL 15 R : CD 122} \cdot {R}_{i}^{CellTypeA : IL 15 R : CD 122} [ t ] \cdot {L}_{i}^{CellTypeA : IL 15} [ t ] - {k}_{re}^{IL 15 : IL 15 R : CD 122} \cdot {C}_{i}^{CellTypeA : IL 15 : IL 15 R : CD 122} [ t ] + {k}_{fe}^{CD 122 : IL 15 : IL 15 R} \cdot {R}_{i}^{CellTypeA : CD 122} [ t ] \cdot {C}_{i}^{CellTypeA : IL 15 : IL 15 R} [ t ] - {k}_{re}^{CD 122 : IL 15 : IL 15 R} \cdot {C}_{i}^{CellTypeA : IL 15 : IL 15 R : CD 122} [ t ] + {k}_{fe}^{IL 15 R : IL 15 : CD 122} \cdot {R}_{i}^{CellTypeA : IL 15 R} [ t ] \cdot {C}_{i}^{CellTypeA : IL 15 : CD 122} [ t ] - {k}_{re}^{IL 15 R : IL 15 : CD 122} \cdot {C}_{i}^{CellTypeA : IL 15 : IL 15 R : CD 122} [ t ] - {k}_{fe}^{CD 132 : IL 15 : IL 15 R : CD 122} \cdot {R}_{i}^{CellTypeA : CD 132} [ t ] \cdot {C}_{i}^{CellTypeA : IL 15 : IL 15 R : CD 122} [ t ] + {k}_{re}^{CD 132 : IL 15 : IL 15 R : CD 122} \cdot {C}_{i}^{CellTypeA : IL 15 : IL 15 R : CD 122 : CD 132} [ t ] + {k}_{e}^{CellTypeA : IL 15 : IL 15 : CD 122} \cdot {C}_{S}^{CellTypeA : IL 15 : IL 15 R : CD 122} [ t ] - {k}_{h}^{CellTypeA : IL 15 : IL 15 R : CD 122} \cdot {C}_{i}^{CellTypeA : IL 15 : IL 15 R : CD 122} [ t ] & 115\end{matrix}$$

$$\begin{matrix}\frac{d {C}_{S }^{CellTypeA : IL 15 : CD 122}}{d t} = {k}_{f}^{IL 15 : CD 122} \cdot {R}_{S}^{CellTypeA : CD 122} [ t ] \cdot {L}^{IL 15} [ t ] - {k}_{r}^{IL 15 : CD 122} \cdot {C}_{S}^{CellTypeA : IL 15 : CD 122} [ t ] - {k}_{f}^{CD 132 : IL 15 : CD 122} \cdot {R}_{S}^{CellTypeA : CD 132} [ t ] \cdot {C}_{S}^{CellTypeA : IL 15 : CD 122} [ t ] + {k}_{r}^{CD 132 : IL 15 : CD 122} \cdot {C}_{S}^{CellTypeA : IL 15 : CD 122 : CD 132} [ t ] - {k}_{f}^{IL 15 R : IL 15 : CD 122} \cdot {R}_{S}^{CellTypeA : IL 15 R} [ t ] \cdot {C}_{S}^{CellTypeA : IL 15 : CD 122} [ t ] + {k}_{r}^{IL 15 R : IL 15 : CD 122} \cdot {C}_{S }^{CellTypeA : IL 15 : IL 15 R : CD 122} [ t ] - {k}_{e}^{CellTypeA : IL 15 : CD 122} \cdot {C}_{S}^{CellTypeA : IL 15 : CD 122} [ t ] & 116\end{matrix}$$

$$\begin{matrix}\frac{d {C}_{i}^{CellTypeA : IL 15 : CD 122}}{d t} = {k}_{fe}^{IL 15 : CD 122} \cdot {R}_{i}^{CellTypeA : CD 122} [ t ] \cdot {L}_{i}^{CellTypeA : IL 15} [ t ] - {k}_{re}^{IL 15 : CD 122} \cdot {C}_{i}^{CellTypeA : IL 15 : CD 122} [ t ] - {k}_{fe}^{CD 132 : IL 15 : CD 122} \cdot {R}_{i}^{CellTypeA : CD 132} [ t ] \cdot {C}_{i}^{CellTypeA : IL 15 : CD 122} [ t ] + {k}_{re}^{CD 132 : IL 15 : CD 122} \cdot {C}_{i}^{CellTypeA : IL 15 : CD 122 : CD 132} [ t ] - {k}_{fe}^{IL 15 R : IL 15 : CD 122} \cdot {R}_{i}^{CellTypeA : IL 15 R} [ t ] \cdot {C}_{i}^{CellTypeA : IL 15 : CD 122} [ t ] + {k}_{re}^{IL 15 R : IL 15 : CD 122} \cdot {C}_{i }^{CellTypeA : IL 15 : IL 15 R : CD 122} [ t ] + {k}_{e}^{CellTypeA : IL 15 : CD 122} \cdot {C}_{S}^{CellTypeA : IL 15 : CD 122} [ t ] - {k}_{h}^{CellTypeA : IL 15 : CD 122} \cdot {C}_{i}^{CellTypeA : IL 15 : CD 122} [ t ] & 117\end{matrix}$$

$$\begin{matrix}\frac{d {C}_{S}^{CellTypeA : IL 15 : CD 122 : CD 132}}{d t} = {k}_{f}^{IL 15 : CD 122 : CD 132} \cdot {R}_{S}^{CellTypeA : CD 122 : CD 132} [ t ] \cdot {IL}^{IL 15} [ t ] - {k}_{r}^{IL 15 : CD 122 : CD 132} \cdot {C}_{S}^{CellTypeA : IL 15 : CD 122 : CD 132} [ t ] + {k}_{f}^{CD 132 : IL 15 : CD 122} \cdot {R}_{S}^{CellTypeA : CD 132} [ t ] \cdot {C}_{S}^{CellTypeA : IL 15 : CD 122} [ t ] - {k}_{r}^{CD 132 : IL 15 : CD 122} \cdot {C}_{S}^{CellTypeA : IL 15 : CD 122 : CD 132} [ t ] - {k}_{f}^{IL 15 R : IL 15 : CD 122 : CD 132} \cdot {R}_{S}^{CellTypeA : IL 15 R} [ t ] \cdot {C}_{S}^{CellTypeA : IL 15 : CD 122 : CD 132} [ t ] + {k}_{r}^{IL 15 R : IL 15 : CD 122 : CD 132} \cdot {C}_{S}^{CellTypeA : IL 15 : IL 15 R : CD 122 : CD 132} [ t ] - {k}_{e}^{CellTypeA : IL 15 : CD 122 : CD 132} \cdot {C}_{S}^{CellTypeA : IL 15 : CD 122 : CD 132} [ t ] & 118\end{matrix}$$

$$\begin{matrix}\frac{d {C}_{i}^{CellTypeA : IL 15 : CD 122 : CD 132}}{d t} = {k}_{fe}^{IL 15 : CD 122 : CD 132} \cdot {R}_{i}^{CellTypeA : CD 122 : CD 132} [ t ] \cdot {L}_{i}^{CellTypeA : IL 15} [ t ] - {k}_{re}^{IL 15 : CD 122 : CD 132} \cdot {C}_{i}^{CellTypeA : IL 15 : CD 122 : CD 132} [ t ] + {k}_{fe}^{CD 132 : IL 15 : CD 122} \cdot {R}_{i}^{CellTypeA : CD 132} [ t ] \cdot {C}_{i}^{CellTypeA : IL 15 : CD 122} [ t ] - {k}_{re}^{CD 132 : IL 15 : CD 122} \cdot {C}_{i}^{CellTypeA : IL 15 : CD 122 : CD 132} [ t ] - {k}_{fe}^{IL 15 R : IL 15 : CD 122 : CD 132} \cdot {R}_{i}^{CellTypeA : IL 15 R} [ t ] \cdot {C}_{i}^{CellTypeA : IL 15 : CD 122 : CD 132} [ t ] + {k}_{re}^{IL 15 R : IL 15 : CD 122 : CD 132} \cdot {C}_{i}^{CellTypeA : IL 15 : IL 15 R : CD 122 : CD 132} [ t ] + {k}_{e}^{CellTypeA : IL 15 : CD 122 : CD 132} \cdot {C}_{S}^{CellTypeA : IL 15 : CD 122 : CD 132} [ t ] - {k}_{h}^{CellTypeA : IL 15 : CD 122 : CD 132} \cdot {C}_{i}^{CellTypeA : IL 15 : CD 122 : CD 132} [ t ] & 119\end{matrix}$$

$$\begin{matrix}\frac{d {R}_{S}^{CellTypeA : IL 13 Ra 2}}{d t} = - {k}_{f}^{IL 13 : IL 13 Ra 2} \cdot {R}_{S}^{CellTypeA : IL 13 R a 2} [ t ] \cdot {L}^{IL 13} [ t ] + {k}_{r}^{IL 13 : IL 13 Ra 2} \cdot {C}_{S}^{CellTypeA : IL 13 : IL 13 Ra 2} [ t ] - {k}_{t}^{CellTypeA : IL 13 R a 2} \cdot {R}_{S}^{CellTypeA : IL 13 R a 2} [ t ] + {V}_{S}^{CellTypeA : IL 13 : Ra 2} + ( \begin{matrix}{k}_{syn}^{IL 13 Ra 2 : IL 2 : CD 25} \cdot {C}_{S}^{CellTypeA : IL 2 : CD 25 : CD 122 : CD 132} + \\ {k}_{syn}^{IL 13 Ra 2 : IL 2 : CD 122} \cdot {C}_{S}^{CellTypeA : IL 2 : CD 122 : CD 132} + \\ {k}_{syn}^{IL 13 Ra 2 : IL 4 : CD 213} \cdot {C}_{S}^{CellTypeA : IL 4 : CD 124 : CD 213} + \\ {k}_{syn}^{IL 13 Ra 2 : IL 4 : CD 132} \cdot {C}_{S }^{CellTypeA : IL 4 : CD 124 : CD 132} + \\ {k}_{syn}^{IL 13 Ra 2 : IL 7} \cdot {C}_{S}^{CellTypeA : IL 7 : CD 127 : CD 132} + \\ {k}_{syn}^{IL 13 Ra 2 : IL 9} \cdot {C}_{S}^{CellTypeA : IL 9 : CD 129 : CD 132} + \\ {k}_{syn}^{IL 13 Ra 2 : IL 13} \cdot {C}_{S}^{CellTypeA : IL 13 : CD 124 : CD 213} + \\ {k}_{syn}^{IL 13 Ra 2 : IL 15} \cdot {C}_{S}^{CellTypeA : IL 15 : IL 15 R : CD 122 : CD 132} + \\ {k}_{syn}^{IL 13 Ra 2 : TSLP} \cdot {C}_{S}^{CellTypeA : TSLP : CD 127 : TSLPR} + \\ {k}_{syn}^{IL 13 Ra 2 : IL 21} \cdot {C}_{S}^{CellTypeA : IL 21 : IL 21 R : CD 132}\end{matrix} ) & 120\end{matrix}$$

$$\begin{matrix}\frac{d {R}_{i}^{CellTypeA : IL 13 Ra 2}}{d t} = - {k}_{fe}^{IL 13 : IL 13 Ra 2} \cdot {R}_{i}^{CellTypeA : IL 13 Ra 2} [ t ] \cdot {L}_{i}^{CellTypeA : IL 13} [ t ] + {k}_{re}^{IL 13 : IL 13 Ra 2} \cdot {C}_{i}^{CellTypeA : IL 13 : IL 13 Ra 2} [ t ] + {k}_{t}^{CellTypeA : IL 13 Ra 2} \cdot {R}_{S}^{CellTypeA : IL 13 Ra 2} [ t ] - {k}_{h}^{CellTypeA : IL 13 Ra 2} \cdot {R}_{i}^{CellTypeA : IL 13 Ra 2} [ t ] & 121\end{matrix}$$

$$\begin{matrix}\frac{d {C}_{S}^{CellTypeA : IL 13 : IL 13 Ra 2}}{d t} = {k}_{f}^{IL 13 : IL 13 Ra 2} \cdot {R}_{S}^{CellTypeA : IL 13 Ra 2} [ t ] \cdot {L}^{IL 13} - {k}_{r}^{IL 13 : IL 13 R a 2} \cdot {C}_{S}^{CellTypeA : I L 13 : IL 13 Ra 2} [ t ] - {k}_{e}^{CellTypeA : IL 13 : IL 13 Ra 2} \cdot {C}_{S}^{CellTypeA : IL 13 : IL 13 Ra 2} [ t ] & 122\end{matrix}$$

$$\begin{matrix}\frac{d {C}_{i}^{CellTypeA : IL 13 : IL 13 Ra 2}}{d t} = {k}_{fe}^{IL 13 : IL 13 Ra 2} \cdot {R}_{i}^{CellTypeA : IL 13 Ra 2} [ t ] \cdot {L}_{i}^{CellTypeA : IL 13} - {k}_{re}^{IL 13 : IL 13 R a 2} \cdot {C}_{i}^{CellTypeA : IL 13 : IL 13 Ra 2} [ t ] + {k}_{e}^{CellTypeA : IL 13 : IL 13 R a 2} \cdot {C}_{S}^{CellTypeA : IL 13 : IL 13 Ra 2} [ t ] - {k}_{h}^{CellTypeA : IL 13 : IL 13 Ra 2} \cdot {C}_{i}^{CellTypeA : IL 13 : IL 13 Ra 2} [ t ] & 123\end{matrix}$$

$$\begin{matrix}\frac{d {C}_{S}^{CellTypeA : IL 15 : CD 132}}{d t} = {k}_{f}^{IL 15 : CD 132} \cdot {L}^{IL 15} [ t ] \cdot {R}_{S}^{CellTypeA : CD 132} [ t ] - {k}_{r}^{I 152 : CD 132} \cdot {C}_{S}^{CellTypeA : IL 15 : CD 132} [ t ] - {k}_{e}^{CellTypeA : IL 15 : CD 132} \cdot {C}_{S}^{CellTypeA : IL 15 : CD 132} [ t ] & 124\end{matrix}$$

$$\begin{matrix}\frac{d {C}_{i}^{CellTypeA : IL 15 : CD 132}}{d t} = {k}_{fe}^{IL 15 : CD 132} \cdot {L}_{i}^{CellTypeA : IL 15} [ t ] \cdot {R}_{i}^{CellTypeA : CD 132} [ t ] - {k}_{re}^{IL 15 : CD 132} \cdot {C}_{i}^{CellTypeA : IL 15 : CD 132} [ t ] + {k}_{e}^{CellTypeA : IL 15 : CD 132} \cdot {C}_{S}^{CellTypeA : IL 15 : CD 132} [ t ] - {k}_{h}^{CellTypeA : IL 15 : CD 132} \cdot {C}_{i}^{CellTypeA : IL 15 : CD 132} [ t ] & 125\end{matrix}$$

Using our model, we determine the extent of signaling on various cytokine receptor types and examine the likelihood that each will reach a given threshold, based on the initial values provided above.

The models enable us to address many unanswered questions. Relevant to the question of response to anti-CD25, we can quantitatively investigate whether blocking CD25 leads to the availability of more CD 132 for signaling from complexes between IL-7 and the IL-7 receptor.

In one embodiment, the model is utilized to predict the effect of an anti-CD25 therapy on a subject prior to treatment. A first set of input values is provided, and the model is utilized to analyze the level of cytokine signaling prior to treatment. Then, a second set of input values is utilized in which the number of available CD25 receptors is reduced to reflect the therapy's effect, and the model is utilized to determine the level of signaling on various cytokine receptors after the administration of the therapy. In one embodiment, if IL-7 signaling increases significantly, then it is predicted that CD56bright NK cells will expand and the subject will respond to the therapy.

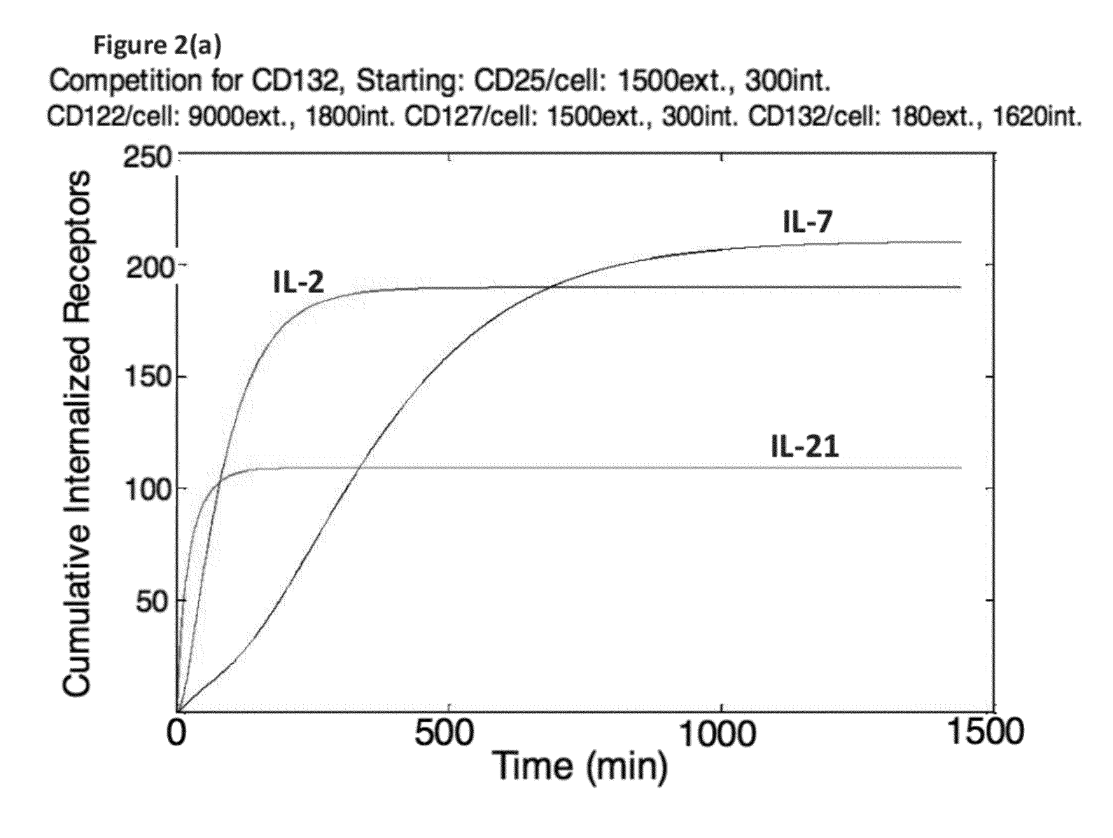

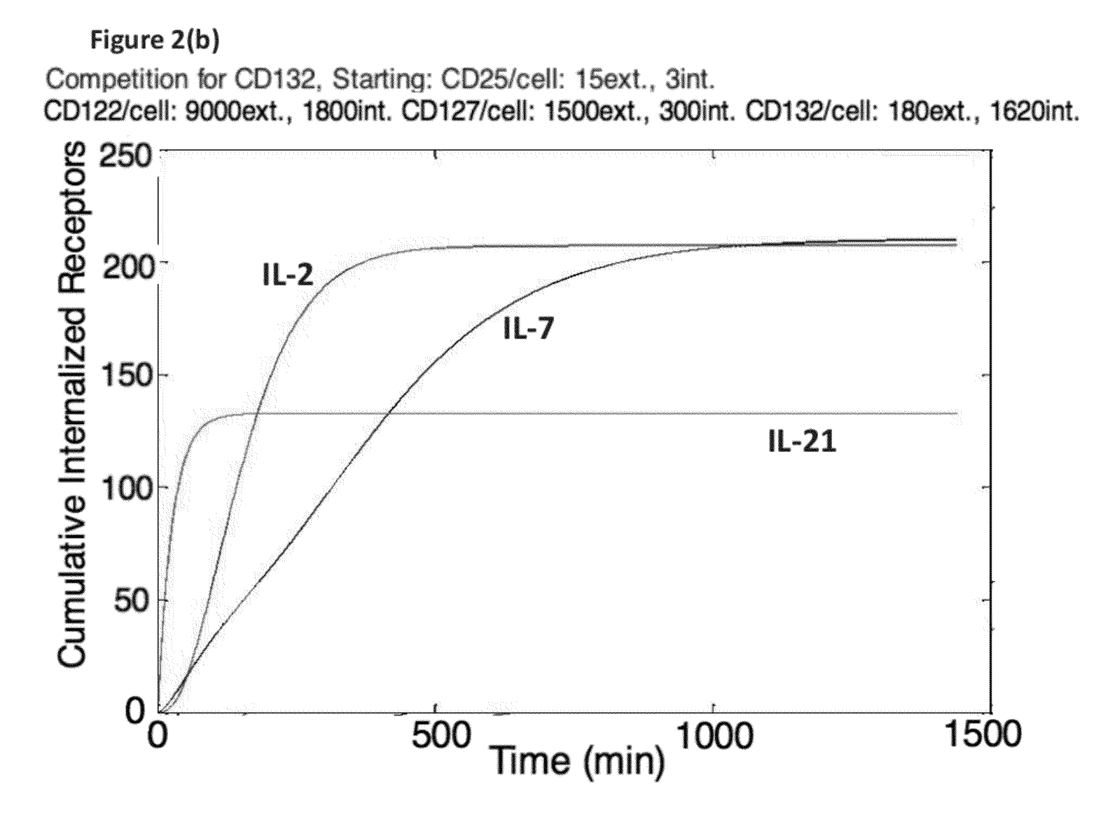

For example, the modeling shows that for a subject represented by a certain set of input values, the quantity of cytokine will be the limiting factor in cytokine signaling. FIG. 2(a) shows an initial example, with concentrations of IL-2, IL-7, and IL-21 set to 0.1 nM each. In this case, the signaling plateaus occur when each cytokine runs out. When we provide a second set of values in which the amount of CD25 has been reduced to reflect the expected effect of the therapy, as shown in FIG. 2(b), there is little effect on the level of IL-7 or IL-21 signaling, because the concentration of cytokine and not the receptor levels remain the limiting factor. In one specific embodiment, this subject would be predicted to be a non-responder to anti-CD25.

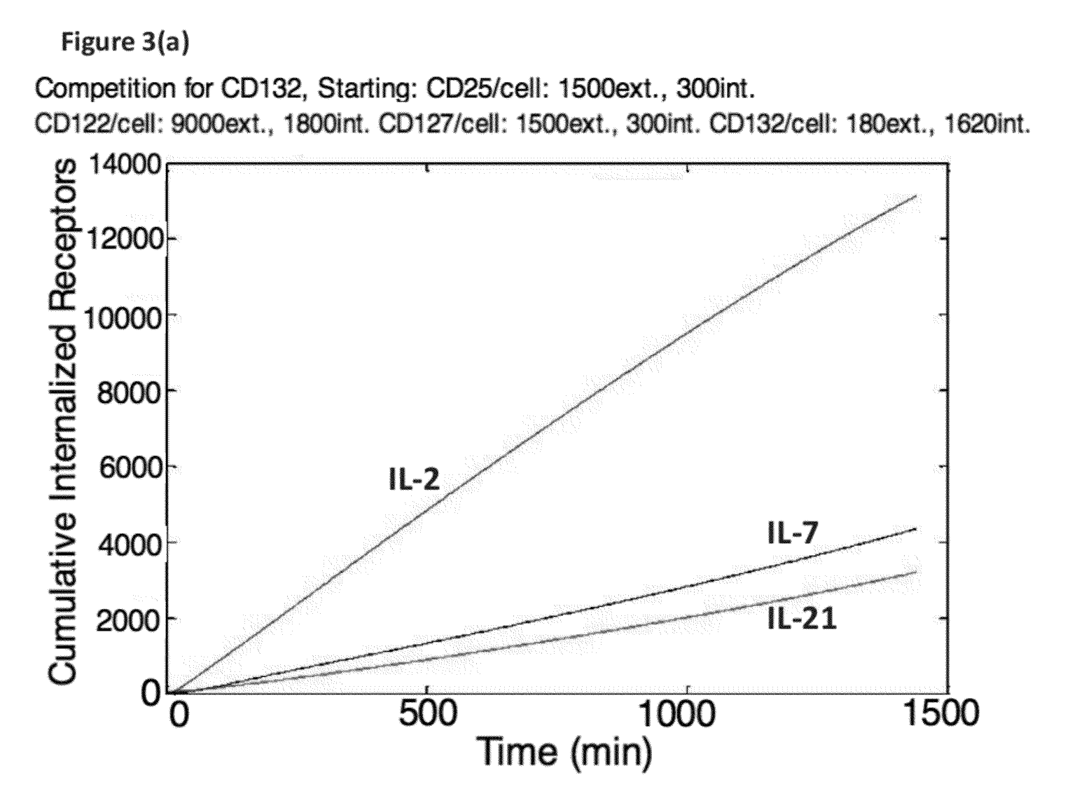

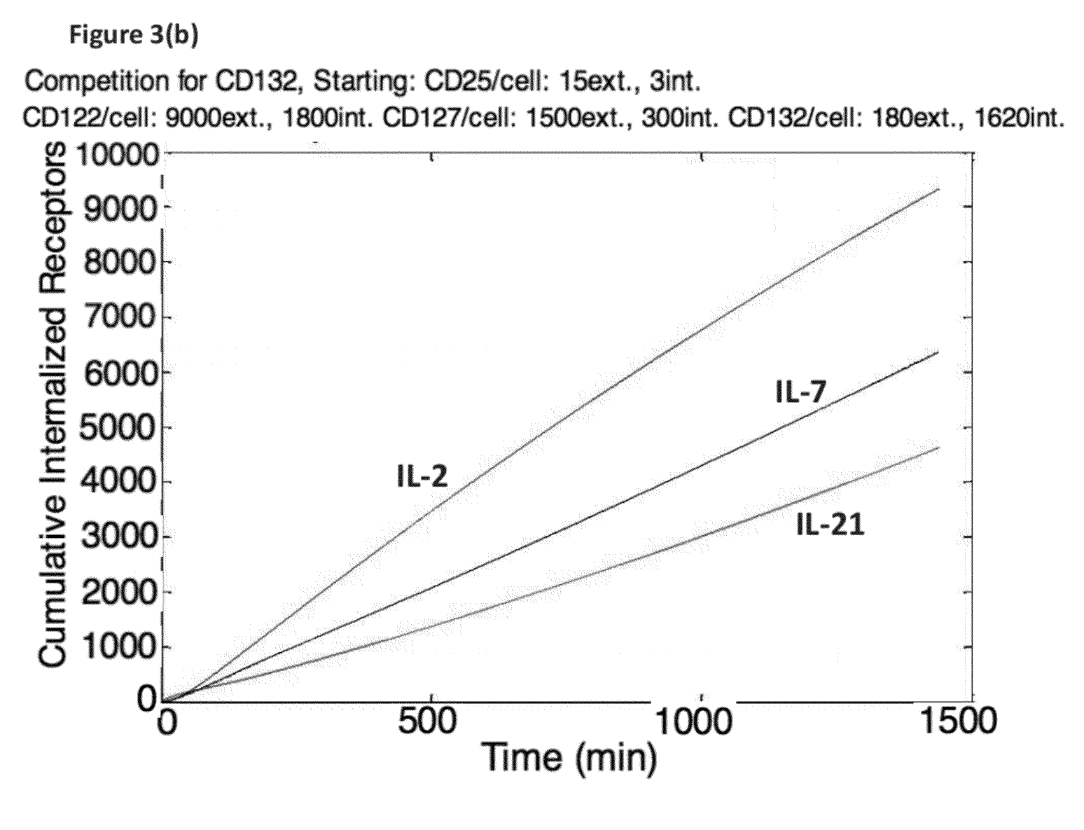

In contrast, FIG. 3(a) shows the out put of the model for a different set of input values representing a different patient, in which the concentrations of IL-2, IL-7, and IL-21 are significantly higher at 10 nM each. In this case, when a second set of input values is provided with the levels of CD25 reduced to reflect the effect of an anti-CD25 therapy, as shown in FIG. 3(b), the level of IL-2 signaling drops as expected and the level of IL-7 signaling increases significantly. In one specific embodiment, this patient would be predicted to respond to an anti-CD25 therapy.

### Example 2

### Predicting the Effects of a BAFF Antagonist on a Subject Prior to Treatment

In one embodiment, the therapy is a BAFF antagonist. The therapy's target receptor subunits are BAFF-R, APRIL, and TACI. The ligands that interacts with the therapy's target receptor subunits are BAFF and APRIL. The receptor subunits that interact with the therapy's target receptor subunits are none. The ligands that interact with receptor subunits that interact with the therapy's target receptor subunits are none. The receptor subunits that interact with receptor subunits and ligands that bind to receptor subunits that interact with receptor subunits are none. A receptor subunit that binds to a ligand is HSPG.

### Methods and Methods

In one embodiment, assaying a sample further comprises utilizing the following protocol adapted from [Cesana, 2006], [Venken, 2008], [Hatjiharissi, 2007]

Blood Collection: Whole blood is collected in heparin-containing Vacutainer tubes (BD or equivalent).

Determining absolute cell counts: TruCount Tubes (BD Biosciences or equivalent) are utilized to determine accurate cell counts. Cells are stained with fluorescently labeled antibodies against the following maker (human). CD19.

B Cell counts are determined using a FACS Aria or FACS Calibur (BD Biosciences or equivalent).

Isolating peripheral blood mononuclear cells (PBMCs): PBMCs are isolated from whole blood using Ficoll density gradient centrifugation (Histopaque, Sigma-Aldrich; Amersham; or equivalent).

Cell sorting: Relevant subsets are separated. Cells are stained with fluorescently labeled antibodies against the following marker (human). CD19. The B Cells are defined as: CD 19⁺. B cells are isolated using a FACS Aria, FACS Calibur (BD Biosciences) or equivalent.

CELL SURFACE Receptor Quantification: The FACS-sorted B cells collected above are stained with phycoerythrin (PE) conjugated antibodies against one or more of the following targets: BAFF-R, APRIL, BCMA, and HSPG.

One or more of the following reagents (or equivalent) is utilized:

PE Anti-human CD268 (BAFF-R) Antibody (Catalog Number 316905, BioLegend, San Diego, Calif. USA) or PE Mouse Anti-Human BAFF Receptor (Catalog Number 558097 Becton Dickinson Biosciences, San Jose, Calif. USA)

Polyclonal Anti-human BCMA/TNFRSF17-Phycoerythrin (Catalog Number: FAB193P, R&D Systems, Minneapolis, Minn. USA).

Monoclonal Anti-human TACI/TNFRSF13B/CD267-Phycoerythrin (Catalog Number: FAB1741P, R&D Systems, Minneapolis, Minn. USA) or PE Rat anti-Human CD267 (Catalog Number 558414 Becton Dickinson Biosciences, San Jose, Calif. USA).

Anti-HSPG antibody 3G10 (Seikagaku, Japan).

INTRACELLULAR AND CELL SURFACE Receptor Quantification: After quantifying only the cell surface receptors using the above procedure, the cells can then be permeabilized using CytoFix/Cytoperm (Catalog Number 554722, Becton Dickinson Biosciences, San Jose, Calif. USA) or equivalent. Then the above “Cell Surface Receptor Quantification” procedure can be repeated, but in this case will yield the total (intracellular+cell surface) receptor levels. The intracellular levels can then be calculated for each receptor by subtracting the surface levels from the total levels as in [Hodge, 2000].

Measure Cytokine Levels: Serum levels of BAFF and APRIL can be determined using an ELISA kit such as the Quantikine Human BAFF/BLyS/TNFSF13B Immunoassay (Catalog Number DBLYS0, SBLYS0, or PDBLYS, R&D Systems, Minneapolis, Minn. USA), and APRIL Human ELISA Kit (Catalog Number KHC3051, Invitrogen/Life Technologies, Carlsbad Calif. USA).

In one embodiment, the measurements resulting from the above protocols comprise the initial conditions that are input into the computational model as defined in the table below. In this example, Cell Type A is defined to be B cells, but in other embodiments it could be other cell types, or repeated for multiple cell types. Note that BR3 is the BAFF receptor.

Table of Measured Parameters: Initial Conditions (t = 0)

| parameter | Definition |
|---|---|
| R_{S}^{CellTypeA:BR3}[t = 0] | Surface BR3 receptor subunits per Cell Type A |
| R_{S}^{CellTypeA:TACI}[t = 0] | Surface TACI receptors per Cell Type A |
| R_{S}^{CellTypeA:BCMA}[t = 0] | Surface BCMA receptors per Cell Type A |
| R_{S}^{CellTypeA:HSPG}[t = 0] | Surface HSPG per Cell Type A |
| Rᵢ^{CellTypeA:BR3}[t = 0] | Internal BR3 receptor subunits per Cell Type A |
| Rᵢ^{CellTypeA:TACI}[t = 0] | Internal TACI receptors per Cell Type A |
| Rᵢ^{CellTypeA:BCMA}[t = 0] | Internal BCMA receptors per Cell Type A |
| Rᵢ^{CellTypeA:HSPG}[t = 0] | Internal HSPG per Cell Type A |
| L^{BAFF}[t = 0] | Concentration of BAFF in serum |
| L^{APRIL}[t = 0] | Concentration of APRIL in serum |
| Y^{CellTypeA}[t = 0] | Cell count of Cell Type A |

In one particular embodiment, the following format is used to define relevant parameters to represent interactions:

kf_X_Y is defined as the surface forward rate constant of X binding to Y.
kr_X_Y is defined as the surface reverse rate constant of X binding to Y.
kfe_X_Y is defined as the internal forward rate constant of X binding to Y.
kre_X_Y is defined as the internal reverse rate constant of X binding to Y.
ksyn_X_Y is defined as the rate at which X in synthesized in response to the binding event indicated in Y.
kt_celltypea_X is defined as the constitutive internalization rate of X on cell type a.
ke_celltypea_X is defined as the internalization rate of X on cell type a.
kh_celltypea_X is defined as the degradation rate of X on cell type a.
kx_celltypea_X is defined as the recycling rate of X on cell type a.
vs_celltypea_X is defined as the rate at which X is synthesized on cell type a.

In one particular embodiment, using the above format to define parameters, the following parameters are provided from literature values as indicated, although in other embodiments other values may be used or the values may be measured:

kr_baff_br3=(1.3e-2)*60;% min ̂-1 [Day, 2005]

kf_baff_br3=kr_baff_br3/16;% nM, [Treml, 2009]

kr_baff_taci=(1.3e-2)*60;% min ̂-1 TEMP: assume same as br3

kf_baff_taci=kr_baff_taci/0.2;% nM, [Treml, 2009]

kr_april_taci=(1.3e-2)*60;% min ̂-1 TEMP: assume same as br3

kf_april_taci=kr_april_taci/6.4;% nM, [Treml, 2009] kr_baff_bcma=(1e-1)*60;% min ̂-1 [Day, 2005]

kf_baff_bcma=kr_baff_bcma/1600;% nM, [Treml, 2009] kr_april_bcma=(5.6e-3)*60;% min ̂-1 [Day, 2005]

kf_april_bcma=kr_april_bcma/16;% nM, [Treml, 2009]

kr_april_hspg=(1.3e-2)*60;% min ̂-1 TEMP: assume same as br3

kf_april_hspg=kr_april_hspg/1600;% nM TEMP: assume same as BAFF-BCMA

kre_baff_br3=8*kr_baff_br3;% min ̂-1 TEMP: same proportion as IL-2 [Fallon, 2000]

kfe_baff_br3=kre_baff_br3/1000;% nM̂-1,min ̂-1 TEMP: same proportion as IL-2 [Fallon, 2000]

kre_baff_taci=8*kr_baff_taci;% min ̂-1 TEMP: same proportion as IL-2 [Fallon, 2000]

kfe_baff_taci=kre_baff_taci/1000;% nM̂-1,min ̂-1 TEMP: same proportion as IL-2 [Fallon, 2000]

kre_april_taci=8*kr_april_taci;% min ̂-1 TEMP: same proportion as IL-2 [Fallon, 2000]

kfe_april_taci=kre_april_taci/1000;% nM̂-1,min ̂-1 TEMP: same proportion as IL-2 [Fallon, 2000]

kre_baff_bcma=8*kr_baff_bcma;% min ̂-1 TEMP: same proportion as IL-2 [Fallon, 2000]

kfe_baff_bcma=kre_baff_bcma/1000;% nM̂-1,min ̂-1 TEMP: same proportion as IL-2 [Fallon, 2000]

kre_april_bcma=8*kr_april_bcma;% min ̂-1 TEMP: same proportion as IL-2 [Fallon, 2000]

kfe_april_bcma=kre_april_bcma/1000;% nM̂-1,min ̂-1 TEMP: same proportion as IL-2 [Fallon, 2000]

kre_april_hspg=8*kr_april_hspg;% min ̂-1 TEMP: same proportion as IL-2 [Fallon, 2000]

kfe_april_hspg=kre_april_hspg/1000;% nM̂-1,min ̂-1 TEMP: same proportion as IL-2 [Fallon, 2000]

%Constitutive Internalization

kt_celltypea_br3=0.007;% min ̂-1 TEMP: same as IL-2 [Fallon, 2000]

kt_celltypea_taci=0.007;% min ̂-1 TEMP: same as IL-2 [Fallon, 2000]

kt_celltypea_bcma=0.007;% min ̂-1 TEMP: same as IL-2 [Fallon, 2000]

kt_celltypea_hspg=0.007;% min ̂-1 TEMP: same as IL-2 [Fallon, 2000]

%Constitutive Receptor Synthesis Rate

vs_celltypea_taci=kt_celltypea_taci*Y0(3);%Balance internalization, maintain initial number

vs_celltypea_br3=kt_celltypea_br3*Y0(1);% Balance internalization, maintain initial number

vs_celltypea_bcma=kt_celltypea_bcma*Y0(5);% Balance internalization, maintain initial number

vs_celltypea_hspg=kt_celltypea_hspg*Y0(7);% Balance internalization, maintain initial number

%vs_celltypea_taci=11;% min ̂-1 TEMP: same as IL-2 [Fallon, 2000]

%vs_celltypea_br3=11;% min ̂-1 TEMP: same as IL-2 [Fallon, 2000]

%vs_celltypea_bcma=11;% min ̂-1 TEMP: same as IL-2 [Fallon, 2000]

%vs_celltypea_hspg=11;% min ̂-1 TEMP: same as IL-2 [Fallon, 2000]

%Induced Receptor Synthesis Rate

ksyn_celltypea_baff_br3=0.0011;% min ̂-1 TEMP: same as IL-2 [Fallon, 2000]

ksyn_celltypea_baff_taci=0.0011;% min ̂-1 TEMP: same as IL-2 [Fallon, 2000]

ksyn_april_taci=0.0011;% min ̂-1 TEMP: same as IL-2 [Fallon, 2000]

ksyn_celltypea_baff_bcma=0.0011;% min ̂-1 TEMP: same as IL-2 [Fallon, 2000]

ksyn_celltypea_april_bcma=0.0011;% min ̂-1 TEMP: same as IL-2 [Fallon, 2000]

ksyn_celltypea_april_hspg=0.0011;% min ̂-1 TEMP: same as IL-2 [Fallon, 2000]

%Degradation Rate Constant

kh_celltypea_br3=0.035;% min ̂-1 TEMP: same as IL-2 [Fallon, 2000]

kh_celltypea_baff_br3=0.035;% min ̂-1 TEMP: same as IL-2 [Fallon, 2000]

kh_celltypea_taci=0.035;% min ̂-1 TEMP: same as IL-2 [Fallon, 2000]

kh_celltypea_bcma=0.035;% min ̂-1 TEMP: same as IL-2 [Fallon, 2000]

kh_celltypea_hspg=0.035;% min ̂-1 TEMP: same as IL-2 [Fallon, 2000]

kh_celltypea_baff_taci=0.035;% min ̂-1 TEMP: same as IL-2 [Fallon, 2000]

kh_celltypea_baff_bcma=0.035;% min ̂-1 TEMP: same as IL-2 [Fallon, 2000]

kh_celltypea_april_taci=0.035;% min ̂-1 TEMP: same as IL-2 [Fallon, 2000]

kh_celltypea_april_bcma=0.035;% min ̂-1 TEMP: same as IL-2 [Fallon, 2000]

kh_celltypea_april_hspg=0.035;% min ̂-1 TEMP: same as IL-2 [Fallon, 2000]

%Internalization Rate Constant

ke_celltypea_baff_br3=0.04;% min ̂-1 TEMP: same as IL-2 [Fallon, 2000]

ke_celltypea_baff_taci=0.04;% min ̂-1 TEMP: same as IL-2 [Fallon, 2000]

ke_celltypea_baff_bcma=0.04;% min ̂-1 TEMP: same as IL-2 [Fallon, 2000]

ke_celltypea_april_taci=0.04;% min ̂-1 TEMP: same as IL-2 [Fallon, 2000]

ke_celltypea_april_bcma=0.04;% min ̂-1 TEMP: same as IL-2 [Fallon, 2000]

ke_celltypea_april_hspg=0.04;% min ̂-1 TEMP: same as IL-2 [Fallon, 2000]

other_factors_affecting_br3_synthesis=0;%TEMP

other_factors_affecting_taci_synthesis=0;%TEMP

other_factors_affecting_bcma_synthesis=0;%TEMP

other_factors_affecting_hspg_synthesis=0;%TEMP

%Recycling Rate Constant

kx_celltypea_baff=0.15;% min ̂-1 TEMP: same as IL-2 [Fallon, 2000]

kx_celltypea_april=0.15;% min ̂-1 TEMP: same as IL-2 [Fallon, 2000]

ye=10̂-14;% L/cell [Fallon, 2000]total endosomal volume

na=6.02e23/(10̂9); % Avogadro's Number, units in nM

In one embodiment, the method for assessing the provided values comprises the following equations:

$$\begin{matrix}\frac{d {R}_{S}^{CellTypeA : BR 3}}{d t} = - {k}_{f}^{BAFF : BR 3} \cdot {L}^{BAFF} [ t ] \cdot {R}_{S}^{CellTypeA : BR 3} [ t ] + {k}_{r}^{BAff : BR 3} \cdot {C}_{S}^{CellTypeA : BAFF : BR 3} [ t ] - {k}_{t}^{CellTypeA : BR 3} \cdot {R}_{S}^{CellTypeA : BR 3} [ t ] + {V}_{S}^{CellTypeA : BR 3} + {k}_{syn}^{CellTypeA : BAFF : BR 3} [ t ] \cdot {C}_{S}^{CellTypeA : BAFF : BR 3} [ t ] + ( other\_factors \_affecting \_BR 3 \_synthesis ) & 1\end{matrix}$$

$$\begin{matrix}\frac{d {R}_{i}^{CellTypeA : BR 3}}{d t} = - {k}_{fe}^{BAFF : BR 3} \cdot {L}_{i}^{CellTypeA : BAFF} [ t ] \cdot {R}_{i}^{CellTypeA : BR 3} [ t ] + {k}_{re}^{BAFF : BR 3} \cdot {C}_{i}^{CellTypeA : BAFF : BR 3} [ t ] + {k}_{t}^{CellTypeA : BR 3} \cdot {R}_{S}^{CellTypeA : BR 3} [ t ] - {k}_{h}^{CellTypeA : BR 3} \cdot {R}_{i}^{CellTypeA : BR 3} [ t ] & 2\end{matrix}$$

$$\begin{matrix}\frac{d {R}_{S}^{CellTypeA : TACI}}{d t} = - {k}_{f}^{BAFF : TACI} \cdot {L}^{BAFF} [ t ] \cdot {R}_{S}^{CellTypeA : TACI} [ t ] + {k}_{r}^{BAFF : TACI} \cdot {C}_{S}^{CellTypeA : BAFF : TACI} [ t ] - {k}_{f}^{APRIL : TACI} \cdot {L}^{APRIL} [ t ] \cdot {R}_{S}^{CellTypeA : TACI} [ t ] + {k}_{r}^{APRIL : TACI} \cdot {C}_{S}^{CellTypeA : APRIL : TACI} [ t ] - {k}_{t}^{CellTypeA : TACI} \cdot {R}_{S}^{CellTypeA : TACI} [ t ] + {V}_{S}^{CellTypeA : TACI} + {k}_{syn}^{CellTypeA : BAFF : TACI} \cdot {C}_{S}^{CellTypeA : BAFF : TACI} [ t ] + {k}_{syn}^{CellTypeA : APRIL : TACI} \cdot {C}_{S}^{CellTypeA : APRIL : TACI} [ t ] + ( other\_factors \_affecting \_TACI \_synthesis ) & 3\end{matrix}$$

$$\begin{matrix}\frac{d {R}_{i}^{CellTypeA : TACI}}{d t} = - {k}_{fe}^{BAFF : TACI} \cdot {L}_{i}^{CellTypeA : BAFF} [ t ] \cdot {R}_{i}^{CellTypeA : TACI} [ t ] + {k}_{re}^{BAFF : TACI} \cdot {C}_{i}^{CellTypeA : BAFF : TACI} [ t ] - {k}_{fe}^{APRIL : TACI} \cdot {L}_{i}^{CellTypeA : APRIL} [ t ] \cdot {R}_{i}^{CellTypeA : TACI} [ t ] + {k}_{re}^{APRIL : TACI} \cdot {C}_{i}^{CellTypeA : APRIL : TACI} [ t ] + {k}_{t}^{CellTypeA : TACI} \cdot {R}_{S}^{CellTypeA : TACI} [ t ] - {k}_{h}^{CellTypeA : TACI} \cdot {R}_{i}^{CellTypeA : TACI} [ t ] & 4\end{matrix}$$

$$\begin{matrix}\frac{d {R}_{S}^{CellTypeA : BCMA}}{d t} = - {k}_{f}^{BAFF : BCMA} \cdot {L}^{BAFF} [ t ] \cdot {R}_{S}^{CellTypeA : BCMA} [ t ] + {k}_{r}^{BAFF : BCMA} \cdot {C}_{S}^{CellTypeA : BAFF : BCMA} [ t ] - {k}_{f}^{APRIL : BCMA} \cdot {L}^{APRIL} [ t ] \cdot {R}_{S}^{CellTypeA : BCMA} [ t ] + {k}_{r}^{APRIL : BCMA} \cdot {C}_{S}^{CellTypeA : APRIL : BCMA} [ t ] - {k}_{t}^{CellTypeA : BCMA} \cdot {R}_{S}^{CellTypeA : BCMA} [ t ] + {V}_{S}^{CellTypeA : BCMA} [ t ] + {k}_{syn}^{CellTypeA : BAFF : BCMA} \cdot {C}_{S}^{CellTypeA : BAFF : BCMA} [ t ] + {k}_{syn}^{CellTypeA : APRIL : BCMA} \cdot {C}_{S}^{CellTypeA : APRIL : BCMA} [ t ] + ( other\_factors \_affecting \_BCMA \_synthesis ) & 5\end{matrix}$$

$$\begin{matrix}\frac{d {R}_{i}^{CellTypeA : BCMA}}{d t} = - {k}_{fe}^{BAFF : BCMA} \cdot {L}_{i}^{CellTypeA : BAFF} [ t ] \cdot {R}_{i}^{CellTypeA : BCMA} [ t ] + {k}_{re}^{BAFF : BCMA} \cdot {C}_{i}^{CellTypeA : BAFF : BCMA} [ t ] - {k}_{fe}^{APRIL : BCMA} \cdot {L}_{i}^{CellTypeA : APRIL} [ t ] \cdot {R}_{i}^{CellTypeA : BCMA} [ t ] + {k}_{re}^{APRIL : BCMA} \cdot {C}_{i}^{CellTypeA : APRIL : BCMA} [ t ] + {k}_{t}^{CellTypeA : BCMA} \cdot {R}_{S}^{CellTypeA : BCMA} [ t ] - {k}_{h}^{CellTypeA : BCMA} \cdot {R}_{i}^{CellTypeA : BCMA} [ t ] & 6\end{matrix}$$

$$\begin{matrix}\frac{d {R}_{S}^{CellTypeA : HSPG}}{d t} = - {k}_{f}^{APRIL : HSPG} \cdot {L}^{APRIL} [ t ] \cdot {R}_{S}^{CellTypeA : HSPG} [ t ] + {k}_{r}^{APRIL : HSPG} \cdot {C}_{S}^{CellTypeA : APRIL : HSPG} [ t ] - {k}_{t}^{CellTypeA : HSPG} \cdot {R}_{S}^{CellTypeA : HSPG} [ t ] + {V}_{S}^{CellTypeA : HSPG} + {k}_{syn}^{CellTypeA : APRIL : HSPG} \cdot {C}_{S}^{CellTypeA : APRIL : HSPG} [ t ] + ( other\_factors \_affecting \_HSPG \_synthesis ) & 7\end{matrix}$$

$$\begin{matrix}\frac{d {R}_{i}^{CellTypeA : HSPG}}{d t} = - {k}_{fe}^{APRIL : HSPG} \cdot {L}_{i}^{CellTypeA : APRIL} [ t ] \cdot {R}_{i}^{CellTypeA : HSPG} [ t ] + {k}_{re}^{APRIL : HSPG} \cdot {C}_{i}^{CellTypeA : APRIL : HSPG} [ t ] + {k}_{t}^{CellTypeA : HSPG} \cdot {R}_{S}^{CellTypeA : HSPG} [ t ] - {k}_{h}^{CellTypeA : HSPG} \cdot {R}_{i}^{CellTypeA : HSPG} [ t ] & 8\end{matrix}$$

$$\begin{matrix}\frac{d {C}_{S}^{CellTypeA : BAFF : BR 3}}{d t} = {k}_{f}^{BAFF : BR 3} \cdot {L}^{BAFF} [ t ] \cdot {R}_{S}^{CellTypeA : BR 3} [ t ] - {k}_{r}^{BAFF : BR 3} \cdot {C}_{S}^{CellTypeA : BAFF : BR 3} [ t ] - {k}_{e}^{CellTypeA : BAFF : BR 3} \cdot {C}_{S}^{CellTypeA : BAFF : BR 3} [ t ] & 9\end{matrix}$$

$$\begin{matrix}\frac{d {C}_{i}^{CellTypeA : BAFF : BR 3}}{d t} = {k}_{fe}^{BAFF : BR 3} \cdot {L}_{i}^{CellTypeA : BAFF} [ t ] \cdot {R}_{i}^{CellTypeA : BR 3} [ t ] - {k}_{re}^{BAFF : BR 3} \cdot {C}_{i}^{CellTypeA : BAFF : BR 3} [ t ] + {k}_{e}^{CellTyprA : BAFF : BR 3} \cdot {C}_{S}^{CellTypeA : BAFF : BR 3} [ t ] - {k}_{h}^{CellTypeA : BAFF : BR 3} \cdot {C}_{i}^{CellTypeA : BAFF : BR 3} [ t ] & 10\end{matrix}$$

$$\begin{matrix}\frac{d {C}_{S}^{CellTypeA : BAFF : TACI}}{d t} = {k}_{f}^{BAFF : TACI} \cdot {L}^{BAFF} [ t ] \cdot {R}_{S}^{CellTypeA : TACI} [ t ] - {k}_{r}^{BAFF : TACI} \cdot {C}_{S}^{CellTypeA : BAFF : TACI} [ t ] - {k}_{e}^{CellTypeA : BAFF : TACI} \cdot {C}_{S}^{CellTypeA : BAFF : TACI} [ t ] & 11\end{matrix}$$

$$\begin{matrix}\frac{d {C}_{i}^{CellTypeA : BAFF : TACI}}{d t} = {k}_{fe}^{BAFF : TACI} \cdot {L}_{i}^{CellTypeA : BAFF} [ t ] \cdot {R}_{i}^{CellTypeA : TACI} [ t ] - {k}_{re}^{BAFF : TACI} \cdot {C}_{i}^{CellTypeA : BAFF : TACI} [ t ] + {k}_{e}^{CellTypeA : BAFF : TACI} \cdot {C}_{S}^{CellTypeA : BAFF : TACI} [ t ] - {k}_{h}^{CellTypeA : BAFF : TACI} \cdot {C}_{i}^{CellTypeA : BAFF : TACI} [ t ] & 12\end{matrix}$$

$$\begin{matrix}\frac{d {C}_{S}^{CellTypeA : BAFF : BCMA}}{d t} = {k}_{f}^{BAFF : BCMA} \cdot {L}^{BAFF} [ t ] \cdot {R}_{S}^{CellTypeA : BCMA} [ t ] - {k}_{r}^{BAFF : BCMA} \cdot {C}_{S}^{CellTypeA : BAFF : BCMA} [ t ] - {k}_{e}^{CellTypeA : BAFF : BCMA} \cdot {C}_{S}^{CellTypeA : BAFF : BCMA} [ t ] & 13\end{matrix}$$

$$\begin{matrix}\frac{d {C}_{i}^{CellTypeA : BAFF : BCMA}}{d t} = {k}_{fe}^{BAFF : BCMA} \cdot {L}_{i}^{CellTypeA : BAFF} [ t ] \cdot {R}_{i}^{CellTypeA : BCMA} [ t ] - {k}_{re}^{BAFF : BCMA} \cdot {C}_{i}^{CellTypeA : BAFF : BCMA} [ t ] + {k}_{e}^{CellTypeA : BAFF : BCMA} \cdot {C}_{S}^{CellTypeA : BAFF : BCMA} [ t ] - {k}_{h}^{CellTypeA : BAFF : BCMA} \cdot {C}_{i}^{CellTypeA : BAFF : BCMA} [ t ] & 14\end{matrix}$$

$$\begin{matrix}\frac{d {C}_{S}^{CellTypeA : APRIL : TACI}}{d t} = {k}_{f}^{APRIL : TACI} \cdot {L}^{APRIL} [ t ] \cdot {R}_{S}^{CellTypeA : TACI} [ t ] - {k}_{r}^{APRIL : TACI} \cdot {C}_{S}^{CellTypeA : APRIL : TACI} [ t ] - {k}_{e}^{CellTypeA : APRIL : TACI} \cdot {C}_{S}^{CellTypeA : APRIL : TACI} [ t ] & 15\end{matrix}$$

$$\begin{matrix}\frac{d {C}_{i}^{CellTypeA : APRIL : TACI}}{d t} = {k}_{fe}^{APRIL : TACI} \cdot {L}_{i}^{CellTypeA : APRIL} [ t ] \cdot {R}_{i}^{CellTypeA : TACI} [ t ] - {k}_{re}^{APRIL : TACI} \cdot {C}_{i}^{CellTypeA : APRIL : TACI} [ t ] + {k}_{e}^{CellTypeA : APRIL : TACI} \cdot {C}_{S}^{CellTypeA : APRIL : TACI} [ t ] - {k}_{h}^{CellTypeA : APRIL : TACI} \cdot {C}_{i}^{CellTypeA : APRIL : TACI} [ t ] & 16\end{matrix}$$

$$\begin{matrix}\frac{d {C}_{S}^{CellTypeA : APRIL : BCMA}}{d t} = {k}_{f}^{APRIL : BCMA} \cdot {L}^{APRIL} [ t ] \cdot {R}_{S}^{CellTypeA : BCMA} [ t ] - {k}_{r}^{APRIL : BCMA} \cdot {C}_{S}^{CellTypeA : APRIL : BCMA} [ t ] - {k}_{e}^{CellTypeA : APRIL : BCMA} \cdot {C}_{S}^{CellTypeA : APRIL : BCMA} [ t ] & 17\end{matrix}$$

$$\begin{matrix}\frac{d {C}_{i}^{CellTypeA : APRIL : BCMA}}{d t} = {k}_{fe}^{APRIL : BCMA} \cdot {L}_{i}^{CellTypeA : APRIL} [ t ] \cdot {R}_{i}^{CellTypeA : BCMA} [ t ] - {k}_{re}^{APRIL : BCMA} \cdot {C}_{i}^{CellTypeA : APRIL : BCMA} [ t ] + {k}_{e}^{CellTypeA : APRIL : BCMA} \cdot {C}_{S}^{CellTypeA : APRIL : BCMA} [ t ] - {k}_{h}^{CellTypeA : APRIL : BCMA} \cdot {C}_{i}^{CellTypeA : APRIL : BCMA} [ t ] & 18\end{matrix}$$

$$\begin{matrix}\frac{d {C}_{S}^{CellTypeA : APRIL : HSPG}}{d t} = {k}_{f}^{APRIL : HSPG} \cdot {L}^{APRIL} [ t ] \cdot {R}_{S}^{CellTypeA : HSPG} [ t ] - {k}_{r}^{APRIL : HSPG} \cdot {C}_{S}^{CellTypeA : APRIL : HSPG} [ t ] - {k}_{e}^{CellTypeA : APRIL : HSPG} \cdot {C}_{S}^{CellTypeA : APRIL : HSPG} [ t ] & 19\end{matrix}$$

$$\begin{matrix}\frac{d {C}_{i}^{CellTypeA : APRIL : HSPG}}{d t} = {k}_{fe}^{APRIL : HSPG} \cdot {L}_{i}^{CellTypeA : APRIL} [ t ] \cdot {R}_{i}^{CellTypeA : HSPG} [ t ] - {k}_{re}^{APRIL : HSPG} \cdot {C}_{i}^{CellTypeA : APRIL : HSPG} [ t ] + {k}_{e}^{CellTypeA : APRIL : HSPG} \cdot {C}_{S}^{CellTypeA : APRIL : HSPG} [ t ] - {k}_{h}^{CellTypeA : APRIL : HSPG} \cdot {C}_{i}^{CellTypeA : APRIL : HSPG} [ t ] & 20\end{matrix}$$

$$\begin{matrix}\frac{d {L}^{BAFF}}{d t} = ( - {k}_{f}^{BAFF : BR 3} \cdot {R}_{S}^{CellTypeA : BR 3} [ t ] \cdot {L}^{BAFF} + {k}_{r}^{BAFF : BR 3} \cdot {C}_{S}^{CellTypeA : BAFF : BR 3 } [ t ] - {k}_{f}^{BAFF : TACI} \cdot {R}_{S}^{CellTypeA : TACI} [ t ] \cdot {L}^{BAFF} + {k}_{r}^{BAFF : TACI} \cdot {C}_{S}^{CellTypeA : BAFF : TACI} [ t ] - {k}_{f}^{BAFF : BCMA} \cdot {R}_{S}^{CellTypeA : BCMA} [ t ] \cdot {L}^{BAFF} + {k}_{r}^{BAFF : BCMA} \cdot {C}_{S}^{CellTypeA : BAFF : BCMA} [ t ] + {k}_{x}^{CellTypeA : BAFF} \cdot {L}_{i}^{CellTypeA : BAFF} \cdot {V}_{e} \cdot {N}_{A} ) \cdot \frac{{Y}^{CellTypeA} [ t ]}{{N}_{A}} + ( repeat\_above \_for \_additional \_cell \_types ) & 21\end{matrix}$$

$$\begin{matrix}\frac{d {L}_{i}^{CellTypeA : BAFF}}{d t} = ( - {k}_{fe}^{BAFF : BR 3} \cdot {R}_{i}^{CellTypeA : BR 3} [ t ] \cdot {L}_{i}^{CellTypeA : BAFF} + {k}_{re}^{BAFF : BR 3} \cdot {C}_{i}^{CellTypeA : BAFF : BR 3 } [ t ] - {k}_{fe}^{BAFF : TACI} \cdot {R}_{i}^{CellTypeA : TACI} [ t ] \cdot {L}_{i}^{CellTypeA : BAFF} + {k}_{re}^{BAFF : TACI} \cdot {C}_{i}^{CellTypeA : BAFF : TACI} [ t ] - {k}_{fe}^{BAFF : BCMA} \cdot {R}_{i}^{CellTypeA : BCMA} [ t ] \cdot {L}_{i}^{CellTypeA : BAFF} + {k}_{re}^{BAFF : BCMA} \cdot {C}_{i}^{CellTypeA : BAFF : BCMA} [ t ] ) \cdot \frac{1}{{V}_{e} \cdot {N}_{A}} - {k}_{x}^{CellTypeA : BAFF} \cdot {L}_{i}^{CellTypeA : BAFF} & 22\end{matrix}$$

$$\begin{matrix}\frac{d {L}_{d}^{CellTypeA : BAFF}}{d t} = {k}_{h}^{BAFF : BR 3} \cdot {C}_{i}^{CellTypeA : BAFF : BR 3} [ t ] + {k}_{h}^{BAFF : TACI} \cdot {C}_{i}^{CellTypeA : BAFF : TACI} [ t ] + {k}_{h}^{BAFF : BCMA} \cdot {C}_{i}^{CellTypeA : BAFF : BCMA} [ t ] & 23\end{matrix}$$

$$\begin{matrix}\frac{d {L}^{APRIL}}{d t} = ( - {k}_{f}^{APRIL : HSPG} \cdot {R}_{S}^{CellTypeA : HSPG} [ t ] \cdot {L}^{APRIL} + {k}_{r}^{APRIL : HSPG} \cdot {C}_{S}^{CellTypeA : APRIL : HSPG } [ t ] - {k}_{f}^{APRIL : TACI} \cdot {R}_{S}^{CellTypeA : TACI} [ t ] \cdot {L}^{APRIL} + {k}_{r}^{APRIL : TACI} \cdot {C}_{S}^{CellTypeA : APRIL : TACI} [ t ] - {k}_{f}^{APRIL : BCMA} \cdot {R}_{S}^{CellTypeA : BCMA} [ t ] \cdot {L}^{APRIL} + {k}_{r}^{APRIL : BCMA} \cdot {C}_{S}^{CellTypeA : APRIL : BCMA} [ t ] + {k}_{x}^{CellTypeA : APRIL} \cdot {L}_{i}^{CellTypeA : APRIL} \cdot {V}_{e} \cdot {N}_{A} ) \cdot \frac{{Y}^{CellTypeA} [ t ]}{{N}_{A}} + ( repeat\_above \_for \_additional \_cell \_types ) & 24\end{matrix}$$

$$\begin{matrix}\frac{d {L}_{i}^{CellTypeA : APRIL}}{d t} = ( - {k}_{fe}^{April : HSPG} \cdot {R}_{i}^{CellTypeA : HSPG} [ t ] \cdot {L}_{i}^{CellTypeA : APRIL} + {k}_{re}^{APRIL : HSPG} \cdot {C}_{i}^{CellTypeA : APRIL : HSPG} [ t ] - {k}_{fe}^{APRIL : TACI} \cdot {R}_{i}^{CellTypeA : TACI} [ t ] \cdot {L}_{i}^{CellTypeA : APRIL} + {k}_{re}^{APRIL : TACI} \cdot {C}_{i}^{CellTypeA : APRIL : TACI} [ t ] - {k}_{fe}^{APRIL : BCMA} \cdot {R}_{i}^{CellTypeA : BCMA} [ t ] \cdot {L}_{i}^{CellTypeA : APRIL} + {k}_{re}^{APRIL : BCMA} \cdot {C}_{i}^{CellTypeA : APRIL : BCMA} [ t ] ) \cdot \frac{1}{{V}_{e} \cdot {N}_{A}} - {k}_{x}^{CellTypeA : APRIL} \cdot {L}_{i}^{CellTypeA : APRIL} & 25\end{matrix}$$

$$\begin{matrix}\frac{d {L}_{d}^{CellTypeA : APRIL}}{d t} = {k}_{h}^{APRIL : HSPG} \cdot {C}_{i}^{CellTypeA : APRIL : HSPG} [ t ] + {k}_{h}^{APRIL : TACI} \cdot {C}_{i}^{CellTypeA : APRIL : TACI} [ t ] + {k}_{h}^{APRIL : BCMA} \cdot {C}_{i}^{CellTypeA : APRIL : BCMA} [ t ] & 26\end{matrix}$$

$$\begin{matrix}\frac{d {Y}^{CellTypeA}}{d t} = factors\_affecting \_celltypea \_proliferation & 27\end{matrix}$$

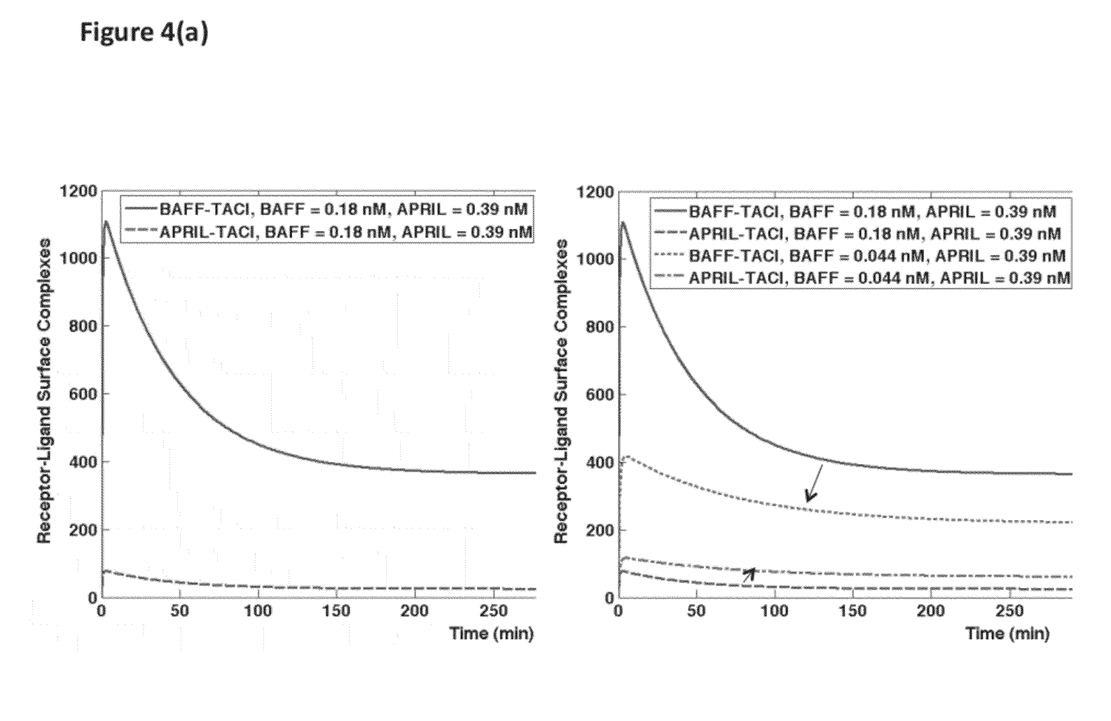

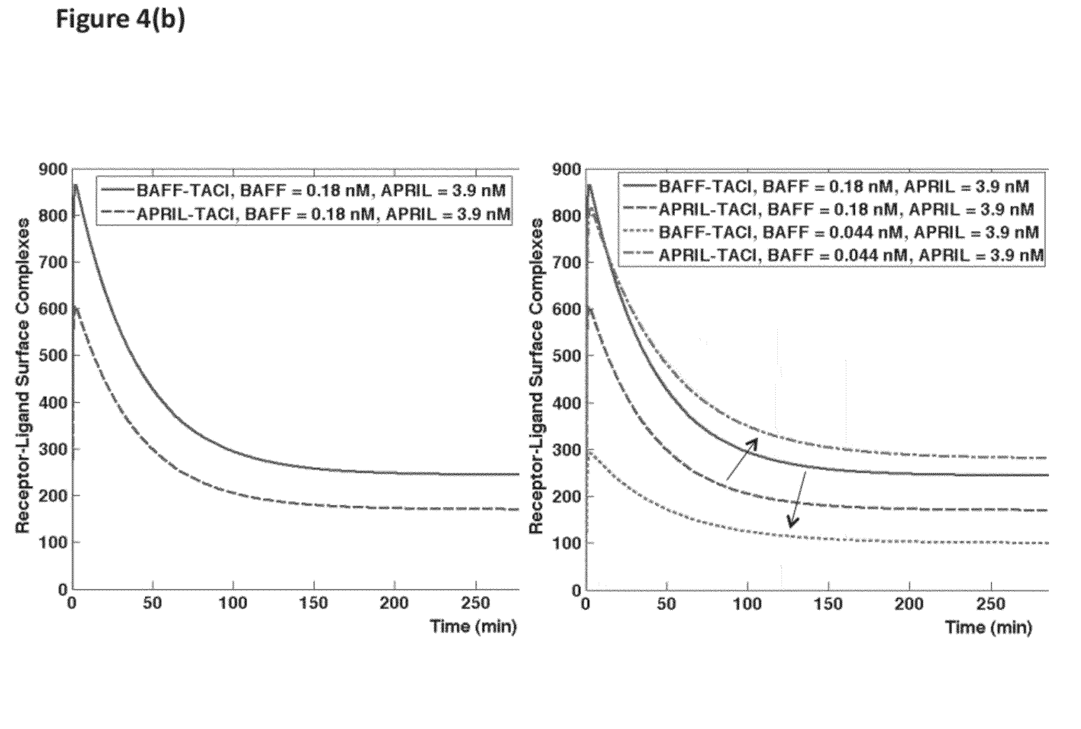

In one embodiment, the therapy is a BAFF antagonist and the therapy's expected effect is to reduce the concentration of BAFF in serum In one embodiment, these equations are solved with MATLAB in order to examine the effect of a BAFF antagonist on the competition between BAFF and APRIL for binding to TACI. This is relevant because the “negative regulation is mediated via the BAFF:TACI interaction, while positive effects (e.g., IgA production, proliferation) are transmitted via APRIL:TACI/HSPG interactions.” [Salzer, 2007]. FIG. 4 shows the output of such a model. FIG. 4(a) illustrates a first subject before (left) and after (right) treatment. The subject has lower initial APRIL levels, so the BAFF antagonist will NOT be effective because even after the addition of the BAFF antagonist (as represented by a reduction in BAFF concentration from 0.18 nM to 0.044 nM), the negative signaling (mediated by BAFF:TACI) still exceeds the positive signaling (mediated by APRIL:TACI). In contrast, the second subject (illustrated in FIG. 4(b)) has higher initial APRIL levels before treatment (left), so the BAFF antagonist WILL be effective because after the addition of the BAFF antagonist (as represented by a reduction in BAFF concentration from 0.18 nM to 0.044 nM) (right), the negative signaling (mediated by BAFF:TACI) NO LONGER exceeds the positive signaling (mediated by APRIL:TACI).

### Example 3

### Predicting the Effects of a JAK Inhibitor

In one embodiment, the therapy is an inhibitor of a janus kinase (JAK). In another embodiment, the therapy is specifically an inhibitor of JAK3. The therapy's target receptor subunit is CD132. The ligands that interacts with the therapy's target receptor subunits are IL-2, IL-4, IL-7, IL-9, IL-15, and IL-21. The receptor subunits that interact with the therapy's target receptor subunits are CD25, CD122, CD124, CD127, CD129, IL-15Ralpha, and IL-21Ralpha. The ligands that interact with receptor subunits that interact with the therapy's target receptor subunits are: IL-2, IL-4, IL-7, IL-9, IL-15, and IL-21. The receptor subunits that interact with receptor subunits and ligands that bind to receptor subunits that interact with receptor subunits are TSLPR, IL-13Ralpha1, TSLP, and IL-13. A receptor subunit that binds to a ligand is IL-13Ralpha2.

In one embodiment, the materials, methods, and model from Example 1 are used to determine the extent of signaling caused by each cytokine. The effects of the therapy are predicted based on which gamma chain cytokine signals are present in a given subject. For instance, rheumatoid arthritis (RA) is believed to be mediated by Th17 and/or Th1 cells [Lubberts, 2010]. IL-21 is shown to increase the likelihood that naïve CD4+ T cells will develop into Th17 cells, and consistent with the two aforementioned observations is the fact that IL-21/IL-21R pathway blockade ameliorates disease in animal models of RA [Young, 2007]. On the other hand, IL-2 and IL-4 together increase the likelihood that naïve CD4+ T cells will develop in to Th2 cells, and a transient rise in synovial fluid IL-2 and IL-4 levels in early RA [Raza, 2005]. We hypothesize that if the analysis described above determines that IL-21 signaling is the dominant gamma chain signaling in a given RA subject at a given time, then the Jak3 inhibitor is likely to be effective because it will reduce the likelihood that naïve CD4+ T cells will become disease-producing Th17 cells. On the other hand, if IL-2 and/or IL-4 is/are the dominant gamma chain signaling in a given RA subject at a given time, then the Jak3 inhibitor is NOT likely to be effective because it will NOT reduce the likelihood that Th17 or Th1 cells will be generated.

### Example 4

### Predicting the Effects of Anti-IL-5

In one embodiment, the therapy comprises an antibody against interleukin-5 (IL-5). The therapy's target receptor subunits are IL-5 receptor alpha and the common beta (βc) subunit. The ligand that interacts with the therapy's target receptor subunits is IL-5. The receptor subunits that interact with the therapy's target receptor subunits are GM-CSF receptor alpha subunit and IL-3 receptor alpha subunit. The ligands that interact with receptor subunits that interact with the therapy's target receptor subunits are: GM-CSF and IL-3.

In one embodiment, the concentration of GM-CSF, IL-3, and IL-5 are determined in serum using commercially available ELISA kits. The surface and intracellular levels of IL-5 receptor alpha, GM-CSF receptor alpha, IL-3 receptor alpha, and beta common are determined on one or more relevant cell types. In one embodiment, the relevant cell types include eosinophils. In another embodiment, the relevant cell type is eosinophils.

In one embodiment, a computational model is then used to determine the effect of the anti-IL-5 in a given subject at a given time, taking into account not only its direct effect on IL-5 but also the effects on GM-CSF and IL-3 signaling caused by the increased availability of beta common.

### Example 5

### Predicting the Effects of IL-21

In one embodiment, the therapy is a recombinant IL-21. The therapy's target receptor subunits are IL-21Ralpha and CD132. The ligands that interact with the therapy's target receptor subunits are IL-21. The receptor subunits that interact with the therapy's target receptor subunits are CD25, CD122, CD124, CD127, CD129, and IL-15Ralpha. The ligands that interact with receptor subunits that interact with the therapy's target receptor subunits are: IL-2, IL-4, IL-7, IL-9, IL-15. The receptor subunits that interact with receptor subunits and ligands that bind to receptor subunits that interact with receptor subunits are TSLPR, IL-13Ralpha1, TSLP, and IL-13. A receptor subunit that binds to a ligand is IL-13Ralpha2.

In one embodiment, the materials, methods, and model from Example 1 are used to determine the effect of IL-21 in a given patient at a given time, taking into account not only its direct effects but also the indirect effects caused by the decreased availability of CD132.

### Example 6

### Predicting the Effects of IL-7

In one embodiment, the therapy is a recombinant IL-7. The therapy's target receptor subunits are CD 127 and CD 132. The ligands that interacts with the therapy's target receptor subunits are IL-7. The receptor subunits that interact with the therapy's target receptor subunits are CD25, CD122, CD124, CD129, IL-15Ralpha, and IL-21Ralpha. The ligands that interact with receptor subunits that interact with the therapy's target receptor subunits are: IL-2, IL-4, IL-7, IL-9, IL-15. The receptor subunits that interact with receptor subunits and ligands that bind to receptor subunits that interact with receptor subunits identified in are TSLPR, IL-13Ralpha1, TSLP, and IL-13. A receptor subunit that binds to a ligand is IL-13Ralpha2.

In one embodiment, the materials, methods, and model from Example 1 are used to determine the effect of IL-7 in a given subject at a given time, taking into account not only its direct effects but also the indirect effects caused by the decreased availability of CD132.

### Example 7

### Predicting the Effects of IL-15

In one embodiment, the therapy is a recombinant IL-15. The therapy's target receptor subunits are IL-15Ralpha, CD122, and CD132. The ligands that interacts with the therapy's target receptor subunits are IL-15. The receptor subunits that interact with the therapy's target receptor subunits are CD25, CD124, CD127, CD129, and IL-21Ralpha. The ligands that interact with receptor subunits that interact with the therapy's target receptor subunits are: IL-2, IL-4, IL-7, IL-9, IL-15. The receptor subunits that interact with receptor subunits and ligands that bind to receptor subunits that interact with receptor subunits are TSLPR, IL-13Ralpha1, TSLP, and IL-13. A receptor subunit that binds to a ligand is IL-13Ralpha2.

In one embodiment, the materials, methods, and model from Example 1 are used to determine the effect of IL-21 in a given patient at a given time, taking into account not only its direct effects but also the indirect effects caused by the decreased availability of CD132.

### Example 8

### Predicting the Effects of GM-CSF

In one embodiment, the therapy comprises a recombinant GM-CSF, such as sargramostim. The therapy's target receptor subunits are GM-CSF receptor alpha and the common beta (βc) subunit. The ligand that interacts with the therapy's target receptor subunits is GM-CSF. The receptor subunits that interact with the therapy's target receptor subunits are the IL-5 receptor alpha subunit and the IL-3 receptor alpha subunit. The ligands that interact with receptor subunits that interact with the therapy's target receptor subunits are: IL-5 and IL-3.

In one embodiment, the concentration of GM-CSF, IL-3, and IL-5 are determined in serum using commercially available ELISA kits. The surface and intracellular levels of IL-5 receptor alpha, GM-CSF receptor alpha, IL-3 receptor alpha, and beta common are determined on one or more relevant cell types. In one embodiment, the relevant cell types include eosinophils. In another embodiment, the relevant cell type is eosinophils.

In one embodiment, a computational model is then used to determine the effect of the GM-CSF in a given patient at a given time, taking into account not only its direct effect but also the effects on IL-5 and IL-3 signaling caused by the decreased availability of beta common.

### Example 9

### Anti-CD25 Alternate Approach

In another embodiment, the effects of an anti-CD25 therapy on a given subject are predicted by determining the extent to which it makes additional IL-2 available to CD56bright NK cells. In subjects with Tregs levels above a certain threshold, even the maximum dose of anti-CD25 may still leave a sufficient number of CD25+ Tregs available to compete for IL-2, such that CD56bright NK cells still will not be able to obtain enough IL-2 to reach their proliferation thresholds. In one embodiment, it is determined whether or not this is the case using measurements of Treg levels, CD56bright NK cell levels, quantity of CD25, CD122, and CD132 on the Tregs, quantity of CD25, CD122, and CD132 on the CD56bright NK cells, concentration of IL-2, and maximum anticipated dose of anti-CD25. In another embodiment, Tregs are divided into memory and naïve Tregs for the purpose of this analysis. In one embodiment, the determination is made using a computational model of receptor-ligand binding and trafficking dynamics.

### REFERENCES

Andrews, A-L., et al, (2002) “Kinetic Analysis of the Interleukin-13 Receptor Complex,” The Journal of Biological Chemistry, 277(48): 46073-46078.
Andrews, A-L., et al, (2006) “IL-4 Receptor a Is an Important Modulator of 1′-4 and IL-13 Receptor Binding. Implications for the Development of Therapeutic Targets,” The Journal of Immunology, 176: 7456-7461.
Arai, M., et al, (2010) “Development and application of a biomarker assay for determining the pharmacodynamic activity of an antagonist candidate biotherapeutic antibody to IL21R in whole blood,” Journal of Translational Medicine, 8:51.
Bielekova, B., et al, (2006) “Regulatory CD56^{bright} natural killer cells mediate immunomodulatory effects of IL-2Rα-targeted therapy (daclizumab) in multiple sclerosis,” PNAS, 103(15): 5941-5946.
Cantrell, D. A. and Smith, K. A., (1984) “The Interleukin-2 T-Cell System: A New Cell Growth Model,” Science, 224: 1312-1316.
Cesana, G. C., et al., (2006) “Characterization of CD4+CD25+ Regulatory T Cells in Patients Treated With High-Dose Interleukin-2 for Metastatic Melanoma or Renal Cell Carcinoma,” J Clin Oncol, 24: 1169-1177.
Day, E. S., et al, (2005) “Selectivity of BAFF/BLyS and APRIL for Binding to the TNF Family Receptors BAFFR/BR3 and BCMA,” Biochemistry, 44: 1919-1931.
De Smedt, M., et al, (2000) “Signals from the IL-9 Receptor Are Critical for the Early Stages of Human Intrathymic T Cell Development,” The Journal of Immunology, 164: 1761-1767.
Fallon, E. M. and Lauffenburger, D. A. (2000) “Computational Model for Effects of Ligand/Receptor Binding Properties on Interleukin-2 Trafficking Dynamics and T Cell Proliferation Response,” Biotechnology Progress, 16: 905-916.
Hanna, J., et al, (2004) “Novel Insights on Human NK Cells' Immunological Modalities Revealed by Gene Expression Profiling,” The Journal of Immunology, 173: 6547-6563.
Hatjiharissi, E., et al, (2007) “Increased natural cell expression of CD16, augmented binding and ADCC activity to rituximab among individuals expressing the FcγRIIIa-158 V/V and V/F polymorphism,” Blood, 110(7): 2561-2564.
Hodge, S., et al, (2000) “Surface and Intracellular Interleukin-2 Receptor Expression on Various Resting and Activated Populations Involved in Cell-Mediated Immunity in Human Peripheral Blood,” Scand. J. Immunol., 51: 67-72.
Kraich, M., et al, (2006) “A modular interface of IL-4 allows for scalable affinity without affecting specificity for the IL-4 receptor,” BMC Biology, 4:13.
Lubberts, E., (2010) “Th17 cytokines and arthritis,” Semin Immunopathol, 32: 43-53.
McElroy, C. A., et al, (2010) “Structural and Biophysical Studies of the Human IL-7/IL-7Rα Complex,” Structure, 17(1): 54-65.
Monti, P., et al, (2009) “Disengaging the IL-2 Receptor with Daclizumab Enhances IL-7—Mediated Proliferation of CD4+ and CD8+ T Cells,” American Journal of Transplantation, 9: 2727-2735.
Mortier, E., et al, (2008) “IL-15Ra chaperones IL-15 to stable dendritic cell membrane complexes that activate NK cells via trans presentation,” J. Exp. Med., 205(5): 1213-1225.
Myszka, D. G., et al, (1996) “Kinetic analysis of ligand binding to interleukin-2 receptor complexes created on an optical biosensor surface,” Protein Science, 5: 2468-2478.
Olosz, F., et al, (2000) “Three Loops of the Common y Chain Ectodomain Required for the Binding of Interleukin-2 and Interleukin-7,” The Journal of Biological Chemistry, 275(39): 30100-30105.
Palmer, M. J., et al, (2008) “Interleukin-7 Receptor Signaling Network: An Integrated Systems Perspective,” Cellular & Molecular Immunology, 5(2): 79-89.
Pandey, A., et al, (2000) “Cloning of a receptor subunit required for signaling by thymic stromal lymphopoietin,” Nature Immunology, 1(1): 59-64.
Pannu, K. K., et al, (2001) “Performance Evaluation of QuantiBRITE Phycoerythrin Beads,” Cytometry, 45: 250-258.
Raza, K., et al, (2005) “Early rheumatoid arthritis is characterized by a distinct and transient synovial fluid cytokine profile of T cell and stromal cell origin,” Arthritis Research & Therapy, 7: R784-R795.
Rickert, M., et al, (2004) “Compensatory Energetic Mechanisms Mediating the Assembly of Signaling Complexes Between Interleukin-2 and its α, β, and γc Receptors,” J. Mol. Biol., 339: 1115-1128.
Sabatino, M., et al, (2009) “Serum Vascular Endothelial Growth Factor and Fibronectin Predict Clinical Response to High-Dose Interleukin-2 Therapy,” Journal of Clinical Oncology, 27.
Sakamoto, S., et al, (2009), “Contributions of interfacial residues of human Interleukin15 to the specificity and affinity for its private alpha-receptor,” J Mol Biol, 389(5): 880-894.
Salzer, U., et al, (2007) “To switch or not to switch—the opposing roles of TACI in terminal B cell differentiation,” Eur. J. Immunol, 37: 17-20.
Taniguchi, T., et al, (1993) “The IL-2/IL-2 Receptor System: A Current Overview,” Cell, 73: 5-8.
Treml, J. F., et al, (2009) “The BLyS Family: Toward a Molecular Understanding of B Cell Homeostasis,” Cell Biochem Biophys, 53: 1-16.
Vamosi, G., et al, (2004) “IL-2 and IL-15 receptor a-subunits are coexpressed in a supramolecular receptor cluster in lipid rafts of T cells,” PNAS, 101(30): 11082-11087.
Venken, K., et al, (2008) “Natural Naïve CD4⁺CD25⁺CD127^{low} Regulatory T Cell (Treg) Development and Function Are Disturbed in Multiple Sclerosis Patients: Recovery of Memory Treg Homeostasis during Disease Progression,” The Journal of Immunology, 180: 6411-6420.
Voss, S. D., et al, (1992) “Characterization of the Interleukin 2 Receptors (IL-2R) Expressed on Human Natural Killer Cells Activated In Vivo by IL-2: Association of the p64 IL-2R γ hairs with the Il-2R β Chain in Functional Intermediate-Affinity IL-2R,” J. Exp. Med., 176: 531-541.
Xue, H-H., et al, (2002) “IL-2 negatively regulates IL-7 receptor a chain expression in activated T lymphocytes,” PNAS, 99(21): 13759-13764.
Young, D. A., et al, (2007) “Blockade of the Interleukin-21/Interleukin-21 Receptor Pathway Ameliorates Disease in Animal Models of Rheumatoid Arthritis,” Arthritis and Rheumatism, 56(4): 1152-1163.
Zhang, J-L., et al, (2003) “Human IL-21 and IL-4 bind to partially overlapping epitopes of common γ-chain,” Biochemical and Biophysical Research Communications, 300: 291-296.

What is claimed is:

1. A method of predicting the effects of therapy on a subject prior to treatment, the method comprising:
(i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b).
(ii) determining a first set of output values, representing the signaling on one or more receptor(s) prior to treatment based on (i), and
(iii) predicting the effects of therapy on a subject prior to treatment based on the results of (i)-(ii).

2. The method of claim 1, further comprising:
(iv) providing a second set of input values, equal to the first set of input values but wherein the quantity or quantities that is/are expected to be directly altered by the therapy is/are changed to reflect the therapy's expected effect,
(v) determining a second set of output values representing the signaling on one or more receptor(s) after administration of the therapy, and
(vi) predicting the effects of therapy on a subject prior to treatment, based on the results of (i)-(v).

3. The method of claim 1, wherein the therapy (a) comprises an agonist or an antagonist of a receptor or receptor subunit, (b) alters the quantity of ligand available to bind to a receptor or receptor subunit, and/or (c) modulates a pathway triggered by a receptor or receptor subunit.

4. The method of claim 1, wherein the target receptor subunit(s) comprises:
(a) the subunit(s) of the receptor(s) for which the therapy is an agonist or an antagonist,
(b) the receptor subunit(s) for which the therapy is an agonist or an antagonist and any subunit(s) that form complexes with that/those receptor subunits,
(c) the subunit(s) of the receptor(s) that bind to the ligand whose quantity is altered by the therapy, or
(d) receptor subunit(s) that trigger the signaling pathway which the therapy modulates.

5. The method of claim 1, wherein the first set of input values further comprises receptor subunit(s) that interact with receptor subunit(s) identified in claim 1(ia) and/or claim 1(ib), and ligand(s) that bind to a receptor subunit(s) that interact with receptor subunits identified in claim 1(ia) and/or claim 1(ib).

6-55. (canceled)

56. A method of designing/conducting a clinical trial, the method comprising:
(i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b).
(ii) determining a first set of output values, representing the signaling on one or more receptor(s) prior to treatment based on (i), and
(iii) designing/conducting a clinical trial based on the results of (i)-(ii).

57. The method of claim 56, further comprising:
(iv) providing a second set of input values, equal to the first set of input values but wherein the quantity or quantities that is/are expected to be directly altered by the therapy is/are changed to reflect the therapy's expected effect,
(v) determining a second set of output values representing the signaling on one or more receptor(s) after administration of the therapy, and
(vi) designing/conducting a clinical trial based on the results of (i)-(v).

58. The method of claim 56, wherein the therapy (a) comprises an agonist or an antagonist of a receptor or receptor subunit, (b) alters the quantity of ligand available to bind to a receptor or receptor subunit, and/or (c) modulates a pathway triggered by a receptor or receptor subunit.

59. The method of claim 56, wherein the target receptor subunit(s) comprises:
(a) the subunit(s) of the receptor(s) for which the therapy is an agonist or an antagonist,
(b) the receptor subunit(s) for which the therapy is an agonist or an antagonist and any subunit(s) that form complexes with that/those receptor subunits,
(c) the subunit(s) of the receptor(s) that bind to the ligand whose quantity is altered by the therapy, or
(d) receptor subunit(s) that trigger the signaling pathway which the therapy modulates.

60. The method of claim 56, wherein the first set of input values further comprises receptor subunit(s) that interact with receptor subunit(s) identified in claim 56(ia) and/or claim 56(ib), and ligand(s) that bind to a receptor subunit(s) that interact with receptor subunits identified in claim 56(ia) and/or claim 56(ib).

61-110. (canceled)

111. A method of selecting a subject for a clinical trial, the method comprising:
(i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b).
(ii) determining a first set of output values, representing the signaling on one or more receptor(s) prior to treatment based on (i), and
(iii) selecting the subject for a clinical trial based on the results of (i)-(ii).

112. The method of claim 111, further comprising:
(iv) providing a second set of input values, equal to the first set of input values wherein the quantity or quantities that is/are expected to be directly altered by the therapy is/are changed to reflect the therapy's expected effect,
(v) determining a second set of output values representing the signaling on one or more receptor(s) after administration of the therapy, and
(vi) selecting the subject for a clinical trial based on the results of (i)-(v).

113. The method of claim 111, wherein the therapy (a) comprises an agonist or an antagonist of a receptor or receptor subunit, (b) alters the quantity of ligand available to bind to a receptor or receptor subunit, and/or (c) modulates a pathway triggered by a receptor or receptor subunit.

114. The method of claim 111, wherein the target receptor subunit(s) comprises:
(a) the subunit(s) of the receptor(s) for which the therapy is an agonist or an antagonist,
(b) the receptor subunit(s) for which the therapy is an agonist or an antagonist and any subunit(s) that form complexes with that/those receptor subunits,
(c) the subunit(s) of the receptor(s) that bind to the ligand whose quantity is altered by the therapy, or
(d) receptor subunit(s) that trigger the signaling pathway which the therapy modulates.

115. The method of claim 111, wherein the first set of input values further comprises receptor subunit(s) that interact with receptor subunit(s) identified in claim 111(ia) and/or claim 111(ib), and ligand(s) that bind to a receptor subunit(s) that interact with receptor subunits identified in claim 111(ia) and/or claim 111(ib).

116-165. (canceled)

166. A method of selecting a therapy for a subject, the method comprising:
(i) providing prior to treatment a first set of input values comprising the absolute or relative quantity of: (a) the therapy's target receptor subunit(s), (b) receptor subunit(s) that interact with the therapy's target receptor subunit(s), and/or (c) ligand(s) that interact with one or more of the receptor subunit(s) identified in (a) and (b),
(ii) determining a first set of output values, representing the signaling on one or more receptor(s) prior to treatment based on (i), and
(iii) selecting a therapy for a subject based on the results of (i)-(ii).

167. The method of claim 166, further comprising:
(iv) providing a second set of input values, equal to the first set of input values but wherein the quantity or quantities that is/are expected to be directly altered by the therapy is/are changed to reflect the therapy's expected effect,
(v) determining a second set of output values representing the signaling on one or more receptor(s) after administration of the therapy, and
(vi) selecting a therapy for a subject based on the results of (i)-(v).

168. The method of claim 166, wherein the therapy (a) comprises an agonist or an antagonist of a receptor or receptor subunit, (b) alters the quantity of ligand available to bind to a receptor or receptor subunit, and/or (c) modulates a pathway triggered by a receptor or receptor subunit.

169. The method of claim 166, wherein the target receptor subunit(s) comprises:
(a) the subunit(s) of the receptor(s) for which the therapy is an agonist or an antagonist,
(b) the receptor subunit(s) for which the therapy is an agonist or an antagonist and any subunit(s) that form complexes with that/those receptor subunits,
(c) the subunit(s) of the receptor(s) that bind to the ligand whose quantity is altered by the therapy, or
(d) receptor subunit(s) that trigger the signaling pathway which the therapy modulates.

170. The method of claim 166, wherein the first set of input values further comprises receptor subunit(s) that interact with receptor subunit(s) identified in claim 166(ia) and/or claim 166(ib), and ligand(s) that bind to a receptor subunit(s) that interact with receptor subunits identified in claim 166(ia) and/or claim 166(ib).

171-394. (canceled)
